(19) United States
(12) Patent Application Publication
(10) Pub. No.: US 2023/0417788 A1
(43) Pub. Date: Dec. 28, 2023

(54) MEASUREMENT DEVICE INCORPORATING A MICROFLUIDIC SYSTEM

(71) Applicant: Oxford Nanoimaging Limited, Oxford (GB)

(72) Inventors: Bo Jing, Oxford (GB); Armando Arpys Arevalo Carreno, Oxford (GB); Benjamin Thomas Whiteley, Oxford (GB); Issac Michael, Oxford (GB); Eric A. Warner, Oxford (GB); Tyler S. Ralston, Oxford (GB)

(73) Assignee: Oxford Nanoimaging Limited, Oxford (GB)

(21) Appl. No.: 18/038,685

(22) PCT Filed: Nov. 25, 2021
(86) PCT No.: PCT/EP2021/083065

§ 371 Date: May 24, 2023

(30) Foreign Application Priority Data
Nov. 25, 2020 (GB) 2018557.5
Nov. 25, 2020 (GB) 2018558.3

(51) Int. Cl. G01N 35/10; G01N 35/00; G02B 21/00

(52) U.S. Cl. CPC G01N 35/1002; G01N 35/00871; G01N 35/1097; G01N 35/00029; G02B 21/0008; G01N 2035/1034; G01N 2035/00158

(57) ABSTRACT

The present application discloses a measurement device incorporating a modular microfluidic system comprising standard modules which can be networked together via standardised connectors in a range of configurations. The measurement device includes a master microfluidic module connectable to an external pressure source, which has a socket for receiving a reagent cartridge, and can be used to drive flow of reagent from the reagent cartridge to an analysis chip. The master microfluidic module also has specialised pressure output and reagent input connectors which can be attached to secondary microfluidic modules, so that the master microfluidic modules can drive reagent from the secondary microfluidic modules to an analysis chip supported on the main microfluidic module. The application also describes a range of specialised cartridge types for use with the measurement device.

### FIELD OF THE INVENTION

The present invention relates to measurement devices incorporating microfluidic systems, as well as the microfluidic systems and components themselves. In particular, the invention relates to microscopy equipment fed by microfluidic systems incorporating reagent cartridges, as well as the reagent cartridges themselves.

### BACKGROUND

Measurement devices incorporating microfluidic systems offer the possibility of carrying out sensitive analysis of tiny volumes of sample. This is particularly advantageous in analysis of biological specimens, where smaller volumes can allow less intrusive sample acquisition from patients, and less use of expensive reagents.

An example where such technology is put to use is Illumina's NextSeq sequencing machine. This machine has an in-built microfluidic and imaging system, and accepts consumable reagent cartridges and sequencing chips (as shown in EP3030645) which a user can insert into the machine to carry out a number of pre-set protocols. The system is aimed at biologists, and hence there is a focus on making the components simple to use without requiring a knowledge of microfluidics to use the machine. However, the resulting design necessarily limits the adaptability of the device, making it unsuitable for protocols beyond those for which it was specifically designed.

The LabSat® system sold by Lunaphore is another commercially available system, incorporating a microfluidic reagent module that can be adapted to a range of staining protocols. However, the system has a limited number of separate mounts for reagent vials, and thus is time-consuming to load up, and relatively inflexible if additional reagent vials are wanted.

An alternative approach from Lunaphore is found in WO 2019/063375, which describes a microfluidic cartridge system said to be suitable for a wide range of staining protocols involving the sequential delivery of reagents. The system has a plurality of reagent wells each with an associated microfluidic channel and flow valve, all of which open onto a shared outlet channel leading on to a measurement chamber. Each of the valves has an associated actuator, allowing sequential delivery of reagents by controlling the sequence of valves opening and closing. However, there are a number of potential drawbacks with this system.

Firstly, the system is relatively complicated due to the need to provide separate actuators to operate each of the microfluidic valves in a relatively confined space.

Secondly, the device is designed for delivery of reagents in a sequence, but is poorly suited to protocols which require mixing of reagents within the microfluidic channels. In particular, in the embodiments depicted in WO 2019/063375 the only space which could feasibly be used for mixing of components is the shared outlet channel. However, the reagent wells feed into the shared outlet channel in a set sequence, meaning that reagents held in the wells can only be mixed in a set order. For example, a reagent in well A can be added into the shared outlet channel first and mixed with a subsequently released reagent from “downstream” well B, but the opposite procedure of adding A into B cannot be carried out. Furthermore, the design necessarily means that additional components can only be added one at a time, without the possibility of adding multiple components simultaneously.

A further example of a commercially available system is the Rotary Membrane Valve & Pump (RMVP) offered by Enplas Life Tech. The system, described in EP3499099, incorporates a substrate with a series of flowpaths incorporating diaphragm valves which can be actuated through rotation of a pin.

In view of the limitations of the microfluidic components of existing measurement devices, an alternative approach is to construct a microfluidic system from scratch. A number of companies (such as Fluigent, Dolomite Microfluidics, and Elveflow) offer generic microfluidic components, such as valves, manifolds, pumps and tubing, to facilitate the construction of such setups. However, if the user wants to support another application, the system has to be disassembled and rebuilt to the specifications of the new application. Generally, such solutions lack interfaces for chips and cartridges. Chips have to be connected manually to tubing without pre-terminated connectors, and reagents have to be introduced from reagent tubes which have to be connected manually to tubing without pre-terminated connectors. Furthermore, when configured for use with a fluidic chip placed in a microscopy system, these custom solutions are often suboptimal because of the long tubing required to connect the chip with the custom components on the outside of the measurement device, and the resulting large internal volume of the system. More generally, the components of the microfluidic system are relatively bulky, meaning that systems as a whole can end up being large and unwieldy.

Thus, there remains a need for improved, relatively compact, measurement devices which benefit from the advantages of microfluidic reagent supply, are simple to use, and give greater flexibility in terms of the types of techniques and protocols that can be accommodated. Similarly, there is a need for improved, more adaptable, reagent supply systems.

### SUMMARY OF THE INVENTION

In view of the foregoing, the present inventors have developed a modular microfluidic system comprising standard modules which can be networked together via standardised connectors in a range of configurations. The modular nature of the system readily facilitates the incorporation of the system into compact measurement devices, in particular allowing a “master” module to be compactly built into the measurement device which can be networked with separate “secondary” modules to expand the functionality of the system.

Accordingly, in a first aspect the present invention provides a measurement device, comprising: an analysis chip mount, for receiving an analysis chip;
(ii) measurement apparatus, for analysing an analysis chip mounted on the analysis chip mount; and
(iii) a master microfluidic module, for supplying reagents to an analysis chip mounted on the analysis chip mount, the master microfluidic module comprising:
   a cartridge socket, having a plurality of cartridge socket inlet ports and cartridge socket outlet ports, for receiving a reagent cartridge;
   a pressure manifold, comprising a plurality of pressure feed lines connectable to an external pressure source, each pressure feed line having an associated multi-way valve assembly for selectively connecting the pressure feed line to either an external pressure output line or a cartridge socket pressure line (connected to a cartridge socket inlet port); and
   a chip input manifold, comprising a plurality of chip input lines for providing reagent to an analysis chip in use (e.g. connectable to an analysis chip received on the analysis chip mount); each having an associated multi-way valve assembly for selectively connecting the chip input line to either a cartridge socket reagent line (connected to a cartridge socket outlet port) or an external reagent input line;
wherein the plurality of external pressure output lines terminate in a shared pressure output connector and the plurality of external reagent input lines originate from a shared external reagent input connector.

For the avoidance of doubt, the term “reagent” is used broadly to refer to any flowable substance (such as a liquid, bubbles, powder etc.) for delivery to the analysis chip. The reagent can be used for any purpose. For example, the reagent may in itself be the subject of analysis on the analysis chip, may be mixed with another component to dilute or react with the component, may be used to clean or flush the analysis chip, or may be used to establish flow over or within the analysis chip (to move components of the sample or achieve hydrodynamic focusing). Thus, the term can be synonymous with sample, reactant, analyte, diluent, cleaning fluid, flushing fluid and the like.

The components set out above allow the measurement device to carry out protocols using a reagent cartridge attached to the master microfluidic module, as already known from earlier work. However, crucially, the provision of the shared pressure output connector and shared external reagent input connector on the master microfluidic module also allows secondary microfluidic modules to interface with the master microfluidic module through corresponding connectors/fixings on the secondary microfluidic module. In particular, a secondary microfluidic module can easily be “looped up” or plugged in to the master microfluidic module using the connectors, with reagents delivered from the secondary module to an analysis chip on the measurement device via the external reagent input connector, optionally with delivery of those reagents achieved through pressure supplied by the master microfluidic module through the pressure output connector. This massively expands the range of protocols which the measurement device can carry out. The provision of shared connectors means that a secondary microfluidic module can easily be connected and disconnected, without having to attach and reattach multiple separate lines and components, nor the need to provide separate pressure sources to power the additional modules. The system facilitates a “plug and play” type system, where secondary microfluidic modules can be easily installed and used with minimal configuration.

This is in contrast to other measurement devices known in the art. For example, the microfluidic module of Illumina's NextSeq machine does not have any provision for interfacing with separate microfluidic modules, let alone interfacing in such a way that the existing pressure supply can be used to drive flow from separate microfluidic modules to the analysis chips. Lunaphore's LabSat system does not benefit from the use of reagent delivery cartridges, and is limited by the inability to extend the number of lines built into the system.

By way of example, consider an implementation in which the measurement device incorporates a master microfluidic module having a cartridge containing 8 reagents, attached to a secondary microfluidic module having a cartridge containing a further 8 reagents, making a total of 16 different reagents. In such an implementation it is possible to deliver the 16 different reagents to the analysis chip in any sequence using only a single pressure source. In contrast, in the NextSeq device delivery of reagents from different cartridges would require swapping of the cartridges as the machine runs. Lunaphore's LabSat system does not accept cartridges at all, and hence the inclusion of reagents beyond those originally loaded onto the system necessitates removing and replacing reagent containers.

The multi-way valve assembly associated with each pressure feed line of the pressure manifold (connected to a pressure feed line, external pressure output line and cartridge socket pressure line) is referred to as the “cartridge pressurisation valve”. Similarly, the multi-way valve assembly associated with each chip input line of the chip input manifold (connected to a chip input line, cartridge socket reagent line and external reagent input line) is referred to as the “chip valve”.

The pressure manifold can be thought of as comprising a number of “divertible pressurisation units”, each unit including a pressure feed line and its associated cartridge pressurisation valve, external output line, and cartridge socket pressure line. The units are “divertible” in the sense that they can be diverted between different flowpaths—either the cartridge socket pressure line or the external pressure output line. The number of divertible pressurisation units incorporated in the pressure manifold is generally referred to as “L”. L is greater than 1, and may be, for example, 2 or more, 3 or more, 4 or more, 5 or more, 6 or more, 7 or more, 8 or more, 12 or more, or 16 or more. In practice, however, the modular nature of the microfluidic system incorporated in the measurement device means that a given divertible pressurisation unit can be configured to supply pressure to a range of different microfluidic modules, and thus an excessive number of pressurisation units is not required. This means that, in practice, L is usually 4, 6 or 8.

The chip input manifold can be thought of as comprising a number of “divertible chip input units”, each including a chip input line and its associated chip valve, cartridge socket reagent line and external reagent input line. Again, the units are “divertible” in the sense that they can be diverted between different flowpaths—either the cartridge socket reagent line or external reagent input line. The number of divertible chip input units incorporated in the chip input manifold is generally referred to as “M”. M is greater than 1, and may be, for example, 2 or more, 3 or more, 4 or more, 5 or more, 6 or more, 7 or more, 8 or more, 12 or more, or 16 or more. In practice, however, M is usually 4, 6 or 8. Preferably, L is greater than or equal to M (in other words, there are more divertible pressurisation units than divertible chip input units). Optionally, L is equal to M. In instances in which there are an excess of divertible pressurisation units compared to divertible chip input units (L is greater than M), it is possible to use the excess pressurisation units to drive the delivery of reagents from external sources, in the manner discussed in more detail below.

Optionally, the pressure manifold may further include one or more “non-divertible pressurisation units”, in which a pressure feed line is connected directly to a cartridge socket inlet port without an alternative output (and hence is “non-divertible” because there is only a single flowpath). In such instances, the pressure feed line may optionally have a 2-way valve to open and close the flowpath. However, preferably, the pressure manifold consists entirely of divertible pressurisation units. In other words, each of the cartridge socket inlet ports is connected to a cartridge socket pressure line having an associated pressurisation valve as described above.

Optionally, the chip input manifold may further include one or more “non-divertible chip input units”, in which a chip socket input line is connected directly to a cartridge socket outlet port without an alternative input (and hence is “non-divertible” because there is only a single flowpath). In such instances, the chip input line may optionally have a 2-way valve to open and close the flowpath. However, preferably, the chip input manifold consists entirely of divertible chip input units. In other words, each of the chip input lines has an associated chip valve as described above.

Suitably, the measurement device includes an enclosure housing the analysis chip mount, the measurement apparatus, and the master microfluidic module.

The enclosure may incorporate a hatch for accessing the cartridge socket of the master microfluidic module. This protects the cartridge in use. In addition, in embodiments in which the measurement apparatus incorporates components which are sensitive to the external environment (for example, light sensitive detectors) the provision of a hatch for accessing the cartridge socket protects the components from damage.

Similarly, the enclosure may incorporate a hatch for accessing the analysis chip mount. Again, this protects the analysis chip in use, and also protects any sensitive components of the measurement apparatus.

The pressure output connector and external reagent input connector (and other relevant connectors of the master microfluidic module, introduced below) are generally positioned on the outside of the enclosure, positioned on the external surface of the enclosure or extending out of the external surface of the enclosure, to aid their connection to a secondary microfluidic module (for example via a linker, such as patch cable, discussed in more detail below). The connectors may be integral to the enclosure, or may be a separate part. Preferably, the connectors attach to a terminal block provided on the enclosure, which can be used to attach a secondary microfluidic module. In instances where the measurement device incorporates an enclosure having a hatch for accessing the cartridge socket, the connectors (for example the terminal block) may also be provided beneath the hatch. Preferably, the shared pressure output connector and shared external reagent input connector are positioned on the same part (e.g. side) of the enclosure, in close proximity to one another, to simplify connection to a secondary microfluidic module.

In instances where the measurement device is an optical measurement device, the enclosure may be made from a lightproof material, to prevent transmission of visible light (for example, having a transmissivity of less than 1% across wavelengths between 380 to 740 nm, preferably less than 0.5%, more preferably less than 0.1%).

The invention extends to a measurement device as defined above, having a cartridge connected to the cartridge socket and/or an analysis chip mounted to the analysis chip input lines on the analysis chip mount.

Secondary Microfluidic Modules

The present invention also includes a measurement device incorporating a secondary microfluidic module connected to the master microfluidic module.

In such instances, the secondary microfluidic module preferably comprises: a reagent cartridge;
a pressure manifold for pressurising the reagent cartridge, comprising a plurality of pressure feed lines; and
a reagent manifold, comprising a plurality of reagent output lines for delivering reagent from the reagent cartridge in use, terminating in a shared reagent output connector;
wherein the reagent output connector is fluidly connected (directly connected, or indirectly connected e.g. through a linker) to the external reagent input connector of the master microfluidic module.

Optionally, the pressure manifold receives pressure from an external pressure source. However, more preferably, the pressure manifold originates from a shared pressure input connector which is fluidly connected (directly connected, or indirectly connected e.g. through a linker) to the external pressure output connector of the master microfluidic module. In such instances, the secondary microfluidic module comprises:
a reagent cartridge; a pressure manifold for pressurising the reagent cartridge, comprising a plurality of pressure feed lines originating from a shared pressure input connector; and
a reagent manifold, comprising a plurality of reagent output lines for delivering reagent from the reagent cartridge in use, terminating in a shared reagent output connector;
wherein the pressure input connector is fluidly connected (directly connected, or indirectly connected e.g. through a linker) to the external pressure output connector of the master microfluidic module, and the reagent output connector is fluidly connected (directly connected, or indirectly connected e.g. through a linker) to the external reagent input connector of the master microfluidic module.

In other words, the secondary microfluidic module is “plugged in” to the master microfluidic module by establishing a fluid connection between the external pressure input connector of the secondary microfluidic module and external pressure output connector of the master microfluidic module, and establishing a fluid connection between the external reagent output connector of the secondary microfluidic module and the external reagent input connector of the master microfluidic module. In this way, the secondary microfluidic module is looped up to the master microfluidic module, so that the master microfluidic module can drive the flow of reagent from the reagent cartridge of the secondary microfluidic module to an analysis chip mounted on the analysis chip mount, using an external pressure source connected to the master microfluidic module.

Optionally, the reagent cartridge is removable. In such instances, the secondary microfluidic module comprises;
a cartridge socket, having a plurality of cartridge socket inlet ports and cartridge socket outlet ports, for receiving a reagent cartridge;
a pressure manifold for supplying pressure to the cartridge socket, comprising a plurality of pressure feed lines preferably originating from a shared pressure input connector, each pressure feed line fluidly connected to a cartridge socket inlet port; and
a reagent manifold, comprising a plurality of reagent output lines terminating in a shared reagent output connector, each reagent output line fluidly connected with a cartridge socket outlet port;
wherein the pressure input connector is preferably fluidly connected (directly connected, or indirectly connected e.g. through a linker) to the external pressure output connector of the master microfluidic module, and the reagent output connector is fluidly connected (directly connected, or indirectly connected e.g. through a linker) to the external reagent input connector of the master microfluidic module.

Preferably, the number of pressure feed lines of the secondary microfluidic module is the same as the number of external pressure output lines of the master microfluidic module. In this way, the external pressure output connector and external pressure input connector have matching numbers of orifices.

Similarly, it is preferred for the number of reagent output lines of the secondary microfluidic module to be the same as the number of external reagent input lines of the master microfluidic module. In this way, the external pressure output connector and external pressure input connector have matching numbers of orifices.

More preferably, the secondary microfluidic module comprises:
a reagent cartridge;
a pressure manifold, comprising a plurality of pressure feed lines each having an associated multi-way valve assembly for selectively connecting the pressure feed line to either an external pressure output line or a cartridge pressure line (connected to a cartridge inlet port); and
a reagent manifold, comprising a plurality of reagent output lines having an associated multi-way valve assembly for selectively connecting upstream to either a cartridge reagent line (connected to a cartridge outlet port) or an external reagent input line;
wherein
the plurality of pressure feed lines originate from a shared external pressure input connector;
the plurality of external pressure output lines terminate in a shared external pressure output connector;
the plurality of external reagent input lines originate from a shared external reagent input connector;
the plurality of reagent output lines terminate in a shared reagent output connector;
the external pressure input connector is fluidly connected (directly connected, or indirectly connected e.g. through a linker) to the external pressure output connector of the master microfluidic module, and
the external reagent output connector is fluidly connected (directly connected, or indirectly connected e.g. through a linker) to the external reagent input connector of the master microfluidic module.

As with the master microfluidic unit above, the multi-way valve assembly associated with the pressure manifold may be referred to as a “cartridge pressurisation valve”. The multi-way valve assembly associated with the reagent manifold can be referred to as a “reagent valve”, analogous to the “chip valve” discussed above in relation to the master microfluidic module.

Even more preferably, the secondary microfluidic module comprises:
a cartridge socket, having a plurality of cartridge socket inlet ports and cartridge socket outlet ports, for receiving a reagent cartridge;
a pressure manifold, comprising a plurality of pressure feed lines each having an associated multi-way valve assembly for selectively connecting the pressure feed line to either an external pressure output line or a cartridge socket pressure line (connected to a cartridge socket inlet port); and
a reagent manifold, comprising a plurality of reagent output lines having an associated multi-way valve assembly for selectively connecting upstream to either a cartridge socket reagent line (connected to a cartridge socket outlet port) or an external reagent input line;
wherein
the plurality of pressure feed lines originate from a shared external pressure input connector;
the plurality of external pressure output lines terminate in a shared external pressure output connector;
the plurality of external reagent input lines originate from a shared external reagent input connector;
the plurality of reagent output lines terminate in a shared reagent output connector;
the external pressure input connector is fluidly connected (directly connected, or indirectly connected e.g. through a linker) to the external pressure output connector of the master microfluidic module, and
the external reagent output connector is fluidly connected (directly connected, or indirectly connected e.g. through a linker) to the external reagent input connector of the master microfluidic module.

In these preferred implementations, the secondary microfluidic module incorporates both an external pressure input connector and external pressure output connector, as well as an external reagent input connector and external reagent output connector. Through the provision of these four connectors, multiple secondary microfluidic modules can be “daisy-chained” together in such a way that all secondary microfluidic modules can be pressurised by the master microfluidic module, and all secondary microfluidic modules can deliver reagents to an analysis chip mounted on the measurement device. Advantageously, this allows the system to be extended to deliver a huge number of reagents from a range of cartridges in any desired sequence.

Thus, in a preferred implementation at least two secondary microfluidic modules are attached to the master microfluidic module in a daisy chain configuration, such that the external pressure input connector of the secondary microfluidic module l+1 is connected to the external pressure output connector of secondary microfluidic module l; and the external reagent output connector of secondary module l+1 is connected to the external reagent input connector of secondary microfluidic module l, where l is greater than or equal to 1.

Furthermore, in instances where the measurement device incorporates an enclosure housing the analysis chip mount, the measurement apparatus, and the master microfluidic module, this daisy-chaining allows the number of reagents fed to an analysis chip to be increased without having to accommodate any additional components within the enclosure of the measurement device. Thus, the design of the enclosure, analysis chip mount, measurement apparatus and master microfluidic module can be optimised to be as compact as possible, without having to adapt to take into account the number and nature of the secondary microfluidic modules. Advantageously, this compact design reduces the length of the flowpath from the reagent cartridge to the analysis chip, minimising the internal volume, and hence minimising waste of potentially expensive and difficult to obtain reagents.

Most preferably, the reagent manifold of the secondary microfluidic module comprises a fluidic chip socket, for receiving a fluidic chip. In other words, the reagent manifold comprises a fluidic chip socket, having a plurality of fluidic chip socket inlet ports and fluidic chip socket outlet ports, each fluidic chip socket inlet port being fluidly connected to a chip input line in fluid communication with the reagent cartridge/reagent cartridge socket (the fluidic chip socket inlet port being connected to said associated multi-way valve assembly, for selectively connecting the chip input line to either the cartridge socket reagent line or the external reagent input line, in embodiments incorporating such an assembly) and each outlet port being fluidly connected to said reagent output line.

The invention extends to instances in which the secondary microfluidic unit includes a fluidic chip mounted to said fluidic chip socket. The fluidic chip may be mounted (e.g. plugged) directly on the fluidic chip socket, or may be mounted via the linker (e.g. a patch cable) described below.

Optionally, the fluidic chip has flowpaths to simply bridge the fluidic chip socket inlet ports and fluidic chip socket outlet ports. Such a fluidic chip may be referred to as a “bridging chip”. Such a bridging chip may come pre-installed as standard in secondary microfluidic modules incorporating said fluidic chip socket. The bridging chip may consist of a substrate having loops of tubing connecting each of the fluidic chip socket inlet ports to a corresponding fluidic chip socket outlet port. Such tubing is preferably relatively short (for example, less than 2 cm, less than 1.5 cm) to minimise the internal volume of the system.

Optionally, the fluidic chip can be used to establish non-standard flow. For example, the fluidic chip may have branched channels, to connect one fluidic chip socket inlet port to two or more fluidic chip socket outlet ports, or conversely to connect two or more fluidic chip socket inlet ports to one fluidic chip socket outlet port. In another example, the fluidic chip may include an incubation chamber fluidly connected to two or more fluidic chip socket inlet ports, to allow the incubation of reagents together before delivery to the master microfluidic module.

Suitably, the secondary microfluidic module includes an enclosure, housing the components of the secondary microfluidic module set out above. The various connectors are generally positioned on the outside of the enclosure (as part of the external surface of the enclosure, or extending out of the external surface of the enclosure) to aid their interconnection. The connectors of different modules are generally connected/linked by a linker, as described below.

Due to the advantages associated with the microfluidic modules of the present invention, the present invention also provides (as a separate aspect, independent of all others) a microfluidic system, comprising a master microfluidic module as defined herein connected to one or more secondary microfluidic modules as defined herein. Separate aspects also comprise a master microfluidic module as defined herein and (separately) a secondary microfluidic module as defined above. In these separate aspects, the modules may have any of the optional and preferred features described herein, either individually or in combination.

It is noted that many of the labels used in relation to the secondary microfluidic module are the same as those used in relation to the master microfluidic module, for ease of understanding. However, the skilled reader recognises that the parts mentioned in relation to the secondary microfluidic module are distinct parts from those mentioned above in relation to the master microfluidic module, unless otherwise indicated. For example, the external pressure output connector and external reagent input connector mentioned above in relation to the secondary microfluidic module are distinct from the external pressure output connector and external reagent input connector mentioned above in relation to the master microfluidic module.

Connectors

The external pressure input connector, external pressure output connector, external reagent input connector and reagent output connector is a coupling adaptor, such as a plug or socket, which can be fluidly connected with one another in the manner described above.

Suitably, the connectors provide an array of orifices fluidly connected to (leading into) the relevant external pressure/reagent lines. For example, the various external pressure/reagent lines may be tubing which is inserted into an array of orifices provided on the connector. The array of orifices may be any suitable arrangement, such as a linear array.

As noted above, the connectors can be formed as part of the enclosure of the measurement device and/or secondary microfluidic modules. For example, the connectors may be female connectors (in other words, a socket), e.g. taking the form of a recessed area in the enclosure, with the relevant inlets/outlets opening into the recessed area. Alternatively, the connectors may be male connectors, e.g. taking the form of a protruding area of the enclosure with the inlets/outlets opening on the protruding area.

Alternatively, the connectors are not integral to the enclosure and instead take the form of a separate coupling adaptor provided at the end of the relevant external pressure/reagent lines (e.g. tubing), such that the combination of coupling adaptor and external pressure/reagent lines take the form of a (flexible) cable.

In a particularly preferred embodiment, the microfluidic module (master or secondary) includes a terminal block having at least one input adaptor (plug/socket) fluidly connected to an output adaptor, wherein the connectors take the form of a flexible cable having a coupling adaptor which interfaces with the input adaptor (plug/socket) provided on the terminal block. In this way, further modules can interface with the connectors via the terminal block, by inserting the connectors of the further module to the output adaptors of the terminal block. In other words, the terminal block acts as an intermediary component, to facilitate interconnection of modules.

Preferably, the terminal block is mounted on or integral to the enclosure, ideally next to/in close proximity to the cartridge/cartridge socket since this configuration allows the device to be relatively compact.

The external pressure input connector of a secondary microfluidic module may plug directly into the external pressure output connector of the master microfluidic module or the external pressure output connector of a further secondary microfluidic module. Similarly, the reagent output connector of a secondary microfluidic module may plug directly into the external reagent input connector of the master microfluidic module or the external reagent input connector of a further secondary microfluidic module.

Alternatively, the connectors of the various modules may be connected through a linker. The linker may take the form of an array of flexible tubing terminating in a plug or socket at either end. Such a linker may be referred to as a “patch cable”. Generally, the linkers are relatively short, to minimise the introduction of internal volume into the system. However, linkers may be offered in different lengths to give consumers flexibility in configuring their systems.

Preferably, both the master and secondary microfluidic modules incorporate such terminal blocks, and the connection between the modules is achieved by a patch cable as described above.

The connectors may be connected simply via friction fit. However, preferably the connectors are locked in place relative to one another, in particular to avoid the pressure of fluids through the system undoing connections. To this end, the connectors are preferably connected through a quick-release mechanism (as opposed to a threaded engagement, requiring several turns to unlock). Advantageously, this allows easy connection between modules, facilitating the “plug and play” nature of the system. The quick release mechanism may be, for example, a mechanical quick release mechanism (such as a clamp or clip, in which a mechanical part releasably locks in place), a magnetic quick release mechanism, or an electronic quick release mechanism, of which mechanical quick release mechanisms (such as clips or clamps), are preferred due to their simplicity of construction and use. The quick release mechanism may be provided as part of the connectors themselves. Alternatively, the quick release mechanism may be a separate part. In a particularly preferred embodiment, modules are linked together via the above-mentioned linkers (preferably a patch cable) which are secured in place through a quick release mechanism.

In instances in which a connector is not in use (for example, in which the master microfluidic module is not attached to a secondary microfluidic module) the relevant connector may be sealed with a capping seal. For example, a capping seal applied to the external pressure output connector of a master microfluidic module can prevent depressurisation of the master microfluidic module when a secondary microfluidic module is not connected.

Multi-Way Valve Assemblies

Each of the multi-way valve assemblies described above may be a 3-way valve assembly, or take the form of two 2-way valves. In the latter case, the two 2-way valves essentially serve the same function as a 3-way valve, but with additional functionality as described below.

For example, each cartridge pressurisation valve can comprise of consist of two 2-way valves: with the pressure feed line split so as to be connected to the inlets of (i) a first 2-way valve with an outlet connected to the external pressure output line, and (ii) a second 2-way valve with an outlet connected to the cartridge socket pressure line.

Similarly, the chip valve can comprise or consist of two 2-way valves: with the chip input line split so as to be connected to the outlets of (i) a first 2-way valve with an inlet connected to the external reagent input line and (ii) a second 2-way valve with an inlet connected to the cartridge socket reagent line. The use of two 2-way valves for each chip valve is preferred over the use of a single 3-way valve, because it allows more control over the flowpaths. In particular, for a 3-way valve at least one flowpath is always open, but the use of two 2-way valves allows both valves to be closed to shut off the flowpath to the chip input line, or for both two 2-way valves to be open to allow the external reagent line to be used to refill the cartridge, for example.

In a particularly useful configuration, each cartridge pressurisation valve is a 3-way valve, and each chip valve consists of two 2-way valves. Advantageously, this configuration uses the more compact 3-way valve for cartridge pressurisation (where the need to open/close both sides of the valve simultaneously is not important) but uses two 2-way valves for the chip valve to allow more complex flow patterns, as described above.

Preferably, each valve of the multi-way valve assembly is a latching or bistable valve. This allows the multi-way valve assembly to retain a particular configuration without the need for constant actuation, which avoids excessive heat generation. This is particularly important when the master microfluidic module is housed within the same enclosure as the measurement apparatus and the analysis chip, since heat build-up can damage both samples and measurement apparatus and/or cause thermal drift in the measurement apparatus.

The valves may be, for example, a latching, diaphragm, slipper or rocker valve. The valves may be, for example, solenoid valves, piezo actuated valves, or shape memory alloy valves, although generally solenoid valves are used.

External Pressure Source

As explained above, the pressure feed lines of the master microfluidic module are connectable to an external pressure source, to allow pressurisation of the microfluidic system as a whole.

The present invention also extends to embodiments in which the measurement device includes at least one pressure source connected to the plurality of pressure feed lines. The external pressure source(s) generally supplies a positive pressure to push reagents out of a reagent cartridge connected to the master microfluidic module (either via the cartridge socket of the microfluidic module, or as part of a secondary microfluidic module as described above). However, preferably the external pressure source(s) are capable of supplying either a positive pressure or a negative pressure (suction) to the pressure feed lines (in other words, references to “pressurisation” above and below can refer to both positive and negative pressures). This may be useful, for example, in instances where multiple reagents must be agitated or mixed. For example, in instances where the reagent comprises solid particles that must be broken down, it can be useful to rapidly alternate between positive and negative pressure so as to agitate reagents within the fluidic system. Alternatively, in some instances it may be useful to sequentially deliver different reagents from two reagent reservoirs and then subsequently suck the two reagents up into a further reagent reservoir (either empty, or filled with an alternative reagent) to incubate the sample for a set amount of time, before applying a positive pressure so as to dispense from that reservoir. Furthermore, the application of a negative pressure may be used to backfill a reagent cartridge, to replenish the reagent cartridge after use.

In instances where a user wishes to pressurise only a subset of the pressure feed lines, they may choose to connect only a subset of the pressure feed lines of the master microfluidic module to the external pressure source, whilst leaving the remaining pressure feed lines disconnected. However, preferably, each of the pressure feed lines of the master microfluidic module has an associated pressure source valve, to control the pressurisation of the pressure feed lines.

Optionally, each pressure source valve is a 2-way valve to open and close the flowpath between the external pressure source and an associated pressure feed line. Preferably, each pressure source valve is a multi-way valve assembly, with the outlet connected to the pressure feed lines and the inlets connected to multiple external pressure sources supplying different pressures. For example, each pressure source valve may be a multi-way valve assembly connected to a first external pressure source operable at pressure P1, and a second external pressure source operable at pressure P2, where pressure P1 is different to pressure P2. This may take the form of a 3-way valve with a first inlet connected to the first external pressure source operable at pressure P1, and a second inlet connected to the second external pressure source operable at a pressure P2. Alternatively, this may take the form of two 2-way valves, with the pressure feed line split so as to be connected to the outlets of (i) a first 2-way valve with an inlet connected to the first external pressure source and (ii) a second 2-way valve with an inlet connected to the second external pressure source.

Such a system can be particularly advantageous when the master microfluidic module is connected to one or more secondary microfluidic modules which operate best at different pressures. In such instances, the pressure source valves of a first subset of the pressure lines of the master microfluidic module may direct flow from a first pressure source to the reagent cartridge, and the multi-way valve assemblies of a second subset of the pressure lines of the master microfluidic module may direct flow from a second pressure source to a secondary microfluidic module. For example, the master microfluidic module may be used to slowly deliver a fluid to a sample of cells at low pressure to cause staining without moving the cells, and the secondary microfluidic module may quickly deliver a fluid at high pressure to cause movement of the cells or achieve hydrodynamic focussing.

Cartridge Socket

The master microfluidic module incorporates a cartridge socket for fluid connection to a reagent cartridge. In addition, the (or each) secondary microfluidic module preferably incorporates a cartridge socket, as described above.

The cartridge socket is a mount which allows a cartridge to be reversibly attached to the relevant microfluidic module. It comprises an array of cartridge socket inlet ports and an array of cartridge socket outlet ports which can be fluidly connected to corresponding ports on a cartridge. The number of cartridge socket inlet ports and cartridge socket outlet ports generally corresponds to the number of pressurisation units and chip input units, and may be, for example 2 or more (of each type of port), 3 or more, 4 or more, 5 or more, 6 or more, 7 or more, 8 or more, 12 or more, or 16 or more. Usually, there will be 4, 6, or 8 of each type of cartridge port.

The connection between reagent cartridge and cartridge socket may be direct (with the reagent cartridge plugging directly in a cartridge socket) or indirect (with the connection being made via a linker). Direct connection is preferred, such that the array of cartridge socket inlet ports and the array of cartridge socket outlet ports mate with corresponding ports on a cartridge.

The cartridge socket inlet ports may include holes/recesses, optionally incorporating a gasket/seal, for insertion of corresponding protrusions from a cartridge.

More preferably the cartridge socket inlet ports and cartridge socket outlet ports of the cartridge socket include protrusions, such as needles, for insertion into corresponding holes (ports) on a cartridge. This is advantageous because the provision of protrusions on a cartridge can be problematic from a safety and practical standpoint. For example, in general a user will have to pick up, hold and manipulate a cartridge, and thus the provision of protrusions on the cartridge can lead to a risk of the user accidentally stabbing themselves, contacting and contaminating the protrusions, and/or damaging the protrusions. This is less of an issue when the cartridge socket incorporates such protrusions, because the user will not have to handle the socket in the same way, since it is built into the microfluidic module itself. Furthermore, the provision of protrusions on a cartridge can prevent the user from placing the cartridge on a surface, particularly if the protrusions are deformable. In particular, in preferred configurations described below the cartridge inlets and outlets are placed at the bottom of the cartridge, and reagent reservoirs at the top, meaning that users will ideally have to rest the cartridge on its bottom to limit the chances of reagent spilling out of the reservoirs.

Suitably, the cartridge socket inlet ports and cartridge socket outlet ports are provided as part of a fixed array. For example, the cartridge socket inlet ports and cartridge socket outlet ports may comprise needles provided with a screw thread, screwed into position in corresponding holes on the measurement device, to ensure correct positioning. The cartridge socket pressure lines and cartridge socket reagent lines may then be pushed into place within the needle, for example through a friction fit.

Alternatively, the cartridge socket inlet ports and cartridge socket outlet ports may be sprung-loaded. In other words, the cartridge socket incorporates one or more loading springs which urge the ports towards a cartridge inserted into the cartridge socket. Advantageously, this helps to ensure a sealing connection between the ports and a cartridge. To achieve this, the loading spring(s) should allow the cartridge socket inlet ports and cartridge socket outlet ports to be compressed in the absence of a cartridge.

In one implementation, each cartridge socket inlet port and each cartridge socket outlet port includes a loading spring (for example a helical spring) to urge the port towards a cartridge inserted into the cartridge socket. Suitably, the loading spring is positioned under a socket base (on the opposite side of the base to the cartridge, in use) so as not to interfere with or compromise the ability of a cartridge to interface with the ports. The base may itself include a spring loading surface, against which the loading spring is compressed when a cartridge is inserted onto the ports (for example taking the form of a base plate against which the loading springs are compressed). However, preferably each loading spring is trapped between the socket base and a mounting surface (for example, part of the enclosure of the measurement device), so that the loading spring is compressed against the mounting surface when a cartridge is inserted onto the ports.

Preferably, the cartridge socket incorporates a cartridge securing element, for fixing the cartridge in position and ensuring a sealing connection between the cartridges and the cartridge socket. This may be any conventional means, such as mechanical fixings (clips, screws and the like) or magnets. Preferably, the cartridge securing element is a quick release mechanism, allowing the cartridge to be easily removed, such as a snap-fit mechanism. For example, the cartridge socket may include one or more releasable clips. The cartridge securing element is particularly advantageous in implementations in which the cartridge socket inlet ports and cartridge socket outlet ports are sprung-loaded, because the cartridge securing element allows the springs to be retained in their compressed configuration, urging the ports into the cartridge.

Preferably, the cartridge socket incorporates one or more socket guides to correctly position the cartridge relative to the cartridge socket inlet ports and cartridge socket outlet ports. For example, the cartridge socket may incorporate a wall providing a surface for the cartridge to slide into position. Preferably, the cartridge guide takes the form of a guide rail.

Optionally, the cartridge guide also serves as the cartridge securing element. For example, the cartridge socket may have one or more guide rails which serve as a securing element, as set out above. For example, the cartridge socket may include a guide rail having a lip which clips into position on the cartridge (for example, over the top of the cartridge) when the cartridge is fully inserted into the cartridge socket ports, wherein the guide rail can be deformed away from the cartridge to release the lip when the socket is to be removed. The guide rail may incorporate a hinge, preferably a living hinge (for example, a relatively thinner section) to aid deformation and/or a handle to help a user deform the clip. Optionally, the cartridge incorporates a corresponding groove or channel for receiving the guide rail, which allows the guide rail to secure the cartridge in multiple dimensions.

In a most preferred implementation, the cartridge socket has at least two upstanding guide rails which slot into corresponding grooves provided in opposing sides of the reagent cartridge to secure the cartridge in the x-y plane, wherein at least one of the guide rails includes a lip which clicks into position on the cartridge (for example, over the top of the cartridge) to secure the cartridge in the z plane. Advantageously, this system allows the cartridge to be accurately positioned and secured in all dimensions without requiring excessively large guide elements, and the guide rails can be made relatively thin to facilitate them bending out of place to remove the cartridge.

Although described as individual elements, the guide rails and any cartridge securing elements may be interconnected as a single piece, which may be referred to as a “cartridge fixture”. The cartridge fixture may be integrally formed, for example, from plastic or metal.

Optionally, the cartridge socket includes an electrical contact for providing power to the cartridge and allowing exchange of electrical signals with a cartridge inserted into the cartridge socket. For example, each inlet and/or outlet port may incorporate an electrical contact for interfacing with a corresponding electrical contact on an inserted cartridge. In implementations were the cartridge ports correspond to needles, each needle may have a flange on which said electrical contact is provided. Optionally, the electrical contact on the cartridge socket is sprung loaded, to ensure proper mating with the electrical contact of a cartridge. For example, each inlet and/or outlet port may be a sprung-loaded port incorporating a flange with the port incorporating an electrical contact point. In this way, urging the flange upwards against a cartridge using a spring improves the insertion of the needles into the cartridge and ensures a stable electrical connection between the cartridge socket and cartridge.

Optionally, the cartridge socket incorporates an actuator, for actuating a cartridge inserted into the cartridge socket. In particular, the cartridge socket may incorporate a motor, for moving components of the cartridge (specifically, a rotor chip) as described in more detail below.

The particularly advantageous cartridge socket arrangements described above also constitute a separate aspect of the invention. In particular, in a separate aspect, the present invention provides a microfluidic system including a cartridge socket as described above, for receiving a reagent-containing reagent cartridge.

This independent aspect may have any of the optional or preferred features mentioned above in the general discussion of the cartridge socket.

The invention also extends to a cartridge socket having an attached reagent cartridge as described below, in particular one of those defined in the preferred first, second, third, fourth and fifth implementations below, as well as a microfluidic module incorporating a cartridge socket and attached reagent cartridge.

Reagent Delivery Cartridges

The cartridges suitable for use in the measurement device of the invention are not particularly limited.

Suitably, the reagent cartridge contains a plurality of reservoirs, a plurality of cartridge pressurisation ports for pressurising the reservoirs, and a plurality of cartridge outlet ports for dispensing reagent from the reservoirs.

In its simplest form, the reagent cartridge may consist of a plurality of reservoirs, each in fluid communication with an associated pressurisation port and cartridge outlet port. Optionally, the reagent cartridge may incorporate a valve system.

To improve the flexibility of the device the present inventors have developed cartridges which incorporate specialised valves to diversify the type of protocols which can be carried out.

Reagent Cartridges Based on Diaphragm Valves

In a first preferred implementation (also forming a separate aspect of the invention) the reagent cartridge comprises a housing containing:
a plurality of reagent reservoirs;
a plurality of cartridge pressurisation ports (connected to the cartridge socket inlet ports when installed on a microfluidic module) in fluid communication with the reagent reservoirs, for pressurising the reagent reservoirs in use;
a plurality of cartridge outlet ports (connected to the cartridge socket outlet ports when installed on a microfluidic module), for dispensing reagent from the cartridge in use; and
a valve assembly, for regulating flow of reagents from the reagent reservoirs to the cartridge outlet ports in use, the valve assembly comprising:
   a stator chip assembly, having a plurality of reagent channels each providing a flowpath from the reagent reservoirs to the cartridge outlet ports, each reagent channel having an associated valve section in which the reagent channel is capped with a flexible membrane, the valve section being actuatable between an open position in which the reagent channel is open and a closed position in which the flexible membrane is deformed so as to occlude the reagent channel; and
   a rotor chip, rotatable relative to the stator chip assembly between a first position and a second position, wherein the rotor chip includes an actuator surface which actuates the valve sections of the reagent channels, and wherein said rotation causes the actuator surface to actuate (open/close) a different subset of the reagent channels in the first position compared to the second position.

The actuator surface may be, for example, a protrusion provided on the surface of a disc. The disc may have a solid face, or may have hollow regions. Alternatively, the actuator surface may be provided by a feature mounted on a frame or arm of the rotor chip. The rotor chip may be, or incorporate, for example, a hollow cylinder with the rim of the cylinder providing the actuator surface (e.g. with a shaped rim so that certain sections project to provide the actuator surface which closes the valve section, and other sections being recessed to allow the valve section to open).

Advantageously, the routing of reagents from reservoir to outlet in such a cartridge can be controlled through rotation of the rotor chip.

Suitably, the stator chip assembly comprises a routing plate incorporating said reagent channels overlaid with a flexible membrane sheet to cap the reagent channels in said valve sections. Optionally, each of the valve sections may have its own associated flexible membrane/diaphragm. However, preferably a single flexible membrane sheet is used to cap all of the valve sections. In an especially preferred implementation, the reagent channels may take the form of a plurality of grooves on the routing plate which are capped by a single flexible membrane. Advantageously, such an arrangement can allow a single un-patterned flexible membrane to be used, which simplifies manufacture of the device. In other words, the flexible membrane may be a flat sheet, e.g. without surface features (such as convex or concave bumps or bulges) engineered in the surface.

Optionally, the cartridge pressurisation ports and cartridge outlet ports are provided on a mating surface of the housing, to allow the cartridge to be plugged into corresponding ports on the measurement device (suitably provided in the form of a cartridge socket, as described above).

Optionally all of the cartridge pressurisation ports and cartridge outlet ports are provided on said mating surface of the housing. Alternatively, the cartridge has cartridge pressurisation ports and at least one of the cartridge outlet ports provided on said mating surface of the housing, and at least one of the cartridge outlet ports provided on an alternative (external) surface (e.g. a non-mating surface) of the housing. In this way, the cartridge outlet ports on the alternative surface can allow reagents to be removed from the cartridge without being fed into the measurement device. These ports may be referred to as a “direct output” port. For example, the cartridge may have a plurality of cartridge outlet ports on the bottom mating face of the housing, and at least one cartridge outlet port provided on a side or the top of the housing. Direct outlet ports may allow reagents to be removed for sampling or quality control purposes (for example, to validate measurements carried out by the measurement device) or connected directly to other components (e.g. an analysis chip) directly by tubing so as to minimise internal volume between the reservoir and said other component.

The rotor chip may be rotatable by hand or, more preferably, by a motor (e.g. a servomotor). Optionally, the motor is part of the cartridge itself. However, more preferably, the motor is part of the device to which the cartridge is mounted, for example part of the cartridge socket as described above. In this way, the motor can be powered by the device, obviating the need for a motor and corresponding power source to be included in the cartridge itself, which would otherwise complicate construction of the cartridge. In particular, the cartridge is suitably a consumable component, in which case ease of manufacture and disposability (preferably by recycling as a single part—e.g. in a plastics waste stream) are highly advantageous. In such instances, the rotor chip may have a first face which provides the actuator surface, and a second face having a motor mounting adaptor. Most preferably, the mating surface of the housing has a motor access port providing access to the mounting face of the rotor chip. The motor mounting adaptor may be a recess for receiving the shaft of the motor.

In a preferred implementation, the stator chip assembly further comprises a plurality of pressure channels providing a flowpath from the cartridge pressurisation ports to the reagent reservoirs. In such instances, each pressure channel preferably has an associated valve section in which the pressure channel is capped with a flexible membrane, the valve section being actuatable between an open position in which the pressure channel is open and a closed position in which the flexible membrane is deformed so as to occlude the pressure channel. In such implementations, the same rotor chip may control the opening and closing of the valve sections of both the reagent channels and pressure channels. In such a cartridge the same rotor chip controls not only the reagents but also for the pressurisation system. In other words, the valve can control which reagent reservoirs are pressurised, and which reagent reservoirs are capable of delivering reagent.

The flexible membrane may be made from an elastomer, for example, polyurethane, silicone, polyethylene terephthalate, polycarbonate, polymethylmethacrylate, polyvinyl chloride, polypropylene, polyether, polyethylene, or polystyrene. Preferably, the flexible membrane is made from polyurethane or silicone.

In addition to the flexible membrane, the stator chip assembly may comprise one or more plates having the reagent channels, and optionally pressure channels, formed therein. The stator chip assembly may comprise multiple plates held together, for example, by adhesive, such as glue or double-sided tape. Alternatively, the stator chip assembly may be a single plate having the reagent channels (and optionally pressure channels) formed therein, overlaid with said flexible membrane. The single plate may be made by diffusion bonding multiple plates together.

For example, the stator chip assembly may comprise (or be made through diffusion bonding of) a reagent plate having reagent channels therethrough and a pressure plate having pressure channels therethrough. In such instances, at least one of the plates must accommodate bridging holes to allow throughflow from an adjacent plate to the reagent reservoirs, cartridge outlet ports and/or cartridge pressurisation ports, as appropriate.

Advantageously, constructing the stator chip assembly from multiple plates (either through adhering plates together, or permanently attaching through diffusion bonding) can allow a limited set of “standard” plates to be manufactured for use in a range of different cartridges. For example, in a “basic” cartridge incorporating eight reagent reservoirs, the stator chip assembly may incorporate a reagent plate having eight primary reagent channels for delivering reagent, along with a set of bridging holes that are not used during operation of the basic cartridge. For a more “advanced” cartridge incorporating sixteen reagent reservoirs, the stator chip assembly may incorporate an identical first reagent plate stacked on top of a second reagent plate. The first reagent plate is used to obtain reagent from eight of the reservoirs. The second reagent plate has eight reagent channels whose inlets mate with the bridging holes of the first reagent plate, and also has eight bridging holes which mate with the outlets of the first reagent plate. This simple stacking means that the cartridge can be adapted to allow for 16 reagents instead of 8 through the simple addition of a standard additional plate.

Optionally, the rotor chip and stator chip assembly include an indexing system, to help achieve the correct indexing between rotor chip and stator chip assembly. Preferably, the indexing system helps to calibrate the position of the rotor chip relative to the stator chip.

The indexing system may be a pneumatic-based indexing system. In such a system, the stator chip assembly may have a venting channel having an associated valve section capped with a flexible membrane, the valve section being actuatable between an open position in which the venting channel is open and a closed position in which the flexible membrane is deformed so as to occlude the venting channel, wherein the actuator surface is configured to actuate the valve section of the venting channel, and wherein, in use, the escape of air from the venting channel when the valve section is in its open position is indicative of the relative position of the stator chip assembly and rotor chip. The venting channel is connected or connectable to a pressure source. For example, the venting channel may be in fluid communication with one of said cartridge pressurisation ports (this may be achieved by connecting the venting channel to an empty reagent reservoirs, or branching one of pressure channels of the cartridge so as to pressurise the venting channel) or may be connected to an external pressure source. In use, when the venting channel is open the escape of gas may be detected, for example, through a user hearing the escape of gas or (more preferably) through provision of a pressure sensor to detect the escape of gas.

In these embodiments, the rotor chip may be movable between said first and second positions in which the actuator surface actuates a different subset of the reagent channels in the first position compared to the second position, and a third position in which the actuator surface actuates the venting channel.

Additionally, or alternatively, the one or more indexing elements may be a mechanical-based system. For example, the one or more indexing elements may be a spring plunger system (in particular a ball plunger system) provided at the interface between the rotor chip and stator chip. In a preferred implementation of a spring plunger system, a spring-loaded ball bearing is mounted on the face of one component (for example the rotor chip), and the face of the other component (for example, the stator chip assembly) includes one or more pockets into which the spring-loaded ball bearing is urged into as the rotor chip rotates, optionally with the provision of linking grooves between pockets to facilitate movement of the ball bearing between positions. The spring loading of the ball bearing may be achieved by providing each ball with an associated spring (either through use of a separate spring, or moulding a spring lever into the relevant chip), or by generally providing a spring to urge the rotor chip and the stator chip assembly together (the latter being preferred, since it also helps to improve the seal between the rotor chip and stator chip assembly). Alternatively, the indexing elements comprise one or more weak (e.g. permanent) magnets on the rotor chip and stator chip assembly which serve to index the rotor chip and stator chip at set positions, although this option is less preferred as the magnetic forces can create additional strain on the motor and could potentially interfere with reagent containing magnetic components (for example, magnetic beads). Advantageously, the use of one or more indexing elements allows correct positioning of the rotor chip and stator chip assembly without the need for high accuracy (expensive) motors.

Suitably, the rotor chip is rotatable in the xy plane, but does not undergo axial movement (in the z plane) during rotation between the first position and second position. In other words, the rotor chip does not “lift away” from the stator assembly during repositioning.

Diaphragm Valve—Direct Chip Contact Implementations

Optionally, said actuator surface on the rotor chip directly presses and deforms the flexible membrane of the valve sections, so as to occlude the reagent channels. Such an implementation may be referred to as a “direct chip contact” implementation. In direct chip contact implementations, rotating the actuator surface into contact with the valve section associated with a reagent channel closes that reagent channel. Continuing to rotate the rotor chip then takes the actuator surface out of contact with the valve section so as to open the reagent channel again.

The reagent cartridge may comprise resilient means (such as one or more springs) to urge the rotor chip against the stator chip assembly, whilst still allowing relative rotation.

Suitably, the rotor chip takes the form a disc/cylinder. The disc/cylinder may include said actuator surface on the face proximate to the stator chip assembly. For example, the disc/cylinder may have a profiled/contoured face, with relatively higher points on said face providing the actuator surface(s).

The actuator surface may take the form of, for example, one or more protrusions on the surface of the rotor chip. The protrusions may be, for example, a bump or a ridge. Advantageously, providing the protrusion in the form of a ridge or bump can allow a leak-proof seal of the valve sections whilst minimising the contact surface area between the protrusion and stator chip assembly during rotation of the rotor chip, thereby minimising friction and wear of the device.

In direct chip contact implementations, the actuator surface may be a notched ridge provided on the rotor chip. The notched ridge is provided on the face of the rotor chip which contacts the flexible membrane. Suitably, the notched ridge extends around the perimeter of the rotary valve. In such an implementation, a particular reagent channel can be opened by rotating the rotor chip until a notch in the notched ridge is aligned with the relevant valve section.

Optionally, the notched ridge has only a single notch, e.g. to allow only one valve section to be in the open position at a time. In this instance, the ridge may take the form of an incomplete ring circling the face of the rotor chip, e.g. with the ends not touching so as to form a gap corresponding to said one notch.

Alternatively, the notched ridge may have at least two notches. For example, the protrusion may take the form of two arcuate ridges circling the perimeter of the rotor chip, with diametrically opposed notches.

Alternatively, the notched ridge may have at least three notches, or at least four notches, so as to allow multiple valve sections to be in the open position simultaneously.

By “notch” we mean a portion in which the ridge is relatively lower in height above the surface of the rotary valve, or in which the ridge is absent, so as to reduce or avoid deformation of the flexible membrane. The notch can have any suitable profile, for example, square-edged, V-shaped, U-shaped. Preferably, however, the notch has rounded edges so as to limit the possibility of damage to the flexible membrane.

The actuator surface may be provided by more than one protrusion. For example, the rotor chip may have two or more protrusions (e.g. bumps or ridges), three or more protrusions, four or more protrusions, or five or more protrusions.

In addition to embodiments in which the rotor chip has protrusions extending from a face of the rotor chip to provide the actuator surface, the actuator surface may also be provided by features mounted on a suitable frame. For example, the rotor chip may have a hollow cylinder with the rim of the cylinder providing said actuator surface, e.g. with protrusions provided on the cylinder rim (bumps, or crests in the cylinder's rim). As an alternative example, the rotor chip may comprise an arm which rotates relative to the stator chip assembly, with the arm providing said actuator surface. Alternatively, the rotor chip may comprise a ring mounted to a shaft through suitable supports/struts, with the ring providing the actuator surface and incorporating one or more gaps analogous to the “notches” described above.

In direct chip contact implementations, the rotor chip may comprise an actuator surface having a protrusion (e.g. in the form of a bump and/or circular ridge) and the stator chip assembly may comprise a circular groove in which the protrusion is positioned during rotation. The circular groove may serve as a track for the protrusion during rotation. Advantageously, this can facilitate alignment of the rotor chip and the stator chip assembly, both during manufacture and during operation of the device. In a particularly preferred implementation, the valve assembly comprises:
a stator chip assembly, having said plurality of reagent channels each providing a flowpath from the reagent reservoirs to the cartridge outlet ports, the plurality of reagent channels intersecting (e.g. crossing, originating from or terminating at) a circular groove, each reagent channel having an associated valve section provided at the circular groove in which the reagent channel is capped with a flexible membrane, the valve section being switchable between an open position in which the reagent channel is open and a closed position in which the flexible membrane is deformed so as to occlude the reagent channel;
a rotor chip, rotatable relative to the stator chip assembly between a first position and a second position, the rotor chip having a protrusion (e.g. in the form of a notched ridge, as described above) which contacts and deforms the flexible membrane so as to close at least one of the valve sections, the protrusion being sited within the circular groove of the stator chip assembly wherein said rotation causes the protrusion to close a different subset of the reagent channels in the first position compared to the second position.

Optionally, the rotor chip is made from PTFE or UHMWPE, since these materials ensure low friction between the rotor chip and stator chip assembly. Optionally, the rotor chip is integrally formed, e.g. through injection moulding.

Optionally, the rotor chip comprises one or more protrusions formed from a low friction material, such as PTFE or UHMWPE, with the main body of the rotor chip formed from another material. This can allow a low friction contact between the protrusion of the rotor chip and stator chip assembly, whilst allowing the main body of the rotor chip to be made from relatively cheaper materials.

Optionally, the rotor chip and/or flexible membrane is provided with a surface coating to decrease friction.

Optionally, a lubricant is present between the rotor chip and the stator chip assembly.

Diaphragm Valve—Indirect Chip Contact Implementations

As an alternative to direct chip contact, the actuator surface on the rotor chip may instead move a separate valve actuator which interacts with the flexible membrane. Such implementations may be referred to as “indirect chip contact” implementations. Advantageously, such implementations can avoid contact of the flexible membrane with rotating parts, minimising frictional wear on the flexible membrane and thereby having the potential to prolong the lifetime of the cartridge.

For example, the rotor chip may serve as a cam which converts rotational movement of the rotor chip into linear motion of a valve actuator so as to actuate the valve sections of the stator chip assembly.

In one example of such an implementation, the valve actuator assembly may comprise a plurality of pins which are actuated by the actuator surface on the rotor chip, e.g. by being pushed into the flexible membrane or pushed away from the flexible membrane by the actuator surface.

The pins may be biased towards a resting state by resilient means, such as a spring. To this end, the valve actuator assembly preferably comprises a plurality of cantilever-mounted pins attached to a support body. Suitably, a cantilever-mounted pin is associated with each valve section of the stator chip assembly. Advantageously, such a valve actuator assembly can be manufactured as a single part (for example, by injection moulding), and the use of a cantilever construction avoids the need to rely on gravity or separate resilient means (e.g. springs) to return the pins to their resting state after actuation.

In such instances, the support body may take the form of a frame, and most preferably comprises a ring. Optionally, the cantilever-mounted pins are attached on the outside of the frame/ring. However, more preferably, the cantilever-mounted pins are attached on the inside of the frame/ring, because for a valve actuator assembly of a given overall diameter positioning the pins on the inside of the ring maximises the circumference of the frame/ring available for attachment of each cantilever, can simplify attachment of the frame/ring to other components of the reagent cartridge, and can allow a more compact construction of the rotor chip.

Each cantilever-mounted pin may be bendable from a resting state in which its associated valve section is open to an engaged state in which the pin deforms the flexible membrane to close the valve section. In such embodiments, the actuator surface pushes the cantilever-mounted pin into the flexible membrane to close a valve section. Such an arrangement may be referred to as a “normally open” embodiment, since the valve sections will be open in the absence of an applied force from the rotor chip. The rotor chip may serve as an end-face cam (with the actuator surface corresponding to the face of the rotor chip) which pushes the underside of the pins towards the flexible membrane. Alternatively, the rotor chip may serve as a cylindrical cam, with the actuator surface provided by a groove in the sidewall of the rotor chip, and the cantilever end sitting on top of the actuator surface (by “on top” it is meant relatively closer to the stator chip assembly).

Alternatively, each cantilever-mounted pin may be bendable from a resting state in which the pin deforms the flexible membrane to close its associated valve section to an engaged state in which the pin is bent away from the flexible membrane so as to open the valve section. Such an arrangement may be referred to as a “normally closed” embodiment, since the valve sections will be closed in the absence of an applied force from the rotor chip. In such embodiments, the actuator surface pushes the cantilever-mounted pin away from the flexible membrane to open the valve section. For example, the rotor chip may serve as a cylindrical cam, with the actuator surface provided by a groove in the side of the rotor chip, and the cantilever end sitting underneath the actuator surface (e.g. within the groove) such that the actuator surface can push the pins away from the flexible membrane. Alternatively, the actuator surface may be provided by the underside of the rotor chip (by “underside” it is meant the face relatively further away from the stator chip assembly).

In instances where the valve actuator corresponds to a plurality of pins attached to a frame (e.g. ring), the rotor chip preferably comprises a main body having a shaft penetrating through the underside of the centre of the frame, and a capping body attached to the shaft on the topside of the frame. This construction allows the valve actuator to be formed as an integral part, with the rotor chip subsequently formed around the valve actuator. In the “normally open” embodiment discussed above the actuator surface may be provided on the main body of the rotor chip. In the “normally closed” embodiment the actuator surface may be provided on the underside of the capping body. Optionally, the main body and capping body together define said groove in the side of the rotor chip.

The pin may have any suitable shape for pushing into the membrane. However, preferably the pin is a rounded (e.g. domed) pin to minimise the possibility of damaging the flexible membrane.

The actuator surface may include, for example, one or more protrusions. The protrusions may be, for example, a bump or a ridge. Preferably, the bump or ridge is smooth-edged so as to gradually push the valve actuator, thereby minimising damage.

In the indirect chip contact embodiments above, the rotor chip preferably does not directly contact the flexible membrane.

In particularly preferred implementations of the “indirect chip contact” version of the reagent cartridge, the reagent cartridge comprises:
a plurality of reagent reservoirs;
a plurality of cartridge pressurisation ports (connected to the cartridge socket inlet ports when installed on a microfluidic module) in fluid communication with the reagent reservoirs, for pressurising the reagent reservoirs in use;
a plurality of cartridge outlet ports (connected to the cartridge socket outlet ports when installed on a microfluidic module), for dispensing reagent from the cartridge in use; and
a valve assembly, for regulating flow of reagents from the reagent reservoirs to the cartridge outlet ports in use, the valve assembly comprising:
   a stator chip assembly, having a plurality of reagent channels each providing a flowpath from the reagent reservoirs to the cartridge outlet ports, each reagent channel having an associated valve section in which the reagent channel is capped with a flexible membrane;
   a valve actuator, comprising a plurality of pins which are movable to actuate the valve sections between an open position in which the reagent channel is open and a closed position in which the flexible membrane is deformed so as to occlude the reagent channel; and
   a rotor chip, rotatable relative to the valve actuator between a first position and a second position, wherein the rotor chip includes an actuator surface (e.g. a protrusion) which pushes the pins to actuate the valve sections, and wherein said rotation causes the actuator surface to actuate (open/close) a different subset of the valve sections in the first position compared to the second position.

Reagent Cartridges Based on Rotary Valve with Linking Channels

In another set of preferred implementations, the reagent cartridge incorporates a rotor chip which forms part of a rotary valve to help direct the flow of reagents. In a second preferred implementation of the reagent cartridge (also forming a separate aspect of the invention), the reagent cartridge comprises a housing having a mating surface for connection to a cartridge socket (for example, as defined above), the housing containing:
a plurality of reagent reservoirs;
a plurality of cartridge pressurisation ports (connected to the cartridge socket inlet ports when installed on a microfluidic module) in fluid communication with the reagent reservoirs, for pressurising the reagent reservoirs in use;
a plurality of cartridge outlet ports (connected to the cartridge socket outlet ports when installed on a microfluidic module), for dispensing reagent from the cartridge in use; and
a valve assembly, for regulating flow of reagents from the reagent reservoirs to the cartridge outlet ports in use, the valve assembly comprising:
   a stator chip assembly, comprising
      a plurality of primary reagent channels fluidly connected to the reagent reservoirs; and
      a plurality of secondary reagent channels fluidly connected to the cartridge outlet ports; and
   a rotor chip, sealingly engaging the stator chip assembly, the rotor chip having one or more linking channel(s) for fluidly connecting the primary reagent channels and secondary reagent channels; wherein the rotor chip is rotatable relative to the stator chip assembly between a first position and a second position, and wherein said rotation causes the linking channel(s) to establish a different fluid connection between the primary reagent channel(s) and the secondary reagent channel(s) in the first position compared to the second position;
wherein the cartridge pressurisation ports and cartridge outlet ports are provided on the mating surface of the housing, to allow the cartridge to be plugged into corresponding ports on the measurement device (suitably provided in the form of a cartridge socket, as described above).

Advantageously, such a cartridge is very simple to connect to a cartridge socket, and yet allows complex flow patterns to be established to the cartridge socket.

To clarify, the system is configured such that when a positive pressure is applied to the cartridge pressurisation ports, the “primary” reagent channels flow reagent from the reagent reservoir into the rotor chip (in other words are input channels with reference to the rotor chip) and the “secondary” reagent channels flow reagent away from the rotor chip to the cartridge outlet ports (in other words are output channels with reference to the rotor chip). However, for the avoidance of doubt it should be noted that when a negative pressure is applied so as to draw material into the reagent reservoirs, the situation is reversed.

The rotor chip has first and second opposite faces. Suitably, the rotor chip takes the form a disc/cylinder, as in the diaphragm valve implementations discussed above.

Suitably, the fluid connection between the primary reagent channel and secondary reagent channel occurs on a face of the rotor chip. In a preferred implementation, the primary reagent channels and secondary reagent channels of the stator chip assembly open onto the same face of the stator chip assembly, and the rotor chip assembly engages said face of the stator chip assembly. This has several advantages. Firstly, it means that the linking channels of the rotor chip do not have a required directionality—for example, it is possible for an opening of a linking channel to serve as either an inlet or an outlet (depending on the precise geometry of the linking channel and primary/secondary channels). Secondly, it makes it easier to ensure a sealing connection between the stator chip assembly and rotor chip, since only one face of the rotor chip is in contact with the stator chip assembly. Thirdly, the rotor chip can be made relatively more compact. This is because each opening generally requires a minimum thickness t to be formed in the rotor chip, so forming the openings on the same side allows these openings to be accommodated in a thickness t, whereas providing openings on opposite faces of the rotor chip requires a thickness of at least 2t to accommodate the openings. Fourthly, having the openings on only one face of the rotor chip allows the other face to be put to a variety of uses, for example to include drive apparatus for a motor (as discussed below).

With this in mind, as above, in a preferred implementation the rotor chip has a first face which engages the stator chip assembly, and a second face having a motor mounting adaptor.

In these embodiments in which the rotor chip engages the stator chip assembly through a single interface (in other words, a single face of the rotor chip engages a single face of the stator chip assembly), the reagent cartridge preferably comprises resilient means (such as one or more springs) to urge the rotor chip against the stator chip assembly, whilst still allowing relative rotation.

Preferably, the rotor chip incorporates a plurality of linking channels. Advantageously, incorporating a plurality of linking channels can expand the range of primary reagent channels and secondary reagent channels that can be connected together, thus expanding the range of possible protocols.

Furthermore, the provision of a plurality of linking channels can be used to minimise cross-contamination during protocols. In particular, different reagents can be delivered to a sample cell through entirely separate flowpaths, using one linking channel to link a first primary reagent channel to a first secondary reagent channel, and another linking channel to link a second primary reagent channel to a second secondary reagent channel. This is in contrast to, for example, the device taught in WO 2019/063375 having a shared outlet channel, meaning that reagents from the reagent reservoirs must inevitably pass along the same channel on their way to the analysis chip. In certain instances, this will necessitate timely and wasteful flushing steps between delivery of reagents, to prevent contamination of the later reagent with the earlier reagent. This could be particularly problematic in instances where two or more reservoirs contain a test sample for analysis, where it is vital to prevent cross-contamination. In contrast, in the present case, providing the rotor chip with a plurality of linking channels allows different reagents to be routed via entirely different paths, minimising or avoiding the time and waste of flushing steps.

In instances where the rotor chip incorporates a plurality of linking channels, these may all be arranged in the same plane of the rotor chip (in other words, within the same depth of the rotor chip, as measured from the face of the rotor chip). In such instances, the linking channels may be curved within the plane to increase the density of channels which can be accommodated on the rotor chip. Advantageously, providing the linking channels in the same plane can simplify construction, and allows the rotor chip to be made relatively thin so as to decrease the size of the cartridge as a whole. Alternatively, the linking channels may be provided in different planes of the rotor chip, for example to increase the number of channels that can be accommodated on the rotor chip (e.g. allowing paths to cross in a way not possible within a single plane) or to establish longer flowpaths to suit a particular protocol.

Preferably, the linking channels comprise or consist of closed channels having openings (an inlet and an outlet) on a face of the rotor chip. Although some or all of the linking channels may be open grooves on the face of the rotor chip which are sealed by the stator chip assembly, this configuration is not preferred. In particular, whilst open grooves simplify construction of the rotor chip, and allow the rotor chip to be made relatively thin, it can be more difficult to ensure a sealing connection between the stator chip assembly and rotor than with closed channels, and open channels can also cause cross-contamination between channels.

Optionally, the rotor chip incorporates a plurality of linking channels for linking any primary reagent channel to any secondary reagent channel. Such a chip may be referred to as a “distribution chip”. For example, the stator chip assembly may have X primary reagent channel outlets spaced in a pattern (for example an arc or circle configuration), and Y secondary reagent channel inlets spaced in a pattern (for example, an arc or circle configuration), and the rotor chip assembly may have linking channels capable of linking any of the X primary reagent channel outlets to any of the Y secondary reagent channel inlets. Generally, for X primary reagent channel outlets and Y secondary reagent channel inlets it will be necessary to provide at least X+Y−1 channels to link all ports together (in instances where two of the ports are diametrically opposed relative to the centre of the rotor chip), more usually X+Y channels.

Optionally, the rotor chip incorporates at least one branched channel to connect a primary reagent channel to multiple secondary reagent channels, or a secondary reagent channel to multiple primary reagent channels. Such a chip may be referred to as a “mixing” chip.

Suitably, the linking channels include openings (inlets and outlets) to interface with the primary reagent channel outlets and secondary reagent channel inlets. Optionally, these openings may be the same size and shape as the primary reagent channel outlets and secondary reagent channel inlets, for example, a uniform-sized circle. Alternatively, at least one of the linking channels may include a slot-shaped opening extending around the rotational axis of the rotor chip. Such a slot-shaped opening may engage the same primary reagent channel outlet and/or secondary reagent channel inlet in the first position and second position. In such instances, the slot-shaped opening may be positioned close to the centre of the rotor chip so as to allow a relatively short slot to engage the relevant primary reagent channel outlet and/or secondary reagent channel inlet over a wide angle of rotation, so as to minimise the internal volume of the rotor chip. For example, for a rotor chip of radius R the slot-shaped opening may be within the of the centre of the rotor chip, within 0.2R, within 0.3R, within 0.4R or within 0.5R.

Preferably, the rotor chip includes a plurality of linking channels, and the openings of the linking channels are positioned according to a regular angular pattern. In particular, the use of a regular pattern facilitates indexing of the rotor chip with the stator chip assembly, because the rotor chip can be moved in standardised angle steps. For example, different configurations of connections between the rotor chip and stator chip assembly may be achieved by rotating the rotor chip between n different positions (including said first position and second position) according to a set angular interval, for example, corresponding to 360°/n where n=2, 3, 4, 5, 6, 7, 8, 9, 10 and so on. This angular interval may be, for example, 120°, 90°, 72°, 60°, 51.4°, 45°, or 36°. To achieve this, the angle between any two openings on the rotor chip, as measured from the axis of rotation of the rotor chip, is generally a multiple of a set interval 360°/n where n is an integer of 3 or more, for example, the interval may be a multiple of 120°, 72°, 60°, 51.4°, 45°, 40° or 36° and so on.

The openings of the linking channels may all be positioned at the same distance from the axis of rotation of the rotor chip. In this way, the openings all sweep through the same circle when the rotor chip is rotated—in other word, the openings are said to be on the same “track”.

Alternatively, the openings of the linking channels may be positioned on different (multiple) tracks, in other words, at different distances form the axis of rotation of the rotor chip.

Optionally, different tracks are provided for interfacing with a different subset or type of channel on the stator chip assembly.

For example, openings for interfacing with the primary channels may be provided on a first track, and openings for interfacing with the secondary channels may be provided on a second track. More specifically, the rotor chip may have one or more linking channels each with an opening on a first track (at a first radius R₁) connected to an opening on a second track (at a second radius R₂, where R₁ is different to R₂). The openings on the first track (at the first radius R₁) may mate with the primary reagent channel outlet and the openings on the second track (at the second radius R₂) may mate with the secondary reagent channel inlet.

As another example, the rotor chip may have a first set of linking channels with inlets on a first track (at a first radius R₁), and a second set of linking channels with inlets on a second track (at a second radius R₂, where R₁ is different to R₂). The openings on the first track (at the first radius R₁) may mate with a first set of primary reagent channel outlets and the openings on the second track (at the second radius R₂) may mate with a second set of primary reagent channel outlets. In this way, the rotor chip has multiple tracks of inlets, with certain tracks reserved only for certain primary reagent channel outlets.

The rotor chip may be rotatable by hand or, more preferably, by a (rotary) motor. Optionally, the motor is part of the cartridge itself. However, more preferably, the motor is part of the device to which the cartridge is mounted, for example part of the cartridge socket (as described above). In this way, the motor can be powered by the device, obviating the need for a motor and corresponding power source to be included in the cartridge itself, which would otherwise complicate construction of the cartridge. In particular, the cartridge is suitably a consumable component, in which case ease of manufacture and disposable (preferably by recycling as a single part—e.g. in a plastics waste stream) are highly advantageous.

In instances in which the rotor chip is rotated by a motor which is part of the device to which the cartridge is mounted, the rotor chip preferably has a first face having the openings to the linking channels (as discussed above, which can be referred to here as the “fluid face”) and a second face having a motor mounting adaptor (which can be referred to as the “mounting face”). Most preferably, the mating surface of the housing has a motor access port providing access to the mounting face of the rotor chip. The motor mounting adaptor may be a recess for receiving the shaft of the motor.

Preferably, the rotor chip and stator chip assembly include one or more indexing elements, to help achieve the correct indexing between rotor chip and stator chip assembly after the rotor chip moves between said first and second position, as described above in relation to the first preferred implementation. For example, the one or more indexing elements may be a spring plunger system (in particular a ball plunger system) provided at the interface between the rotor chip and stator chip. In a preferred implementation of a spring plunger system, a spring-loaded ball bearing is mounted on the fluid face of one component (for example the rotor chip), and the fluid face of the other component (for example, the stator chip assembly) includes one or more pockets into which the spring-loaded ball bearing is urged into as the rotor chip rotates, optionally with the provision of linking grooves between pockets to facilitate movement of the ball bearing between positions. The spring loading of the ball bearing may be achieved by providing each ball with an associated spring (either through use of a separate spring, or moulding a spring lever into the relevant chip), or by generally providing a spring to urge the rotor chip and the stator chip assembly together (the latter being preferred, since it also helps to improve the seal between the rotor chip and stator chip assembly). Alternatively, the indexing elements comprise one or more weak (e.g. permanent) magnets on the rotor chip and stator chip assembly which serve to index the rotor chip and stator chip at set positions, although this option is less preferred as the magnetic forces can create additional strain on the motor and could potentially interfere with reagent containing magnetic components (for example, magnetic beads). Advantageously, the use of one or more indexing elements allows correct positioning of the rotor chip and stator chip assembly without the need for high accuracy (expensive) motors.

Preferably, the indexing elements are positioned close to or at the edge of the rotor chip, since this improves the accuracy of the alignment.

In a preferred implementation the main microfluidic module of the measurement device of the present invention includes a motor as part of the cartridge socket. Similarly, in preferred implementations the secondary microfluidic module(s) include a cartridge socket (as described above) having a motor.

The stator chip assembly of the second preferred implementation comprises one or more plates having the primary reagent channels and secondary reagent channels formed therein. The stator chip assembly may comprise multiple plates held together, for example, by adhesive, such as glue or double-sided tape. Alternatively, the stator chip assembly may be a single plate having the primary reagent channels and secondary reagent channels provided therein. The single plate may be made by diffusion bonding multiple plates together

For example, the stator chip assembly of the second preferred implementation may comprise (or be made through diffusion bonding of) a first reagent plate having primary reagent channels therethrough, and a second reagent plate having secondary reagent channels therethrough. In such instances, at least one of the plates must accommodate bridging holes to allow throughflow from an adjacent plate to the reagent reservoirs and/or stator chip assembly, as appropriate. In the example of the stator chip assembly incorporating a first reagent plate having primary reagent channels therethrough, and a second reagent plate having secondary reagent channels, if the rotor chip engages the face of the first reagent plate then said plate must accommodate bridging holes for the second reagent channels to reach the rotor chip, and if the rotor chip engages the face of the second reagent plate then said plate must accommodate bridging holes for the first reagent channels to reach the rotor chip.

Advantageously, constructing the stator chip assembly from multiple plates (either through adhering plates together, or permanently attaching through diffusion bonding) can allow a limited set of “standard” plates to be manufactured for use in a range of different cartridges. For example, in a “basic” cartridge incorporating eight reagent reservoirs, the stator chip assembly may incorporate a first reagent plate having eight primary reagent lines for delivering reagent, along with a set of bridging holes that are not used during operation of the basic cartridge. For a more “advanced” cartridge incorporating sixteen reagent reservoirs, the stator chip assembly may incorporate an identical first reagent plate stacked on top of a second reagent plate. The first reagent plate is used to obtain reagent from eight of the reservoirs. The second reagent plate has eight primary reagent lines whose inlets mate with the bridging holes of the first reagent plate, and also has eight bridging holes which mate with the outlets of the first reagent plate. This simple stacking means that the cartridge can be adapted to allow for 16 reagents instead of 8 through the simple addition of a standard additional plate.

In a third preferred implementation of the reagent cartridge (also forming a separate aspect of the invention, independent of the features referred to in relation to the other aspects above), the reagent cartridge comprises a housing containing:
a plurality of reagent reservoirs;
a plurality of cartridge pressurisation ports (connected to the cartridge socket inlet ports when installed on a microfluidic module), for pressurising the reagent reservoirs in use;
a plurality of cartridge outlet ports (connected to the cartridge socket outlet ports when installed on a microfluidic module), for dispensing reagent from the cartridge in use; and
a valve assembly, for regulating pressurisation of the reagent reservoirs and flow of reagents from the reagent reservoirs to the cartridge outlet ports in use, the valve assembly comprising:
   a stator chip assembly, comprising
      a plurality of primary reagent channels fluidly connected to the reagent reservoirs; and
      a plurality of secondary reagent channels fluidly connected to the cartridge outlet ports;
      a plurality of primary pressure channels fluidly connected to the cartridge pressurisation ports;
      a plurality of secondary pressure channels fluidly connected to the reagent reservoirs; and
   a rotor chip, sealingly engaging the stator chip, the rotor chip having
      one or more reagent linking channel(s) for fluidly connecting the primary reagent channels and secondary reagent channels; and
      one or more pressure linking channel(s) for fluidly connecting the primary pressure channels to the secondary pressure channels;
   wherein the rotor chip is rotatable relative to the stator chip assembly between a first position and a second position, and wherein
      said rotation causes the reagent linking channel(s) to establish a different fluid connection between the primary reagent channel(s) and the secondary reagent channel(s) in the first position compared to the second position; and/or
      said rotation causes the pressure linking channel(s) to establish a different fluid connection between the primary pressure channel(s) and the secondary pressure channels in the first position compared to the second position.

In such a cartridge the same rotor chip serves as a valve not only for the reagents but also for the pressurisation system. In other words, the valve can control which reagent reservoirs are pressurised, and which reagent reservoirs are capable of delivering reagent. This allows dosing from an arbitrary number of reservoir ports, irrespective of the number of cartridge pressurisation ports and cartridge outlet ports.

Suitably, the openings of the pressure linking channels on the rotor chip are positioned on a different track to the openings of the reagent linking channels (in other words, the openings of the pressure linking channels are positioned at a different distance from the axis of rotation of the rotor chip compared to the openings of the reagent linking channels). For example, the openings for the pressure linking channels may be on a track further outwards (relative to the centre of the rotor chip) than the openings for the reagent linking channels, or the openings for the pressure linking channels may be on a track further inwards than the openings for the reagent linking channels. Advantageously, this minimises the chances of reagent entering the pressurisation system during rotation of the rotor chip, and equally prevents pressure from leaking into the primary reagent channels and secondary reagent channels.

Preferably, the reagent linking channels and pressure linking channels on the rotor chip are paired—in other words, each reagent linking channel has an associated pressure linking channel. In this way, when a reagent linking channel is aligned with a particular reagent inlet channel and reagent outlet channel the paired pressure linking channel is also in proper alignment to cause pressurisation of the appropriate reservoir.

In implementations incorporating both the pressure linking channels and reagent linking channels, the stator chip assembly may be a single plate having the reagent input channels, reagent output channels, and pressure input channels formed therein. This single plate may be made by diffusion bonding a stack of plates having the primary reagent channels, secondary reagent channels, and primary pressure channels and secondary pressure channels formed therein.

For example, the single plate may be made by diffusion bonding a stack of plates comprising: a reagent plate having primary reagent channels therethrough, a pressure plate having the primary pressure channels therethrough, and one or more interface plates having the secondary reagent channels and secondary pressure channels therethrough. In such instances, plates must accommodate bridging holes to interface with the channels of adjacent plates, to allow fluid to flow between the different plates as required (that is, to ensure proper connection to reagent reservoirs, rotor chip and cartridge pressurisation ports as required by the definition above).

Alternatively, the stator chip assembly may comprise said stack of plates attached through adhesive (for example double-sided adhesive tape) without the use of diffusion bonding.

The third implementation may have any of the preferred and optional features set out above in respect of the first and second implementations. In particular, any optional or preferable features discussed above in relation to the linking channel of the second implementation may apply to either or both of the reagent linking channel(s) and pressure linking channel(s) of the third implementation.

In a fourth preferred implementation of the reagent cartridge (also forming a separate aspect of the invention, independent of the features referred to in relation to the other aspects above), the reagent cartridge comprises a housing containing:
a plurality of reagent reservoirs;
a plurality of cartridge pressurisation ports (connected to the cartridge socket inlet ports when installed on a microfluidic module), for pressurising the reagent reservoirs in use;
a plurality of cartridge outlet ports (connected to the cartridge socket outlet ports when installed on a microfluidic module), for dispensing reagent from the cartridge in use; and
a valve assembly, for regulating flow of reagents from the reagent reservoirs to the cartridge outlet ports in use, the valve assembly comprising:
   a stator chip assembly, comprising
      a plurality of primary reagent channels fluidly connected to the reagent reservoirs; and
      a plurality of secondary reagent channels fluidly connected to the cartridge outlet ports;
   a rotor chip, sealingly engaging the stator chip, the rotor chip having a plurality of reagent linking channel(s) for fluidly connecting the primary reagent channels and secondary reagent channels;
   wherein the rotor chip is rotatable relative to the stator chip assembly, and wherein said rotation causes the reagent linking channel(s) to establish a different fluid connection between the primary reagent channel(s) and the secondary reagent channel(s); and wherein the plurality of reagent linking channels is arranged such that any primary reagent channel can be connected to any secondary reagent channel.

This system provides a distinct advantage over other solutions taught in the prior art. For example, the rotary valve in Fluigent's M-Switch™ can couple 10 reagents to only a single outlet port, thus to achieve analogous functionality to the present invention would require a complex connection of several such devices.

This implementation may have any of the preferred and optional features set out above in respect of the other implementations.

For example, the stator chip assembly may have X primary reagent channel outlets regularly spaced in an arc or circle configuration, and Y secondary reagent channel inlets regularly spaced in an arc or circle configuration, and the rotor chip may have X+Y linking channels capable of linking any of the X primary reagent channel outlets to any of the Y secondary reagent channel inlets.

As above, it is preferred for the linking channels to be within the same plane of the rotor chip, for reasons of space-saving.

In a fifth preferred implementation of the reagent cartridge (also forming a separate aspect of the invention, independent of the features referred to in relation to the other aspects above), the reagent cartridge comprises a housing containing:
a plurality of reagent reservoirs;
a plurality of cartridge pressurisation ports (connected to the cartridge socket inlet ports when installed on a microfluidic module), for pressurising the reagent reservoirs in use;
a plurality of cartridge outlet ports (connected to the cartridge socket outlet ports when installed on a microfluidic module), for dispensing reagent from the cartridge in use; and
a valve assembly, for regulating flow of reagents from the reagent reservoirs to the cartridge outlet ports in use, the valve assembly comprising:
   a stator chip assembly, comprising
      a plurality of primary reagent channels fluidly connected to the reagent reservoirs; and
      a plurality of secondary reagent channels fluidly connected to the cartridge outlet ports;
   a rotor chip, sealingly engaging the stator chip, the rotor chip having a branched reagent linking channel(s) for fluidly connecting the primary reagent channels and secondary reagent channels;
   wherein the rotor chip is rotatable relative to the stator chip assembly, and wherein said rotation causes the reagent linking channel(s) to establish a different fluid connection between the primary reagent channel(s) and the secondary reagent channel(s); and wherein the branched reagent linking channel(s) is able to simultaneously direct flow from a primary reagent channel to multiple secondary reagent channels and/or is able to simultaneously direct flow from multiple primary reagent channels to a secondary reagent channel.

Advantageously, the provision of a reagent cartridge having a branched reagent linking channel allows mixing of reagents in an arbitrary fashion, without the complications set out above in relation to the device shown in WO 2019/063375, having only a single shared output channel.

Reagent Reservoirs

The reagent reservoirs may be or incorporate a funnel (and inwardly tapering section) to encourage the flow of reagent towards the (primary) reagent channels. For example, the bottom of the reservoir (when mounted on a cartridge socket) is preferably sloped downwards towards the (primary) reagent channels. The angle of the funnel/slope to encourage full draining of a particular reservoir will depend on the hydrophobicity of the materials used in construction of the reservoir, but may be, for example, 80° or less relative to the direction of gravity, 70° or less, 60° or less, or 45° or less.

The reagent cartridge may incorporate a reagent tray having compartments provided therein to provide the plurality of reagent reservoirs. In such embodiments, the cartridge housing preferably includes one or more lids which seal compartments of the reagent tray (either sealing multiple (or all) compartments together, or sealing compartments individually). In this way, pressure applied to a given compartment pressurises only that specific compartment. Optionally, the lid is openable to allow reagents to be topped up, or replaced.

Optionally, the tray may have integrally formed pressure channels for pressurising the compartments. The pressure channels of the tray may open into the compartment itself. In such instances, the pressure channels preferably open at, or close to, the top of the reagent compartment, to limit the possibility of reagent entering the pressurisation system. Alternatively, the pressures channels of the tray mate with corresponding pressure channels in the above-mentioned lid, with the pressure channels in the lid opening at the top (the “roof”) of the reagent compartment, since this provides a particularly effective way of preventing reagent from entering the pressurisation system.

Optionally, the reagent tray can be inserted and removed from the reagent cartridge. The removable tray may, for example, slot into the reagent cartridge housing. Advantageously, providing the reagent reservoirs as part of a separate module can simplify preparing the reagent cartridge for use with a particular protocol. For example, the reagent cartridge may be loaded with a first reagent tray filled with all of the reagents necessary for a first protocol, which is subsequently replaced with a second reagent tray filled with all of the reagents necessary for a second (optionally different) protocol.

Preferably, the direction in which the reagent tray is inserted and removed from the reagent cartridge is different to the direction in which the reagent cartridge itself is inserted and removed into the cartridge socket of the microfluidic system. In this way, applying force to insert or remove the reagent tray does not remove the reagent cartridge from the reagent cartridge.

Optionally, the reagent channels of the first implementation and the primary reagent channels of the second to fifth implementations each originate from a needle port, and the compartments of the reagent tray are sealed by a film which is pierced by said needle ports as the reagent tray is inserted into the reagent cartridge so as to connect the compartments to the (primary) reagent channels. Similarly, it is preferred that the pressure channels of the first implementation and the secondary pressure channels of the third implementation each terminate in a needle port, wherein the reagent tray is sealed by a film which is pierced by said needle ports as the reagent tray is inserted into the reagent cartridge so as to connect the compartments to the (secondary) pressure channels. Such a reagent tray may be made by providing a plurality of compartments opening on the same face of the tray, and sealing said face with the film. Preferably, the film is a self-healing film, such that the hole formed by the needle ports seals after removal of the reagent tray from the reagent cartridge.

Cartridge Pressurisation Ports and Cartridge Outlet Ports

In all of the implementations above, the plurality of cartridge pressurisation ports and plurality of cartridge outlet ports may take any suitable form for plugging into a corresponding cartridge socket, for example, in the form of a needle or a hole. Most preferably, however, the ports take the forms of holes provided in the cartridge housing, since this allows the mating surface of the cartridge to be placed on a surface (e.g. to rest the cartridge in use). Holes are also better than needles from a handling perspective, since (unlike a needle) it is not possible for a user to stab or scratch themselves on the ports, the ports will not be accidentally bent or damaged, and the user is less likely to contact the ports thereby minimising the possibility of contamination. In addition, providing the ports as holes facilities packaging and shipping of the cartridge (an important consideration for consumable cartridges), since it makes the cartridge more compact and less fiddly to design packaging around.

In implementations where the cartridge pressurisation ports and cartridge outlet ports are holes, the cartridge preferably provides gaskets/septa to ensure sealing connection between the port and a cartridge socket. For ease of manufacture, the cartridge may contain an elongate gasket shared between multiple ports, for example a cartridge pressurisation port gasket and (separately) a cartridge outlet port gasket. Alternatively, the gasket can take the form of a septum that a needle from the cartridge socket penetrates in use.

In a particularly preferred embodiment, the cartridge outlet ports include a leak-resistant resealable gasket/septum. For example, the leak-resistant resealable septum may take the form of a septum incorporating a self-healing membrane.

Preferably, the leak-resistant resealable septum comprises a body having a throughhole sealed by a deformable closure. In such embodiments, inserting a needle into the throughhole deforms the closure to allow entry of the needle, and removing the needle allows the closure to return to seal the throughhole. The closure may be, for example, a hinged door which opens into the throughhole when a needle is pushed into the septum but returns to a closed state when the needle is removed. Preferably, however, the closure is formed from one or more deformable flaps, which can be pushed aside upon insertion of a needle but return to seal the throughhole when the needle is removed. The flaps may be formed, for example, by one or more slits provided in a membrane overlaying the throughhole.

To aid insertion and removal of the needle, the septum preferably takes the form of a body having a throughhole for receiving a needle, the throughhole having a wider entry portion for insertion of said needle and a narrower docking portion for gripping said needle, the entry portion being sealed by a deformable flap (preferably with the deformable flap taking the form of a slit membrane overlaying the entry portion), wherein in use a needle can be inserted into the throughhole by pushing aside the deformable flap, and wherein the deformable flap returns to seal the throughhole upon removal of said needle. Advantageously, making the throughhole wider at the entry portion allows the deformable flap to be relatively bigger than if the throughhole were of a single diameter suited to gripping the needle, making it more easy to deform with a needle. In addition, in such embodiments the needle may be gripped in place not only by the gripping portion, but also by the deformable flap. Preferably, the wider entry portion tapers/funnels into the narrower docking portion, to help guide the needle from the entry portion into the docking portion.

The deformable flap/slit membrane is formed from an elastomeric material. The elastomeric material may be, for example, silicone.

Preferably, the septum is integrally formed. For example, the septum may be integrally formed from an elastomeric material such as silicone.

The cartridge pressurisation ports may also take the form of leak-resistant gasket/septa, as above.

Such embodiments are particularly advantageous in embodiments in which the cartridge outlet ports and cartridge pressurisation ports are provided on a mating surface provided at the bottom of the cartridge. In particular, the cartridge can be removed from a cartridge socket without excessive leakage of fluid from the cartridge.

In view of the advantages set out above, the present invention also provides a reagent cartridge having a reagent outlet port sealed by a septum as defined above, in particular a septum taking the form of a body having a throughhole for receiving a needle, the throughhole having a wider entry portion for insertion of said needle and a narrower docking portion for gripping said needle, the entry portion being sealed by a deformable flap in the absence of a needle, preferably with the deformable flap taking the form of a slit membrane overlaying the entry portion.

In a separate aspect, the present invention also provides a cartridge socket as defined in the independent aspect above incorporating a reagent cartridge as taught herein.

External Reagent Sources

Optionally, the reagent delivery cartridge comprises at least one exterior input tube fluidly connected to a (primary) reagent channel of the stator chip assembly, suitable for drawing reagent from an external reagent source (in other words, outside of the reagent cartridge housing) to the valve assembly and thence on to a cartridge outlet port via the rotor chip. In such embodiments, one or more of the cartridge pressurisation ports may be fluidly connected to an exterior output tube (optionally via the rotor chip), to allow pressurisation of the external reagent source. In this way, the exterior output tube can be used to pressurise the external reagent source, to drive flow of the external reagent source into the exterior input tube. The exterior input tube and exterior output tube may be made of flexible tubing. The provision of such tubes is particularly advantageous in implementations requiring delivery of a large quantity of reagent, since a large tube or bottle of such reagent can be delivered under the control of the valve assembly.

The reagent delivery cartridge may comprise at least 2, at least 4, at least 6 or at least 8 such exterior input tubes for receiving reagents from an external source, preferably each with an associated exterior output tube to allow pressurisation of the external source. Alternatively, the reagent delivery cartridge may not include any exterior input tubes or exterior output tubes (in other words, the cartridge may only permit delivery of reagents from “internal” reagent reservoirs).

Optionally, the reagent delivery cartridge takes the form of a routing cartridge, which allows the cartridge to be connected to a secondary microfluidic module. In this way, the arrangement of master and secondary microfluidic modules need not be linear, since the routing cartridge can allow “branching” of the arrangement. The routing cartridge may comprise:
a plurality of cartridge pressurisation ports (connected to cartridge socket inlet ports when installed on a secondary microfluidic module) fluidly connected to exterior output tubes (e.g. through direct connection between the cartridge pressurisation port and exterior output tube);
a plurality of cartridge outlet ports (connected to cartridge socket outlet ports when installed on a secondary microfluidic module), for dispensing reagent from the cartridge in use; and
a plurality of exterior input tubes;
a valve assembly comprising:
   a stator chip assembly, having a plurality of reagent channels each providing a flowpath from the exterior input tubes to the cartridge outlet ports, each reagent channel having an associated valve section in which the reagent channel is capped with a flexible membrane, the valve section being actuatable between an open position in which the reagent channel is open and a closed position in which the flexible membrane is deformed so as to occlude the reagent channel; and
   a rotor chip, rotatable relative to the stator chip assembly between a first position and a second position, wherein the rotor chip includes an actuator surface which actuates the valve sections of the reagent channels, and wherein said rotation causes the actuator surface to actuate (open/close) a different subset of the reagent channels in the first position compared to the second position.

The rotor chip may operate as a direct chip contact implementation or indirect chip contact implementation, as described above.

In an alternative, the routing cartridge may comprise:
a plurality of cartridge pressurisation ports (connected to cartridge socket inlet ports when installed on a secondary microfluidic module) fluidly connected to exterior output tubes (either through direct connection between the cartridge pressurisation port and exterior output tube, or indirect connection, such as by connecting the exterior output tube to a secondary pressure channel of the rotor chip, in embodiments incorporating such a system, or having the exterior output tube extend from a reagent reservoir);
a plurality of cartridge outlet ports (connected to cartridge socket outlet ports when installed on a secondary microfluidic module), for dispensing reagent from the cartridge in use; and
a plurality of exterior input tubes;
a valve assembly comprising:
   a stator chip assembly, comprising
      a plurality of primary reagent channels each fluidly connected to an exterior input tube; and
      a plurality of secondary reagent channels each fluidly connected to the cartridge outlet ports; and
   a rotor chip, sealingly engaging the stator chip assembly, the rotor chip having one or more linking channel(s) for fluidly connecting the primary reagent channels and secondary reagent channels; wherein the rotor chip is rotatable relative to the stator chip assembly between a first position and a second position, and wherein said rotation causes the linking channel(s) to establish a different fluid connection between the primary reagent channel(s) and the secondary reagent channel(s) in the first position compared to the second position;
wherein
the plurality of exterior output tubes terminate in a shared exterior cartridge output connector; and
the plurality of exterior input tubes terminate in a shared exterior cartridge input connector.

In this way, the arrangement of master and secondary microfluidic modules need not be linear, since the routing cartridge can allow “branching” of the arrangement.

The exterior cartridge output connector and exterior cartridge input connector take the form described above in relation to the connectors of the master and second microfluidic modules.

Suitably, the routing cartridge can be connected to a secondary microfluidic module by connecting the exterior cartridge output connector of the routing cartridge to the external pressure input connector of the secondary microfluidic module and connecting the exterior cartridge input connector to the reagent output connector of the secondary microfluidic module.

An aspect of the present invention also extends to a measurement device as described above, incorporating a master microfluidic module and/or secondary microfluidic module having a routing cartridge which is connected to a (further) secondary microfluidic module.

The routing cartridge may have any of the optional and preferred features set out above in relation to other reagent delivery cartridges, so far as compatible.

Materials

The rotor chip and stator chip assembly can be made of any suitable solid material that is capable of supporting one or more channels therein. For example, they may be made from a resin such as polycarbonate; polyvinyl chloride; DELRI NO (polyoxymethylene); HALAR®; PCTFE (polychlorotrifluoroethylene); PEEK™ (polyetheretherketone); PK (polyketone); PERLAST®; polyethylene; PPS (polyphenylene sulphide); polysulfone; RADEL® R (polyphenylsulfone); polypropylene; fluoropolymer including PTFE (polytetrafluoroethylene), FEP (fluorinated ethylene propylene) and Viton™ PFA (perfluoroalkoxy alkane); TEFZEL® ETFE (Ethylene Tetrafluoroethylene); TPX® (Polymethylpentene); Titanium; UHMWPE (Ultra High Molecular Weight Polyethylene); UL TEM® (polyetherimide); VESPEL®; or 316 Stainless Steel. Preferred materials include, for example, PTFE and UHMWPE, since these materials ensure low friction between the rotor chip and stator chip.

In instances where the rotor chip contacts the stator chip assembly, such as the “direct chip contact” version of the first implementation, and all of the second to fifth implementations, the rotor chip may include a surface coating to reduce friction.

Analysis Chip Mount

The master microfluidic module incorporates an analysis chip mount for receiving an analysis chip.

Optionally, the analysis chip mount is a support on which an analysis chip can be rested, to allow ports on an analysis chip to be plugged into the chip input lines. There are some advantages to this system, since different analysis chips may have very different inlet port configurations to suit different protocols, such that it is helpful to allow separate manipulation of the chip input lines.

Preferably, the chip input lines may terminate in a shared chip input connector, suitable for connection to a corresponding analysis chip connector provided on an analysis chip. In such instances, the connection between the shared chip input connector and analysis chip connector may be achieved through a linker (e.g. patch cable and optionally terminal block), preferably with the use of a quick release mechanism (e.g. clamp or clip), as described above.

Alternatively, the analysis chip mount may be or incorporate an analysis chip socket, into which an analysis chip can be plugged, in an analogous way to that described above in relation to direct connection of a cartridge to the cartridge socket.

In such instances, the analysis chip socket may include an array of analysis chip socket inlet ports, for flowing reagent into the analysis chip. The analysis chip socket inlet ports may take the form of protrusions, such as flexible needles, for insertion into corresponding inlets on an analysis chip. Alternatively, the analysis chip socket inlet ports and (if present) analysis chip socket outlet ports may take the form of recesses, optionally incorporating a gasket/seal, for insertion of corresponding protrusions from an analysis chip.

Analysis Chip

The analysis chip may be any sampling chip, as will occur to the skilled reader. Indeed, the advantage of the measurement device of the present invention is that the microfluidic system can be adapted to an analysis chip and protocol of choice, without restriction.

By way of non-limiting example, the analysis chip may have an array of microfluidic channels extending from the analysis chip socket inlet port to an outlet. Alternatively, the analysis chip may incorporate a chamber which is in fluid communication with several analysis chip socket inlet ports.

Chip Output Manifold

In certain instances, the analysis chip will include its own outlet ports, for removing reagent from the analysis chip. For example, it may have a plurality of waste lines which flow into a single waste container.

Alternatively, the master microfluidic module may incorporate a chip output manifold, comprising a plurality of chip output lines, terminating in a shared reagent output connector.

Preferably, the master microfluidic module incorporates a plurality of said chip input lines terminating in a shared chip input connector, and a plurality of chip output lines terminating in a shared reagent output connector. Optionally, the chip input connector and reagent output connector are provided as part of the same coupling adaptor, for example a recess having one set of orifices corresponding to the chip input connector and another set of orifices corresponding to the reagent output connector. This can facilitate easy connection of an analysis chip via a linker, such as a patch cable.

Electronics

Preferably, the measurement device has detection electronics for detecting the attachment of a peripheral component, such as a cartridge, analysis chip, fluidic chip and/or any secondary microfluidic modules.

More preferably, the measurement device has identification electronics, for identifying the specific type of peripheral component. For example, the identification electronics may identify the model of the cartridge, and thus the number of reagent reservoirs, and the configuration of the channels in the stator chip assembly and rotor. The results of this identification may be fed to a control system, which automatically updates a control panel to take into account the number and type of peripheral components attached.

Preferably, the detection and/or identification electronics correspond to an RFID system. Advantageously, an RFID system allows components to be detected and identified without the need to make electrical contact between those components.

Preferably, the measurement device has a main power input, and any peripheral components are connected so as to be powered by this main power input.

Preferably, the cartridge socket has electrical contacts, for connecting to corresponding electrical contacts on a cartridge inserted into the cartridge socket. Similarly, it is preferred for the analysis chip socket, and the fluidic chip socket of any secondary modules, to have electrical contacts, for connecting to corresponding electrical contacts on a cartridge inserted into the cartridge socket. The electrical contacts on said sockets are preferably sprung loaded, so that the electrical circuit is formed as the corresponding cartridge or chip is inserted. The contacts may correspond to electrical ground, digital supply voltage (e.g. +3.3V), an I2C SCLK line, an 120 SDA line, a combined digital input/output/analog input line, and a high voltage supply (e.g. +20V).

The cartridge and analysis chip can feature an electronic PCB, which interfaces with said electrical contacts.

The cartridge and/or analysis chip may include an electronic temperature control system (integrated heating/cooling elements) to incubate the sample and reagents at a desired temperature.

Flow Sensors

Preferably, the master microfluidic module and any secondary microfluidic modules include one or more flow sensors. Preferably, flow sensors are provided in-line on at least one (preferably all) of the chip input lines of the master microfluidic module and reagent output lines of the secondary microfluidic module. Preferably, the flow sensors are used to regulate the pressure supplied to the cartridge pressurisation ports (for example, by modulating the pressure of the external pressure source(s)) to achieve a desired flow rate.

Pipetting Device

Optionally, the one or more chip input lines are connected to a pipette head, for delivering or removing reagents from an analysis chip (such as a microscope slide) held on the analysis chip mount. This may be achieved by terminating the chip input lines in a dosing head (either one per line, or a shared dosing head across some or all of the lines), or attaching a pipette head to the analysis chip socket or the shared chip input connector described above, where present. Advantageously, such a system may be used to precisely drop/remove reagents from a microscope slide by applying positive/negative pressure.

In such embodiments, the one or more chip input lines preferably include an in-line flow sensor, which is used to regulate delivery/removal of reagents through the pipette head.

Type of Measurement Device and Measurement Apparatus

Preferably, the measurement device is an optical measurement device, in which case the measurement apparatus incorporates optical measurement apparatus. For example, the measurement apparatus may comprise a light detector (such as photodiode or camera) for analysing an analysis chip and (preferably) a light source for illuminating the analysis chip.

Preferably, the measurement device is an optical microscope and the measurement apparatus incorporates a light source and a light detector. More preferably, the measurement device is a fluorescence microscope.

In a most preferred embodiment, the measurement device is a compact microscope, as described in WO 2016/170370.

Kits

The present invention also provides a kit, comprising a master microfluidic module and at least one secondary microfluidic module as described above.

### Especially Preferred Embodiments

In an especially preferred embodiment, the present invention provides an optical microscope, comprising:
(A) a main enclosure, housing:
(i) an analysis chip mount, for receiving an analysis chip;
(ii) optical microscopy apparatus, for analysing an analysis chip held on the analysis chip mount, including a light source and a light detector;
(iii) a master microfluidic module, for supplying reagents to an analysis chip held on the analysis chip mount, comprising:
   a cartridge socket, having a plurality of cartridge socket inlet ports and cartridge socket outlet ports, for receiving a reagent cartridge;
   optionally, with a reagent cartridge plugged into the cartridge socket, wherein the reagent cartridge is preferably according to the first implementation, second implementation, third implementation or fourth implementation taught above;
   a pressure manifold, comprising a plurality of pressure feed lines connectable to an external pressure source, each pressure feed line having an associated multi-way valve assembly for selectively connecting the pressure feed line to either an external pressure output line or a cartridge socket pressure line (connected to a cartridge socket inlet port); and
   a chip input manifold, comprising a plurality of chip input lines, each having an associated multi-way valve assembly for selectively connecting the chip input line to either a cartridge socket reagent line (connected to a cartridge socket outlet port) or an external reagent input line;
   optionally, a chip output manifold, comprising a plurality of chip output lines terminating in a shared reagent output connector;
wherein the plurality of external pressure output lines terminate in a shared pressure output connector and the plurality of external reagent input lines originate from a shared external reagent input connector;
and preferably comprising, separate from the main enclosure:
(B) a secondary microfluidic module comprising:
   a cartridge socket, having a plurality of cartridge socket inlet ports and cartridge socket outlet ports, for receiving a reagent cartridge;
   optionally, with a reagent cartridge plugged into the cartridge socket, wherein the reagent cartridge is preferably according to the first implementation, second implementation, third implementation, fourth implementation or fifth implementation taught above, or is a routing cartridge connected to another secondary microfluidic module in the manner taught above;
   a pressure manifold, comprising a plurality of pressure feed lines each having an associated multi-way valve assembly for selectively connecting the pressure feed line to either an external pressure output line or a cartridge socket pressure line (connected to a cartridge socket inlet port); and
   a reagent manifold, comprising a plurality of reagent output lines having an associated multi-way valve assembly for selectively connecting upstream to either a cartridge socket reagent line (connected to a cartridge socket outlet port) or an external reagent input line;
   wherein
   the plurality of pressure feed lines originate from a shared external pressure input connector;
   the plurality of external pressure output lines terminate in a shared external pressure output connector;
   the plurality of external reagent input lines originate from a shared external reagent input connector;
   the plurality of reagent output lines terminate in a shared reagent output connector;
   the external pressure input connector is connected to the external pressure output connector of the master microfluidic module, and
   the external reagent output connector is connected to the external reagent input connector of the master microfluidic module; and optionally
(C) one or more further secondary microfluidic modules having the features set out in (B), wherein the external pressure input connector of the further secondary module is connected to the external pressure output connector of a preceding secondary microfluidic module; and the external reagent output connector of the further secondary module is connected to the external reagent input connector of the same preceding secondary microfluidic module.

Preferably, the enclosure is lightproof (as defined above) and all of the components of (A) are housed within the enclosure, with one or more hatches provided for accessing the various connectors (the pressure output connector, external reagent input connector and (if present) pressure input connector and external reagent output connector) the cartridge socket and the analysis chip socket.

Suitably, in instances in which enclosure (A) includes a chip output manifold, the combination of the chip input manifold and chip output manifold of the master microfluidic module is identical to the reagent manifold of the secondary microfluidic module(s).

In an especially preferred embodiment, the present invention provides a reagent cartridge, comprising:
a plurality of reagent reservoirs (optionally provided as part of a detachable reagent tray/module as described above);
a plurality of cartridge pressurisation ports (connected to the cartridge socket inlet ports when installed on a microfluidic module) in fluid communication with the reagent reservoirs, for pressurising the reagent reservoirs in use;
a plurality of cartridge outlet ports (connected to the cartridge socket outlet ports when installed on a microfluidic module), for dispensing reagent from the cartridge in use; and
a valve assembly, for regulating flow of reagents from the reagent reservoirs to the cartridge outlet ports in use, the valve assembly comprising:
   a stator chip assembly, having a plurality of reagent channels each providing a flowpath from the reagent reservoirs to the cartridge outlet ports, the plurality of reagent channels intersecting a circular groove, each reagent channel having an associated valve section provided at the circular groove in which the reagent channel is capped with a flexible membrane, the valve section being switchable between an open position in which the reagent channel is open and a closed position in which the flexible membrane is deformed so as to occlude the reagent channel;
   a rotor chip, rotatable relative to the stator chip assembly between a first position and a second position, the rotor chip having a protrusion (e.g. in the form of bump or ridge, such as a notched ridge, as described above) which contacts and deforms the flexible membrane so as to close at least one of the valve sections, the protrusion being sited within the circular groove of the stator chip assembly wherein said rotation causes the protrusion to close a different subset of the reagent channels in the first position compared to the second position.

In another especially preferred embodiment, the present invention provides a reagent cartridge comprising:
a plurality of reagent reservoirs (optionally provided as part of a detachable reagent tray/module as described above);
a plurality of cartridge pressurisation ports (connected to the cartridge socket inlet ports when installed on a microfluidic module) in fluid communication with the reagent reservoirs, for pressurising the reagent reservoirs in use;
a plurality of cartridge outlet ports (connected to the cartridge socket outlet ports when installed on a microfluidic module), for dispensing reagent from the cartridge in use; and
a valve assembly, for regulating flow of reagents from the reagent reservoirs to the cartridge outlet ports in use, the valve assembly comprising:
   a stator chip assembly, having a plurality of reagent channels each providing a flowpath from the reagent reservoirs to the cartridge outlet ports, each reagent channel having an associated valve section in which the reagent channel is capped with a flexible membrane;
   a valve actuator, comprising a plurality of pins which are movable to actuate the valve sections between an open position in which the reagent channel is open and a closed position in which the flexible membrane is deformed so as to occlude the reagent channel; and
   a rotor chip, rotatable relative to the valve actuator between a first position and a second position, wherein the rotor chip includes an actuator surface (e.g. a protrusion) which pushes the pins to actuate the valve sections, and wherein said rotation causes the actuator surface to actuate (open/close) a different subset of the valve sections in the first position compared to the second position.

In such embodiments, the valve actuator preferably comprises a plurality of cantilever-mounted pins attached to a support body. Each cantilever-mounted pin is preferably bendable from a resting state in which the pin deforms the flexible membrane to close its associated valve section to an engaged state in which the pin is bent away from the flexible membrane so as to open the valve section.

Additionally, or alternatively, the rotor chip is preferably a disc, with the actuator surface corresponding to a protrusion on the disc.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1 shows a side perspective view of a measurement device of the present invention, taking the form of a microscope;

FIG. 2 shows a front perspective view of the measurement device of FIG. 1;

FIG. 3 shows a schematic view of the microfluidic module incorporated within the microscope of FIG. 1, connected to an analysis chip socket;

FIG. 4 is a close-up view of the pressure manifold in FIG. 3;

FIG. 5 is a close-up view of the chip input manifold of FIG. 3;

FIG. 6 is a close-up view of the analysis chip socket of FIG. 3, and its associated waste lines;

FIG. 7 shows a schematic view of an alternative valve assembly that can be used to replace the 3-way valves shown in FIGS. 3 to 5;

FIG. 8 shows a schematic view of the components of a secondary microfluidic module according to the present invention;

FIG. 9 shows a schematic view of a secondary microfluidic module connected to the microscope of FIGS. 1 to 6;

FIG. 10 shows a schematic view of two secondary microfluidic modules daisy-chained to the microscope of FIGS. 1 to 6;

FIG. 11 shows a schematic front view of a cartridge socket suitable for use in the present invention;

FIG. 12 is a close up schematic view of one of the cartridge socket inlet ports depicted in FIG. 11;

FIG. 13 is an exploded schematic view of a reagent cartridge according to the present invention;

FIG. 14 is an exploded schematic view showing the reagent cartridge of FIG. 13 plugging into the cartridge socket of FIG. 11;

FIG. 15 is a top cross-sectional view of the rotor chip from the reagent cartridge of FIG. 13;

FIG. 16A shows the channel structure within a stator chip assembly and the rotor chip of FIG. 15 leading to the reagent wells of the reagent cartridge;

FIG. 16B shows the flowpath established through the stator chip assembly and rotor chip to a first reagent well of the cartridge;

FIG. 16C shows the resulting flowpath of reagent from the reagent well when pressure is applied as shown in FIG. 16B;

FIG. 17 is a top view of an alternative rotor chip incorporating a branched linking channel, showing two different rotational orientations;

FIG. 18 is a top view of two different rotational orientations of an alternative rotor chip, showing a linking channel incorporating a slotted outlet towards the centre of the chip.

FIG. 19 is a front view of a patch cable for interconnecting microscope 1 and secondary microfluidic modules;

FIG. 20 is a perspective view of the patch cable of FIG. 19;

FIG. 21 is a perspective view of a terminal block providing sockets for interconnecting microscope 1 and secondary microfluidic modules;

FIG. 22 is a rear perspective view of the microscope of FIG. 1, showing the position of terminal blocks relative to the reagent cartridge;

FIG. 23 is a cross-sectional view through the side of the terminal block shown in FIG. 21;

FIG. 24 is a perspective view of a releasable clamp interfacing with the end of a patch cable, illustrating how the clamp can be used to secure the patch cable to a terminal block;

FIG. 25 is an exploded perspective view, showing the components of FIG. 24;

FIG. 26 is a perspective view of a reagent cartridge of the invention according to the “direct chip contact” embodiment discussed above, having a removable reagent module which attaches to a base module;

FIG. 27 is a perspective view of the removable reagent module of FIG. 26;

FIG. 28 is a cross-sectional view of the removable reagent module of FIG. 26; FIG. 29 is a perspective view showing the inside of the base module of FIG. 26;

FIGS. 30 to 33 show individual layers forming the stator chip assembly of the reagent cartridge in FIG. 29;

FIG. 34 is a perspective view of a rotor chip suitable for use in the reagent cartridge of FIG. 29;

FIGS. 35 and 36 are cross-sectional schematics illustrating operation of the reagent cartridge of FIG. 29;

FIGS. 37 and 38 are cross-sectional schematics showing the actuation mechanism of an alternative reagent cartridge of the invention according to the “indirect chip contact” embodiment discussed above, incorporating a ring of cantilever-mounted pins;

FIG. 39 is a perspective view of the rotor chip and cantilever-mounted pin actuator of FIGS. 37 and 38, shown housed within a pressure plate;

FIG. 40 is a perspective view of the cantilever-mounted pin actuator from FIG. 39; and

FIG. 41 is a top view of the ring of cantilever-mounted pin actuator from FIG. 39.

FIG. 42 is a perspective view of another embodiment of a reagent cartridge according to the invention.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

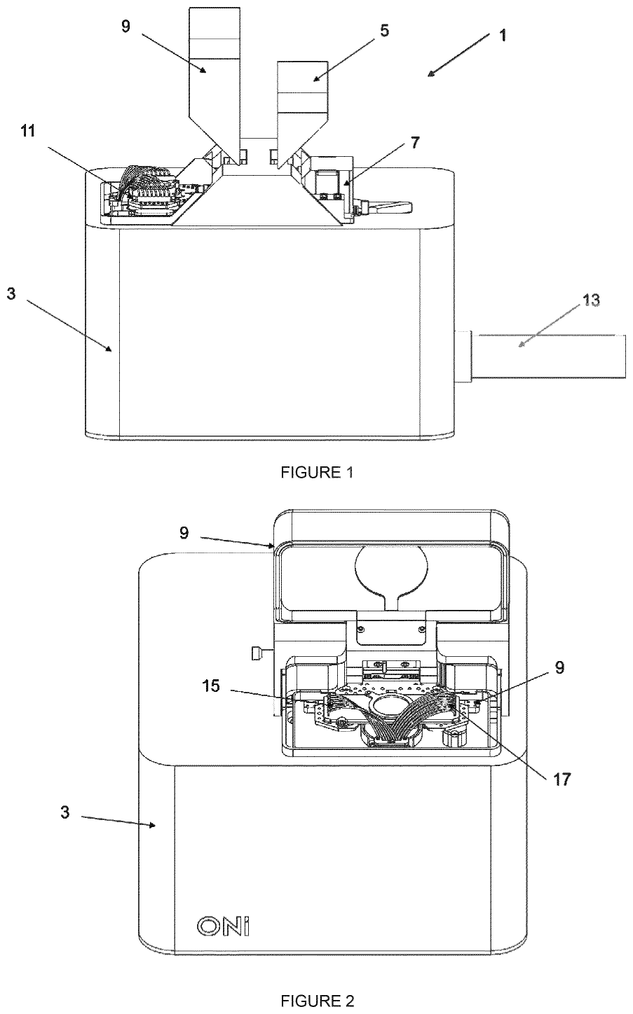

FIGS. 1 and 2 show a microscope 1 according to the present invention. The microscope incorporates an opaque black enclosure 3 housing the device's components, with a hatch 5 for accessing a reagent cartridge 7 and a hatch 9 for accessing an analysis chip 11. Protruding from the housing are two pressure inlet ports 13, for connecting microfluidic components of the microscope to an external pressure source. The front view in FIG. 2 shows analysis chip inlet tubing 15 and analysis chip outlet tubing 17 protruding from the main body of the enclosure.

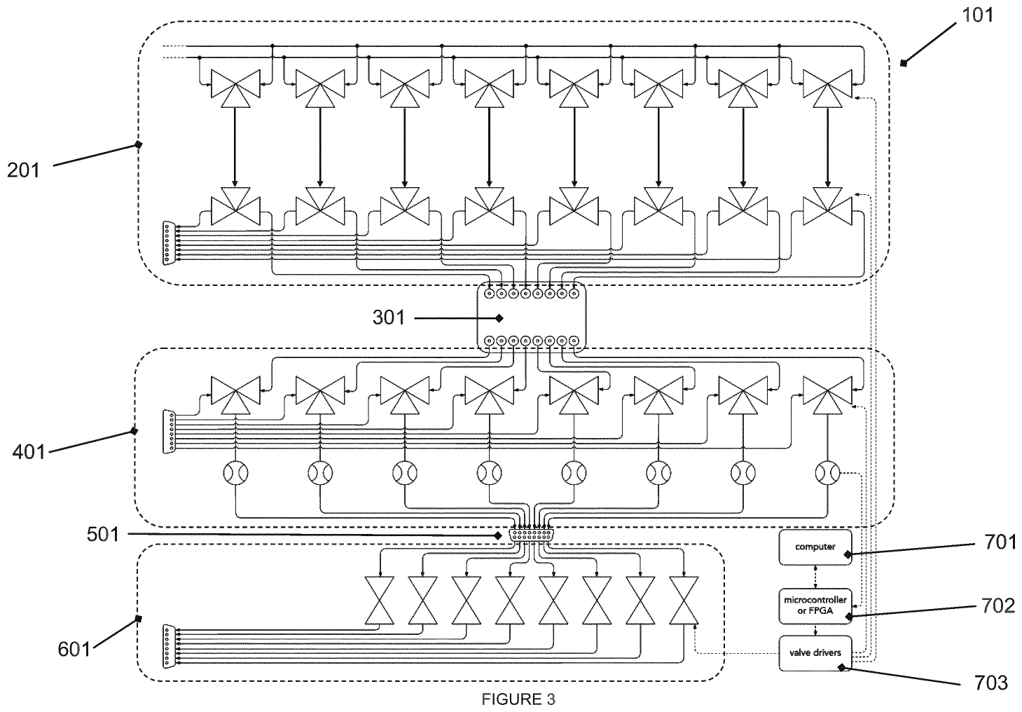

FIG. 3 shows the microfluidic system 101 incorporated within the microscope 1. The system includes a cartridge socket 301 with a set of inlets connected to a pressure manifold 201 and a set of outlets connected to a chip input manifold 401. The chip input manifold connects to analysis chip socket 501, with reagent from the analysis chip socket 501 being removed through chip output manifold 601. The microscope incorporates a computer 701 for controlling operation of the other components via a microcontroller or field programmable gate array 702, and valve drivers 703.

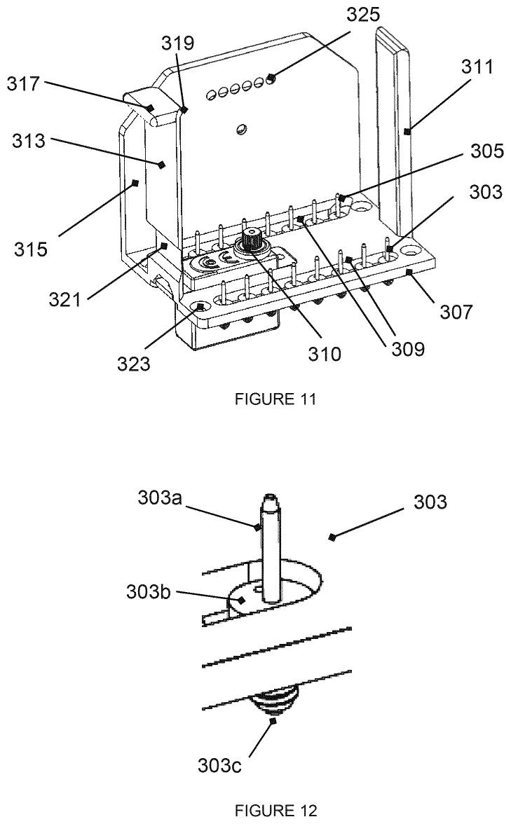

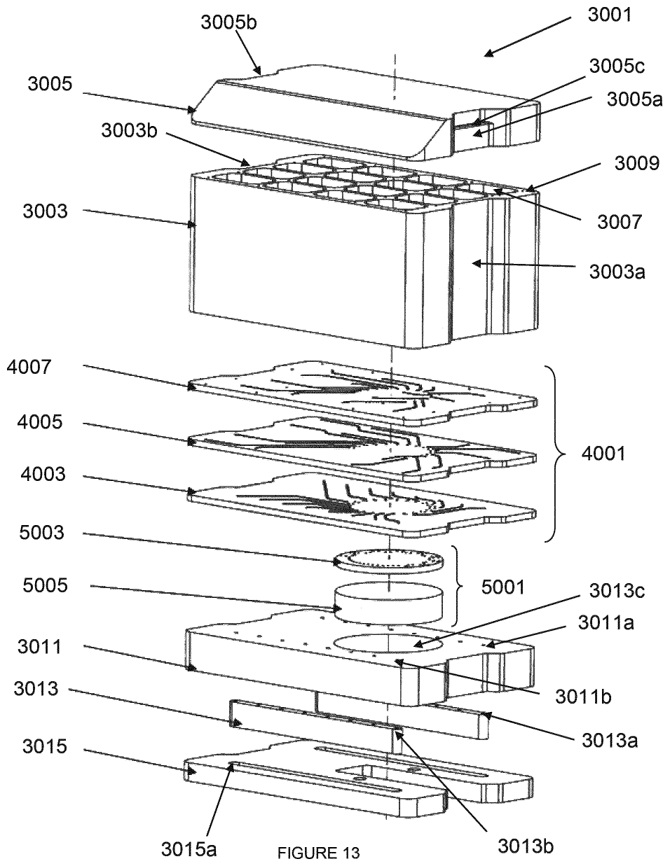

FIG. 4 shows details of the pressure manifold of FIG. 3 in greater detail. The manifold incorporates two pressure input lines 203 and 205, which are connectable to external pressure sources through the pressure inlet ports 13 shown in FIG. 1. In this case, pressure input line 203 is connected to a higher pressure source, and pressure input line 205 is connected to a lower pressure source. The pressure manifold includes eight pressurisation units 204, each supplying pressure to a corresponding port of the cartridge socket 301. For each pressurisation unit 204, the pressure input lines 203 and 205 are connected to inlets of manifold valve 209, which is a 3-way solenoid valve outputting into pressure feed line 207. The output of the pressure line 205 is attached to the inlet of a further 3-way solenoid valve 211 (the above-mentioned cartridge pressurisation valve), whose outlets can be switched between an external pressure line 215 and a cartridge pressurisation line 213. The cartridge pressurisation line 213 is connected to a cartridge socket pressurisation port 303 of cartridge socket 301. In use, a cartridge is connected to cartridge socket 301 through cartridge socket pressurisation ports 303 and cartridge socket fluid ports 305, as shown in greater detail in FIGS. 11 and 13. The 3-way solenoid valve 211 is set to connect to external pressure output line 215 in its normally open position, so that pressure will be directed away from the cartridge socket, to avoid unintentional delivery of reagents from a cartridge held in cartridge socket 301 in the absence of a command to switch the valve.

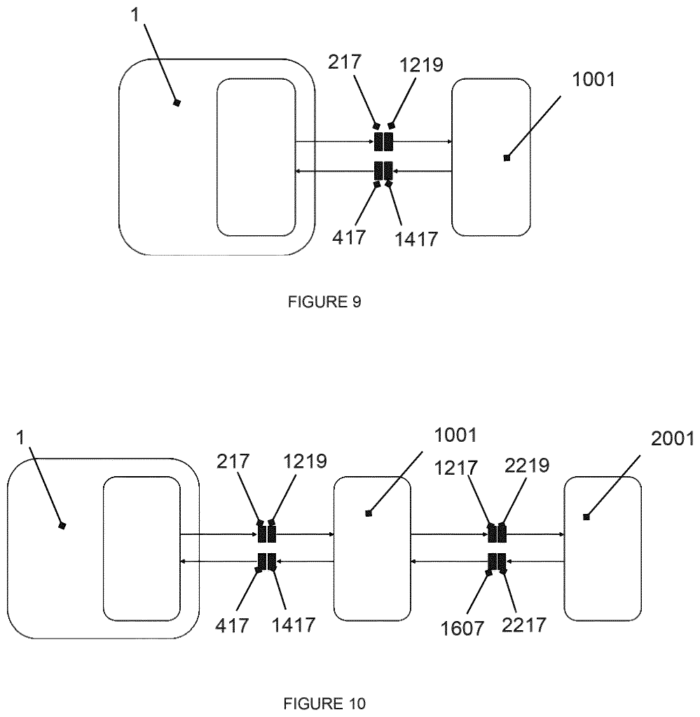

The external pressure output lines 215 from each pressurisation unit 204 extend to a shared terminal, called the pressure output connector 217. This connector can be connected to other modules to provide pressure, as shown in more detail in FIGS. 9 and 10.

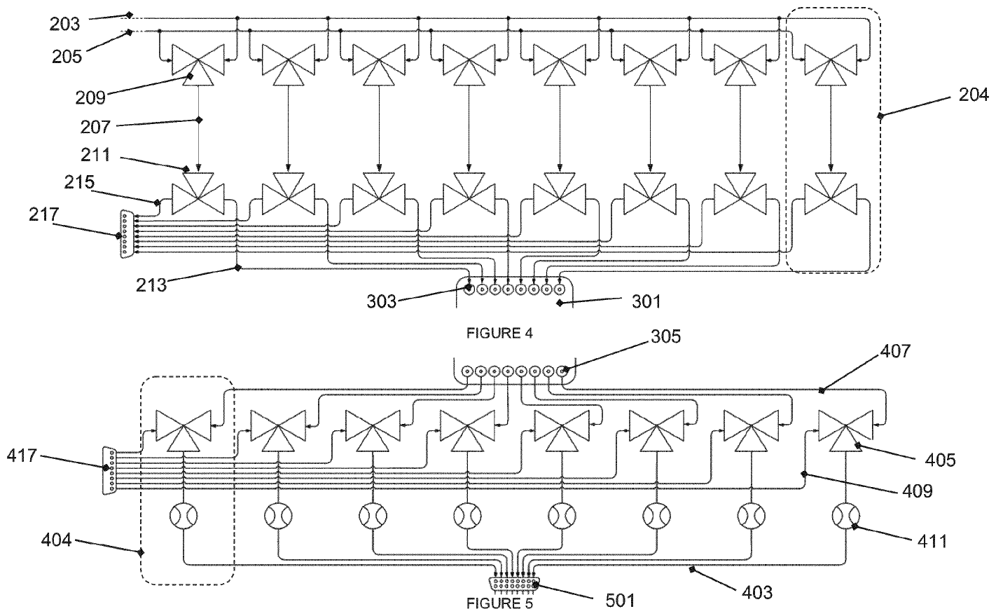

The eight cartridge socket fluid ports 305 are connected to eight corresponding ports on analysis chip socket 501 through chip input manifold 401, shown in greater detail in FIG. 5. Each cartridge socket fluid port 305 has an associated reagent unit 404. Each reagent unit 404 includes a chip socket input line 403 connected to the outlet of chip valve 405, which in the depicted embodiment is a 3-way solenoid valve whose inlets are switchable between either a cartridge fluid line 407 connected to cartridge socket fluid port 305, or an external reagent line 409. In an alternative (preferred) implementation, shown in FIG. 7, the 3-way chip valve 405 is replaced by two 2-way chip valves 405a and 405b, which can be used to establish the same overall flow pattern.

Flow sensor 411 is installed inline on the chip socket input line 403 between chip valve 405 and the analysis chip socket 501, to provide feedback to ensure desired flow characteristics. More specifically, the flow sensor 411 provides feedback data to the computer 701 via a proportional-integral-derivative (PID) controller included as part of microcontroller 702. The computer then uses this feedback to fluctuate the supply of pressure from the external pressure sources based on the current flow rate measurement, to adjust the current flow rate to a preset flow rate for the relevant chip socket fluidic inlet port.

The external reagent input lines 409 from each reagent unit 404 extend to a shared terminal, called the reagent input connector 417. This connector can be connected to other reagent sources, such as a secondary microfluidic module, as shown in more detail in FIGS. 9 and 10.

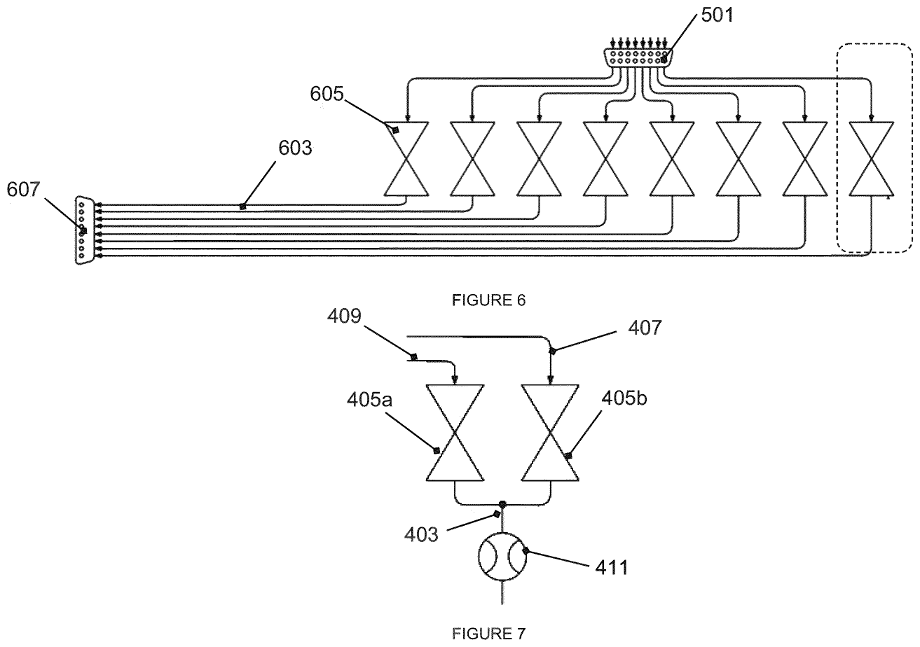

FIG. 6 shows chip output manifold 601 connected to the outputs of analysis chip socket 501. The chip output manifold 601 has eight reagent removal units, each consisting of a reagent removal line 603 and an associated waste valve 605, and all terminating in a shared reagent output connector 607. In alternative embodiments, the waste valves 605 are dispensed with.

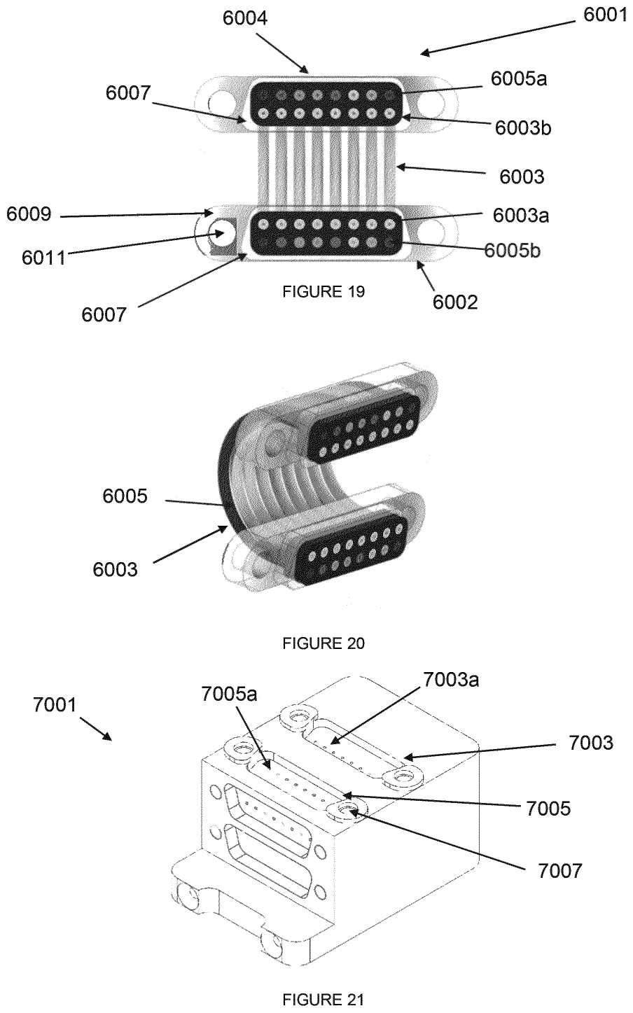

The chip socket 501 may be connected to an analysis chip via the use of a patch cable 6001, depicted in FIGS. 19 and 20.

Optionally, the microscope 1 can be plugged into one or more secondary microfluidic modules. This is depicted in FIGS. 9 and 10, where the microscope 1 is attached to secondary module 1001 through interconnection of relevant connectors. In the embodiment of FIG. 9, the pressure output connector 217 is plugged into a corresponding pressure input connector 1219 on secondary microfluidic module, and a reagent output connector 1417 on secondary module 1001 is plugged into reagent input connector 417 on microscope 1. In this way, pressure supplied by pressure manifold 201 can be supplied to the secondary microfluidic module to drive flow of reagent from the secondary module 1001 to the microscope 1 via the bridge established by the reagent output connector 1417 and reagent input connector 417. In FIG. 10, the system of FIG. 9 has been expanded through the addition of a further secondary module 2001, which is daisy-chained to the secondary module 1001 by attaching the pressure output connector 1217 of secondary module 1001 to pressure input connector 2219 of secondary module 2001, and connecting reagent output connector 2217 of secondary module 2001 to reagent input connector 1607 of secondary module 1001.

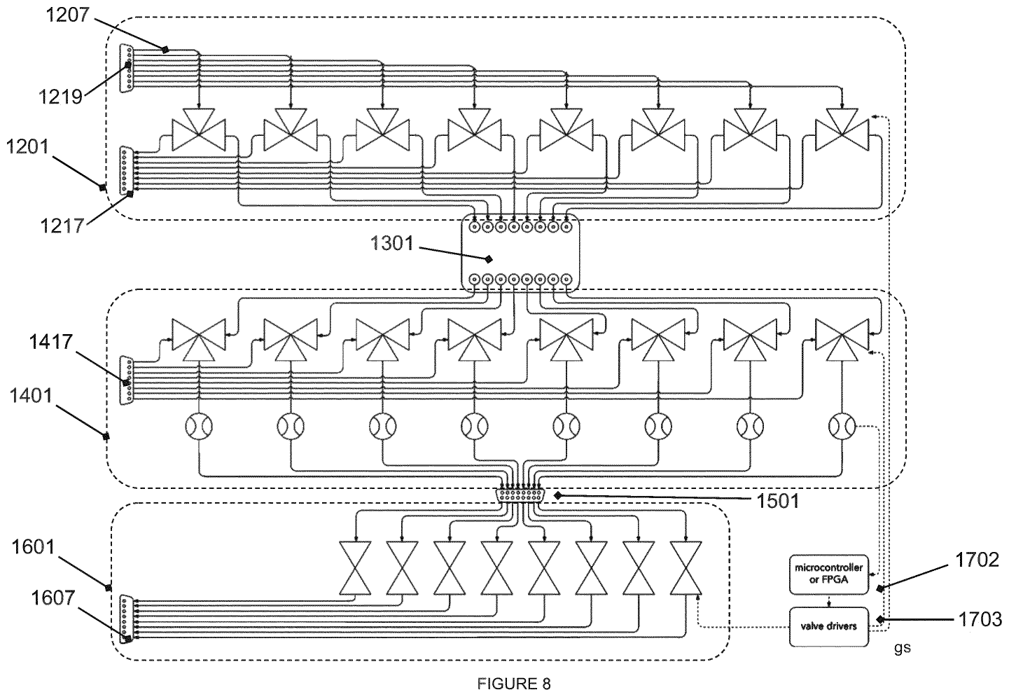

The components of the secondary module 1001 are shown in more detail in FIG. 8. The parts are essentially the same as the microfluidic components of the microscope 1 shown in FIGS. 3-6, with a cartridge socket 1301 having a set of inlets connected to a pressure manifold 1201 and a set of outlets connected to a chip input manifold 1401, which feed reagents to fluidic chip socket 1501, which itself exhausts to chip output manifold 1601. The only significant difference from the microfluidic components of microscope 1 is that in the pressure manifold 1201 of the secondary module 1001 the pressure feed line 1207 originates from a shared pressure input connector 1219. In this case, the fluidic chip socket 1501 accepts a bridging chip, which simply connects the chip inlets to the opposite chip outlets.

The connection between the microscope 1 and secondary microfluidic modules 1001 and 2001 is achieved via the use of patch cables. A representative patch cable is shown in FIGS. 19 and 20. Patch cable 6001 includes a first end 6002 and second end 6004 interconnected by a first set of tubing 6003 and a second set of tubing 6005. The first set of tubing 6003 extends between opening 6003a provided on end 6002 and opening 6003b provided on end 6004, and a second set of tubing 6005 extending between opening 6005a provided on end 6004 and opening 6005b provided on end 6002. Both ends of the patch cable include an end plate 6009 have a trapezoidal protrusion 6007, oriented such that on end 6002 the openings 6003a to tubing 6003 are provided along the shorter parallel side of the trapezoid and the openings 6005b to tubing 6005 are provided along the longer parallel side of the trapezoid, and on end 6004 the openings 6003b are provided along the longer parallel side of the trapezoid and openings 6005b are provided along the shorter parallel side. In this way, the cable has an orientation such that inlets are provided along the shorter parallel side, and outlets are provided along the longer parallel side.

The trapezoidal protrusion 6007 mates with corresponding trapezoidal recesses provided on the microfluidic module. For example, in a preferred implementation various connectors are provided on the enclosure in the form of a terminal block, as shown in FIG. 21.

The terminal block 7001 shown in FIG. 21 provides a reagent-in socket 7003 and pressure-out socket 7005. The reagent-in socket 7003 includes a set of orifices 7003a along the shorter side of the trapezoidal recess. The trapezoidal shape of the protrusion 6007 on the patch cable 6001 and recess on the reagent-in socket 7003 mean that the patch cable can only be inserted in one orientation, in which the orifices 7003a mate with the first set of tubing 6003 of patch cable 6001. This ensures that the patch cable must always be inserted in the correct orientation.

In a similar fashion, the pressure-out socket 7005 includes a trapezoidal recess, but in this case the orifices 7005a are provided along the longer side of the trapezoidal recess.

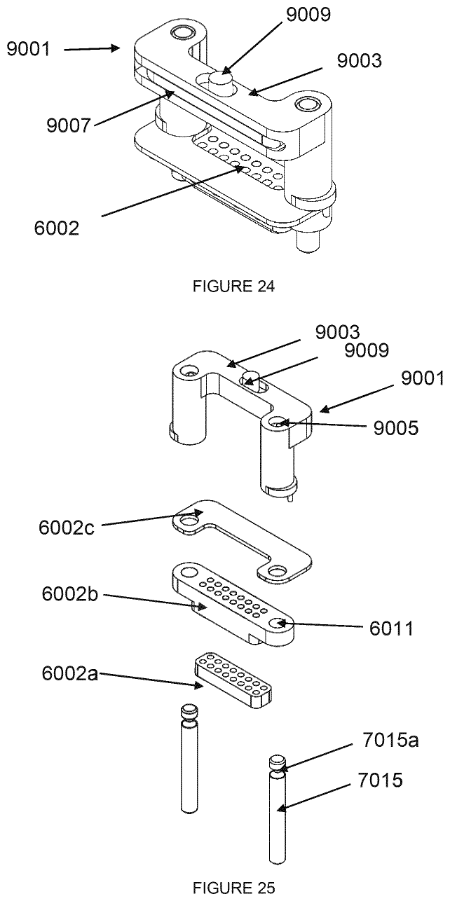

The patch cable 6001 can be secured in position on the terminal block 7001 by using a clamp as shown in FIGS. 24 and 25, to ensure a tight fluid connection between the patch cable and the sockets.

Clamp 9001 includes a frame 9003 having locking holes 9005, the frame incorporating a locking plate 9007 slidable via knob 9009. The locking holes 9005 have a slot in their sidewall for receiving the locking plate 9007 (within the clamp, and hence not shown), so that the locking plate is slidable between a “lock” position where a portion of the plate extends/juts into the locking holes 9005 and an “open” position where the locking plate is retracted from the locking holes.

The component parts of end 6002 of patch cable 6001 are shown in FIG. 25, and include a gasket 6002a, connector 6002b (including the trapezoidal shape at its base) and printed circuit board (PCB) 6002c, with holes 6011 provided through the connector 6002b and PCT 6002c.

Terminal block 7001 includes locking rods 7015, shown in FIG. 25, which are fixed within holes 7007. To attach the patch cable 6001, the cable is positioned so that holes 6011 align with the locking rods 7015, and then slid into position so that gasket 6002a and connector 6002b plug into the relevant socket on the terminal block. The clamp is then used to secure the cable against the terminal block, by positioning knob 9009 so that the locking plate 9007 is in the “open” position, sliding the locking rods 7015 through locking holes 9005, and toggling knob 9009 so that the locking plate 9007 is in the “lock” position, such that locking plate 9007 engages notch 7015a provided on the locking rods 7015. To remove the clamp, knob 9009 is used to slide locking plate 9007 to its “open” position, and the clamp withdrawn.

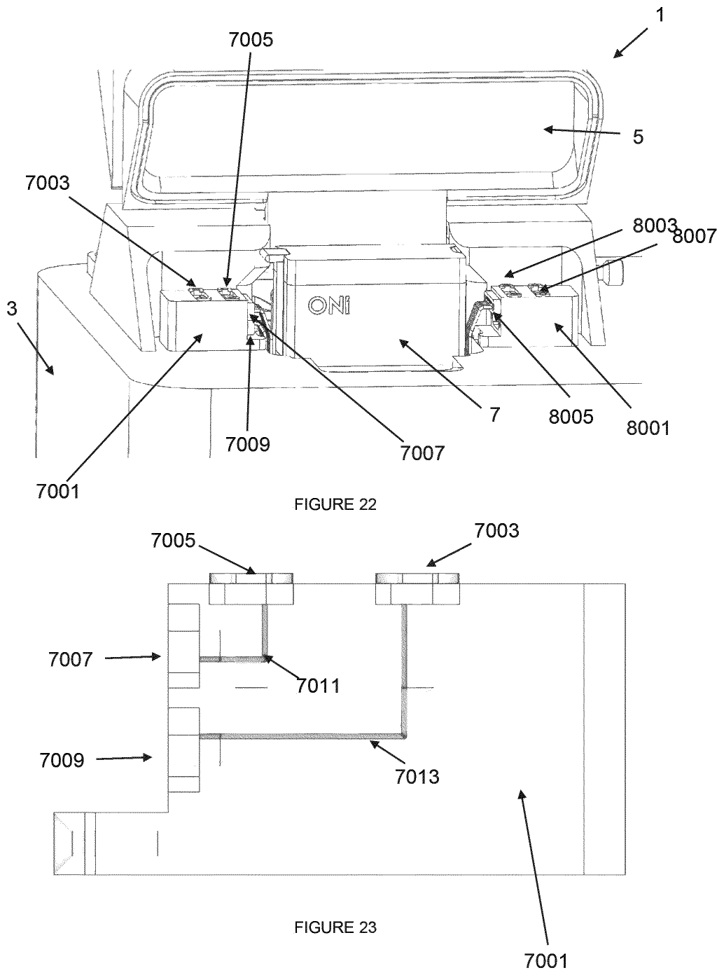

The configuration of the terminal block 7001 within microscope 1 is illustrated in more detail in FIG. 22. FIG. 22 shows microscope 1 having an enclosure 3 incorporating a hatch 5 protecting reagent cartridge 7. Provided either side of the reagent cartridge 7 are terminal blocks 7001 and 8001.

Terminal block 7001 incorporates a first socket 7007, for receiving the shared pressure output connector of the microscope (feature 217 of FIG. 4), in fluid communication with pressure-out socket 7005 via channels 7011 provided within the terminal block (as shown in FIG. 23). Similarly, terminal block 7001 incorporates a second socket 7009, for receiving the shared reagent input connector (feature 417 of FIG. 5), in fluid communication with reagent-in socket 7003.

Terminal block 8001 incorporates a first socket 8005, for receiving the shared reagent output connector of the microscope (feature 607 of FIG. 6), which feeds through to reagent-out socket 8003. In secondary microfluidic modules, the other socket 8007 provided on terminal block 8001 serves as a pressure-in socket, although for the microscope 1 this socket is not required since pressure is provided from the external pressure source as described above.

Advantageously, the provision of the pressure-out socket 7005 and reagent-in socket 7003 in a shared terminal block 7001 on the same side of the cartridge facilitates simple connection of secondary microfluidic modules, since the same length of cable can be used to link up the secondary microfluidic module. Similarly, on secondary microfluidic modules provision of the reagent-out and pressure-in sockets on a shared terminal block 8001 provided on the same side of the cartridge facilitates simple connection to the microscope 1 or to further secondary microfluidic modules.

In certain situations, both sets of tubing of a patch cable may be used simultaneously. For example, in some embodiments the analysis chip socket corresponds to a socket for receiving the patch cable having a set of inlet orifices along the shorter edge of the trapezoid and a set of outlet orifices along the longer edge of the trapezoid, and the analysis chip may include a corresponding socket for receiving the other end of the patch cable.

Turning now to details of the reagent cartridge, the cartridge socket 301 of the microscope 1 is shown in more detail in FIGS. 11 and 12. The socket shows the eight cartridge socket inlets 303 and cartridge socket outlets 305 held within channels 309 in socket mounting plate 307. In this instance the channels and inlet/outlet arrays are linear, but different channel shapes can be used to suit different cartridge configurations, as required.

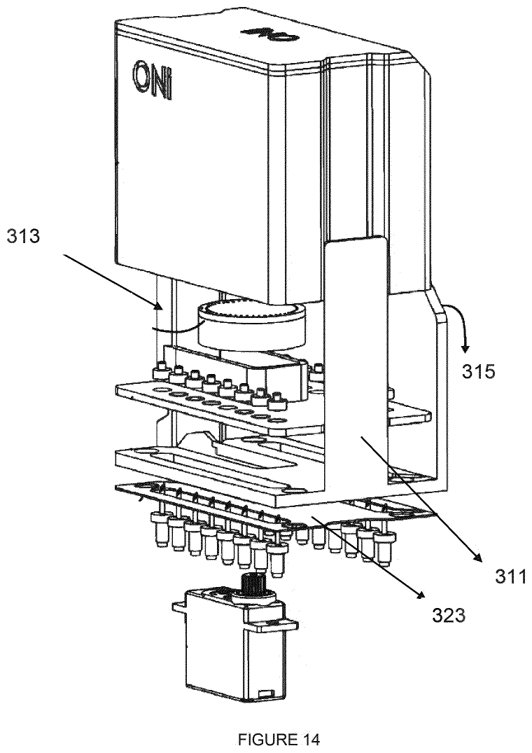

Each cartridge socket inlet 303 and cartridge socket outlet 305 take the form of a needle. This is illustrated in greater detail for a representative cartridge socket inlet in FIG. 12, which shows a flexible needle 303a surrounded by flange 303b. The cartridge socket inlet 303 has a hollow screw thread 303c (in this case an M2 thread), which in use is screwed into microscope 1 to hold the needle in position, and used to secure tubing within the screw thread through a friction fit. In alternative embodiments, the screw thread 303c may be omitted, and the inlets 303 and 305 held in place through being trapped underneath socket mounting plate 307 (for example, trapped against mounting plate 323 as shown in FIG. 14), optionally with a loading spring also trapped underneath the plate such that when a cartridge is inserted in the socket mounting plate 307 the loading spring is at least partially compressed to help the inlet engage a corresponding port in the cartridge.

The socket mounting plate 307 also comprises a gap to accommodate a rotating motor 310, which is used to actuate a cartridge held in the socket mounting plate 307, as described in relation to FIGS. 13 and 14.

Socket mounting plate 307 incorporates a guiding structure to help position and secure a cartridge. The guiding structure consists of a guide rail 311 and opposing guide clip 313, and guide wall 315, which are arranged on three sides of a rectangle. The guide clip 313 includes a lip 319 which snaps over the top of a cartridge pressed into socket 301. To remove the cartridge, a user presses handle 317 which deforms living hinge 321 so as to pull the lip 319 clear from the cartridge.

The interplay between the cartridge and elements of the guiding structure is shown in FIG. 14, which shows guide rail 311 slotting into a corresponding groove provided in the cartridge. A similar interaction occurs for guide clip 313, although this is obscured in the figure.

Elements of a reagent cartridge according to the present invention, based on a rotary valve with linking channels, is shown in FIGS. 13-18.

As shown in FIG. 13, the cartridge 3001 comprises a housing 3003 capped by lid 3005 and base 3015. The housing 3003 has grooves 3003a and 3003b on opposing sides, which mate with corresponding grooves 3005a and 3005b on lid 3005 respectively. Groove 3005a on lid 3005 incorporates a ridge 3005c onto which the lip 319 of guide clip 313 can sit to secure the cartridge into the cartridge socket shown in FIG. 11.

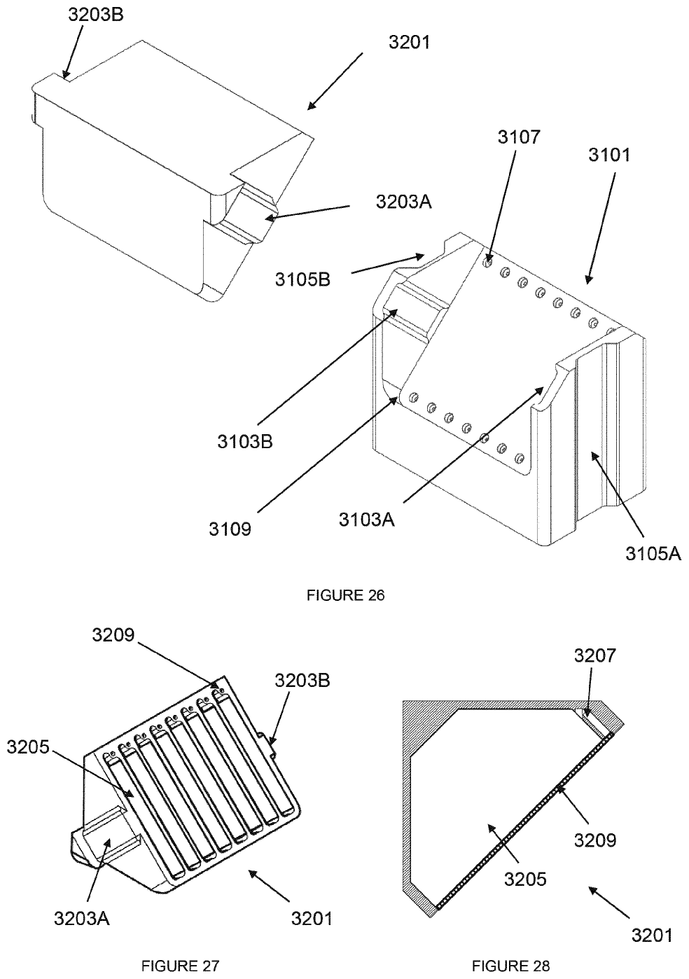

The housing 3003 is made from plastic, and has an integrally formed reagent tray incorporating sixteen reagent wells 3007 (although it is equally possible to provide the reagent tray as a separate module, as described below in relation to FIG. 26). In this case, each reagent well has an associated pressure supply channel 3009 (also integrally formed with the housing 3003), although in alternative embodiment it is possible for a pressure supply channel to be connected to multiple reagent wells. Each pressure supply channel 3009 mates with a corresponding channel in the lid, which opens at the top of the reagent well 3007, so that the opening is positioned away from reagent.

In this case the lid 3005 is removable, but it is also possible to integrally form the lid 3005 with the housing 3003, for example by injection moulding, since the reagent wells 3007 can be filled from the inlet/outlet ports described below.

Inside the housing 3003 are a stator chip assembly 4001 and rotor chip 5001 which serve as a rotary valve to modulate the flow of reagents from reservoirs 3007, and a set of cartridge outlets collectively formed by needle-stator interface plate 3011, gasket 3013 and base 3015. Although shown exploded, all components are accommodated in the housing, in abutment with adjacent parts. For example, rotor chip 5001 sits within hole 3013c of needle-stator interface 3011 so as to be flush with the upper surface, with stator chip assembly 4001 stacked immediately on top of that surface. In addition, gasket 3013 sits within slot 3015a of base 3015, with that whole assembly sitting within a hollow in the base of needle-stator interface 3011 (not shown) in engagement with the lower internal surface of the needle-stator interface.

In use the cartridge 3001 is plugged into a cartridge socket 301 by inserting the needles of the cartridge socket into gaskets 3013, with cartridge socket inlet ports 303 sliding into corresponding pressurisation ports 3013a and cartridge socket outlet ports 305 sliding into corresponding cartridge outlet ports 3013b.

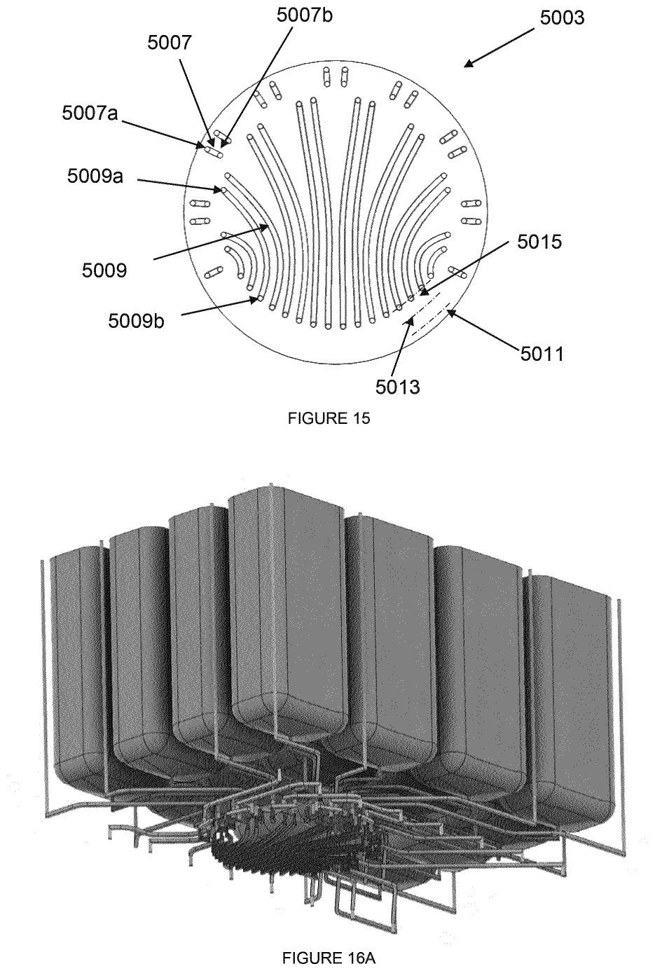

The stator chip assembly 4001 consists of three plates—an interface plate 4003, pressure input plate 4005 and reagent input plate 4007 (shown in more detail in FIG. 15), all having openings onto rotor chip plate 5003 (shown in more detail in FIG. 14). For ease of understanding, the different plates are shown in an exploded form. In practice, however, it is preferred for the stator chip assembly to be a single plate combining the various channels distributed across plates 4003, 4005 and 4007, which may be achieved, for example by carrying out diffusion bonding of the three plates depicted in FIG. 14.

In use, gas introduced through pressurisation port 3013a passes through hole 3011a provided in the needle-stator interface 3011 and on to rotor chip 5003 via a pressure input channel provided in interface plate 4003. Interface plate 4003 routes the pressurising gas to pressure input plate 4005, via a linking channel providing in rotor chip plate 5003. The pressurising gas then passes along a pressure input channel in pressure input plate 4005 to a bridging hole in reagent input plate 4007, and then upwards through pressure supply channel 3009 and a corresponding outlet in lid 3005 to reagent reservoir 3007.

Gas entering the reagent reservoir 3007 forces reagent out of an outlet (not shown) along a reagent input channel provided in reagent input plate 4007, from where it flows to rotor chip plate 5003 via bridging holes provided in pressure plate 4005 and interface plate 4003. The reagent is then routed through a reagent linking channel in rotor 5003 into a reagent output channel provided in interface plate 4003, from where it exits the cartridge via hole 3011b in needle-stator interface 3011 and cartridge outlet port 3013b.

In the cartridge shown in FIG. 13, a user is able to supply the content of any reagent container 3007 to any cartridge outlet port 3013b through rotation of rotor chip 5001, which can be referred to as a “universal” rotor chip. To do this, the rotor chip plate 5003 is mounted onto a motor adaptor 5005, which plugs onto the shaft of motor 310 (the motor being as shown in FIGS. 11 and 14). The configuration of rotor chip plate 5003 is shown in more detail in Figure to illustrate the manner in which the “universal rotor chip” can connect any reagent to any outlet.

The rotor chip plate 5003 consists of a plastic disc having thirty-two linking channels formed therein—sixteen pressure linking channels 5007 and sixteen reagent linking channels 5009.

The pressure linking channels 5007 have a pressure inlet 5007a, positioned towards the outer extremity of the rotor chip plate 5003, on track 5011, and a pressure outlet 5007b, positioned relatively inwards on track 5013. When suitably rotated, the pressure inlet 5007a mates with a pressure outlet hole provided in interface plate 4003, and pressure outlet 5007b simultaneously mates with a pressure inlet hole provided in pressure plate 4005, so as to establish a connection between a cartridge pressurisation port 3013a and a reagent reservoir 3007. By rotating the rotor chip 5001, the rotor chip can be made to connect to any of the cartridge pressurisation ports.

The sixteen reagent linking channels 5009 comprise a first opening 5009a and second opening 5009b. When the rotor chip plate 5003 is positioned such that pressure inlet 5007a and pressure outlet 5007b establish a fluid connection to the reagent reservoir, at least one reagent linking channel 5009 will be positioned such that first opening 5009a aligns with an opening in reagent input plate 4007 and the other opening 5009b aligns with a reagent output line on interface plate 4003. Both opening 5009a and 5009b are positioned on track 5015, at the same distance from the axis of rotation, so that each opening can serve as either an inlet or an outlet. Having the reagent linking channel openings 5009a and 5009b positioned on a different track to the pressure inlet 5007a and pressure outlet 5007b limits the chances of cross-contamination of the pressurisation system with reagent during rotation of the rotor chip 5001.

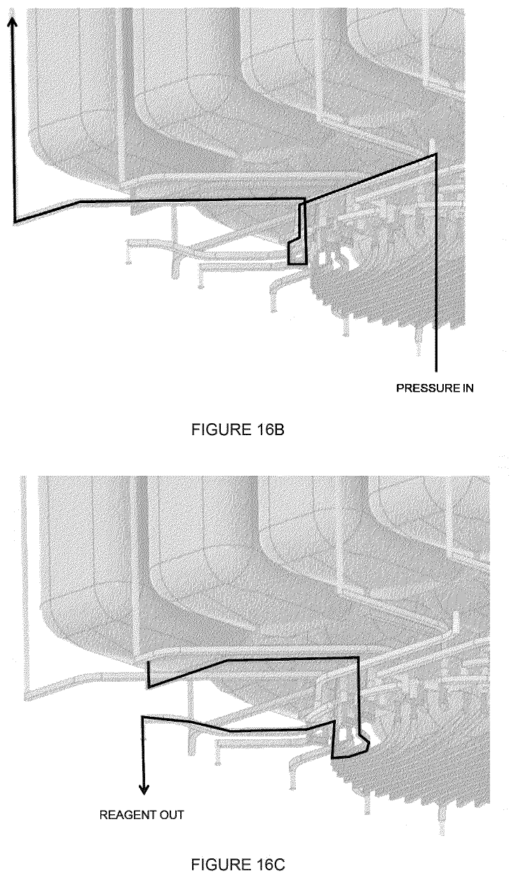

The overall channel structure of the stator chip assembly chip and universal rotor chip leading to the reagent wells is shown in FIG. 16A, where the bottom-most first layer shows channels of the rotor chip, the second layer shows channels of the interface plate, the third layer shows channels of the pressure plate with lines extending upwards to the top of the reagent wells, the fourth layer shows channels of the reagent input plate extending from the base of the reagent wells. FIG. 16B shows how pressure delivered to the interface plate is fed via the rotor chip to the pressure plate, and from there up the reagent pressure supply channel (corresponding to feature 3009 in FIG. 13) to pressurise the back left reagent well. The resulting flow of reagent from the backmost reagent well travels through the channels of the reagent input plate, down into the rotor chip, and then to the interface plate.

The pressure linking channels 5007 and reagent linking channels 5009 are formed as closed channels (for example, having a cylindrical cross-section) at the same plane within the rotor chip 5003, to simplify manufacture and ensure that the rotor chip is relatively compact. The reagent linking channels 5009 are formed as curved paths, in order to accommodate all of the channels in the same plane.

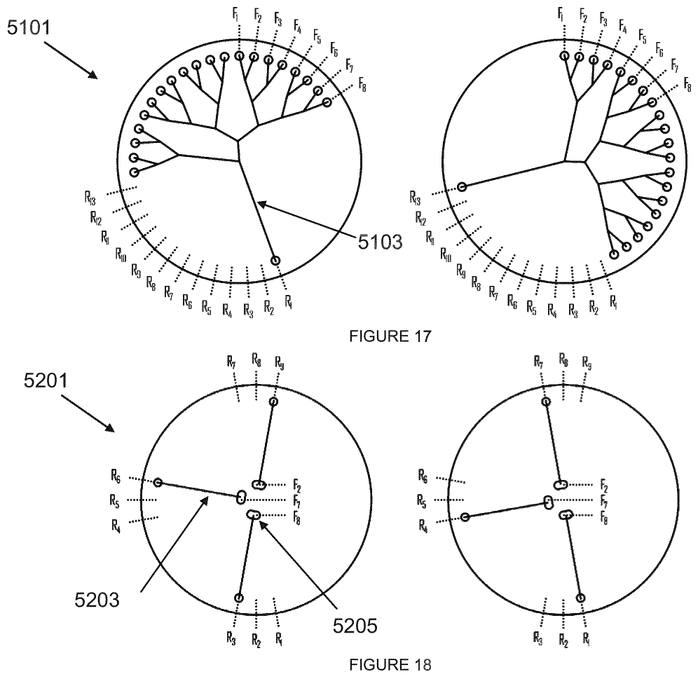

FIGS. 17 and 18 provides alternative rotor chips suitable for use in reagent cartridges according to the present invention based on a rotary valve with linking channels.

In FIG. 17, rotor chip 5101 has a branched linking channel in which a single opening on one side of the chip is connected to 20 openings on the opposite. The linking channel can be used to link up to thirteen reagent inputs, labelled R₁-R₁₃, to up to eight output reagent outputs, labelled F₁-F₈. In the left-hand image, the rotor chip 5101 is rotated so as to deliver reagent R₁ to all of F₁-F₈ simultaneously. In the right-hand image, the rotor chip 5101 has been rotated so that reagent R₁₃ is fed to all of F₁-F₈ simultaneously. If the rotor chip 5101 is rotated further, then the device can be used to simultaneously provide a number of reagent simultaneously to any output selected from F₁-F₈.

FIG. 18 shows a rotor chip 5201 designed for hydrodynamic focussing. In this case, the device features three reagent output openings F₂, F₇ and F₈, which can be fed by three reagent input channels 5203 simultaneously. Nine reagent input openings are provided, R₁-R₉, of which only three connected at one point. In the left-hand image, reagent input openings R₃, R₆ and R₉ are connected to the reagent output openings. In the right-hand image the rotor chip 5201 has been rotated, so that the reagent input openings R₁, R₄ and R₇ are connected to the reagent output openings. The reagent output openings F₂, F₇ and F₈ are arcuate slots 5205, which allows them to mate with the same opening of the stator chip assembly irrespective of which three reagent input openings are connected. The arcuate slots are relatively close to the axis of rotation so that the slots can be relatively short whilst still being able to access the same opening of the stator chip assembly.

FIGS. 26 to 34 show an alternative reagent cartridge according to the present invention, based on a rotor chip which actuates a diaphragm valve, according to the “direct chip contact” embodiment discussed above.

FIG. 26 shows the external housing of the reagent cartridge, incorporating a base module 3101 and detachable reagent module 3201. The base module 3101 includes slots 3105A and 3105B for attaching to a cartridge socket mounting plate 307 in the same manner as depicted in FIGS. 13 and 14. The reagent module 3201 is loaded onto base module 3101 by sliding guide tongues 3203A and 3203B into corresponding grooves 3103A and 3103B of base module 3101. The guide tongues 3203A and 3203B extend at an angle relative to slots 3105A and 3105B, so that the direction of the force required to load and unload reagent module 3201 from base module 3101 is different from that required to load and unload base module 3101 into the cartridge socket.

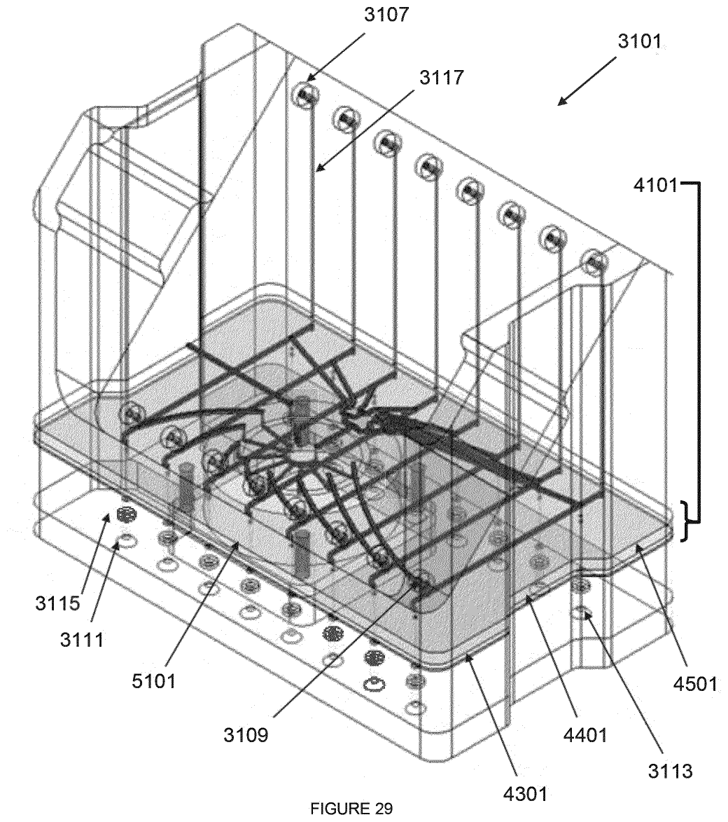

The reagent module 3201 includes eight reagent reservoirs 3205 each with an associated pressurisation channel 3207, all capped by a film 3209 (shown in FIG. 28, omitted from FIG. 27). Each pressurisation channel 3207 opens into its associated reservoir at the top of the reservoir when the reagent module 3201 is loaded on the base module 3101. The reservoirs have a triangular cross-section to facilitate full draining of the cartridge in use.

The base module includes eight pressure outlets 3107 and reagent inlets 3109, which are each provided with a needle (not shown). When the reagent module 3201 is slid into position on base module 3101 the needles associated with pressure outlets 3107 of base module 3101 pierce film 3209 and insert into the pressure channels 3207 of reagent module 3201. Similarly, the needles associated with reagent inlets 3109 pierce film 3209. In this way, the force required to insert the reagent module 3201 onto base module 3101 also establishes the fluid connections necessary to draw reagents from the reservoir.

Preferably, the film 3209 is a self-healing film. In this way, when the reagent module 3201 is detached from base module 3101, the film may re-seal to prevent unwanted escape of reagent from the reservoirs.

Although the depicted reagent module contains eight reservoirs, the skilled reader will appreciate that the cartridge can be adapted to accommodate a different number of reservoirs—for example, 16 reservoirs.

In addition, whilst the depicted embodiment is capped with a film, the skilled reader will appreciate that the film could instead be replaced with a solid wall with separate ports to interface with pressure outlets 3107 and reagent inlets 3109.

FIG. 29 shows the internal components of base module 3101. The base module 3101 includes eight cartridge pressurisation ports 3111 and eight cartridge outlet ports 3113 which are linked to stator chip assembly 4101 via gaskets 3115. In this case a separate septum is provided for each port, but it is also possible for a single structure to serve as a gasket/septum for multiple ports, analogous to gasket 3013 shown in FIG. 13). An example of a suitable septum is shown in FIGS. 43A to 43C. Rotor chip 5101 presses into the lower face of stator chip assembly 4101 to form a valve assembly.

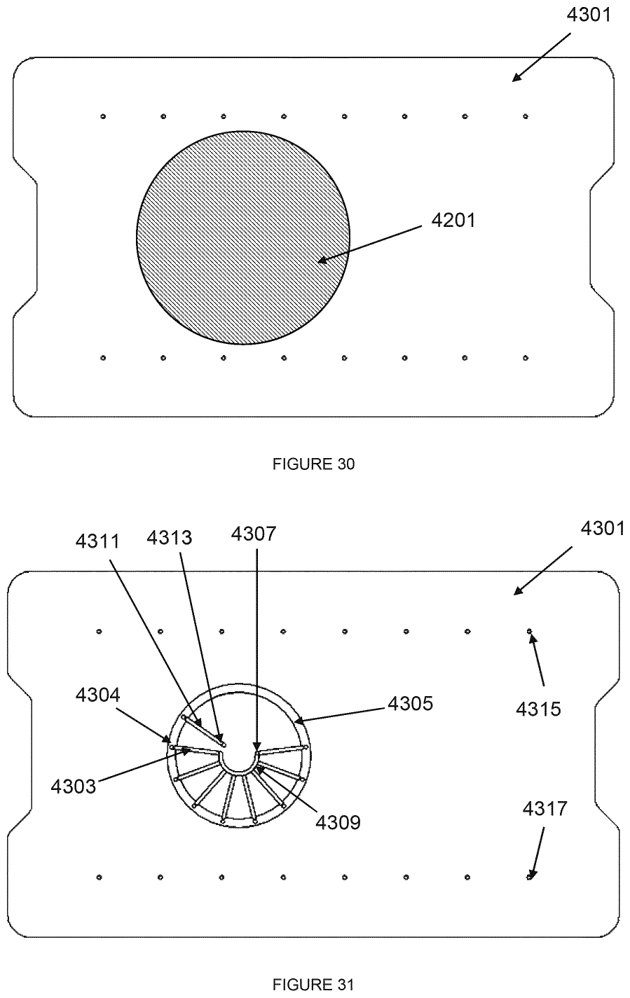

The stator chip assembly is made up of multiple layers, shown separately in FIGS. 30-33. The lowermost layer is a flexible membrane 4201 which is located on the underside of interface plate 4301. The flexible membrane 4201 may be bonded to interface plate 4301, for example, through the use of adhesive or heat bonding. In this case, the flexible membrane 4201 is a disc of polyurethane. The membrane is flat, meaning that no patterning is required prior to use.

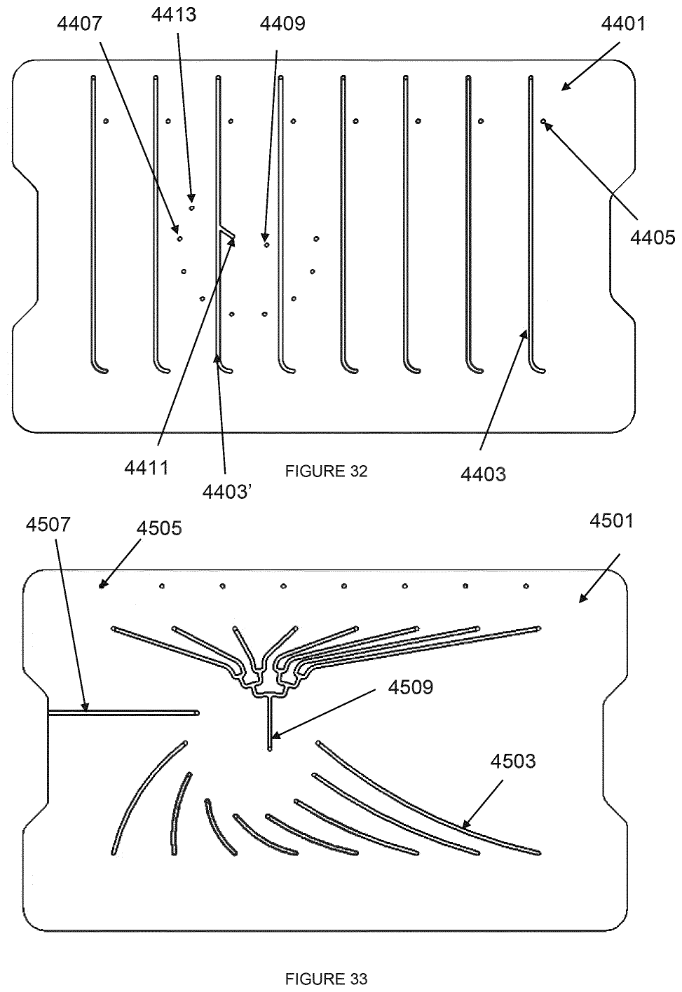

The interface plate 4301 is shown in more detail in FIG. 31, with flexible membrane 4201 removed. The topside of interface plate 4301 is bonded to pressure plate 4401 shown in FIG. 32, which itself is bonded to reagent plate 4501 shown in FIG. 33.

To pressurise the reagent module, a positive pressure is applied to cartridge pressurisation ports 3111 so that gas flows to pressure plate 4401 through holes 4317 provided in interface plate 4301, along channels 4403 in the pressure plate, upwards through holes 4505 in reagent plate 4501 to pressure channels 3117 formed in the sidewall of the base module (see FIG. 29), and then on to a reagent reservoir.

Interface plate 4301 includes eight reagent grooves 4303 which each extend from an inlet hole 4304 located in the shared circular groove 4305 to a shared outlet hole 4307 located in a central arcuate groove 4309. The inlet holes 4304 of reagent grooves 4303 are fluidly connected to the reagent inlets 3109 through a flowpath formed from holes 4407 in pressure plate 4401 and reagent inlet channels 4503 in reagent plate 4501. The outlet hole 4307 is connected to cartridge outlet ports 3113 through a flowpath formed from hole 4409 in pressure plate 4401, connected to reagent outlet channels 4509 in reagent plate 4501, which connects to the cartridge outlet ports 3113 through holes 4405 in pressure plate 4401 and holes 4315 in interface plate 4301.

In the embodiment shown in FIGS. 29 to 33, the reagent outlet channel 4509 establishes a flowpath to all of the cartridge outlet ports 3113. In other words, any given reagent inlet is able to simultaneously deliver reagent to all of the cartridge outlet ports 3113. However, the skilled reader will recognise that other configurations are possible. For example, instead of sharing a common outlet hole 4307, each reagent groove 4303 may have a separate outlet hole which directs reagent to only one, or a subset, of the cartridge outlet ports.

Optionally, the base module includes a further valve system to close off delivery of reagent from particular cartridge outlet ports—for example, a two-way valve associated with each cartridge outlet port between interface plate 4301 and cartridge outlet port 3113. Similarly, the base module may include a further valve system to close off pressurisation of a particular reagent reservoir—for example, a two-way valve.

The flow of reagent from the reservoirs to cartridge outlet ports 3113 is controlled by a valve formed through the interaction between rotor chip 5101 flexible membrane 4201 and interface plate 4301.

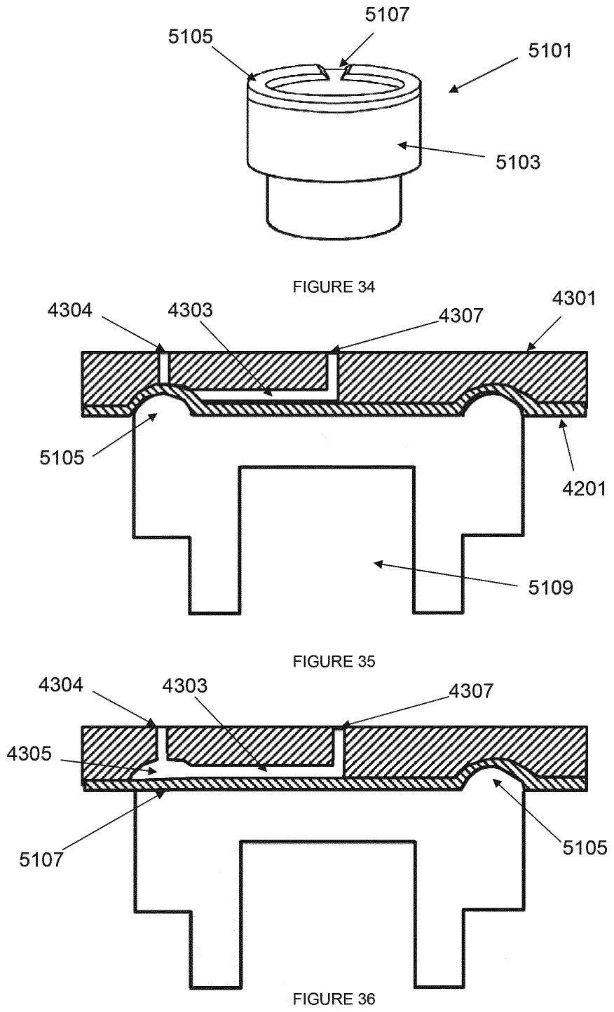

Rotor chip 5101 is shown in FIG. 34, and consists of a rotor body 5103 having a ridge 5105 encircling the outer perimeter of the top face of the rotor body 5103, with a notch 5107 separating the two rounded ends of the ridge. In use, ridge 5105 is pressed into stator assembly 4101 so that the ridge deforms flexible membrane 4201 and sits within circular groove 4305 provided on interface plate 4301. The rotor chip 5101 includes a motor mount 5109, shown in FIG. 35.

The interface plate 4301 also includes a venting channel formed by venting groove 4311, having an outlet in circular groove 4305, which exits to atmosphere through throughhole 4413 in pressure plate 4401 and channel 4507 in reagent plate 4501. The venting channel serves as a means of calibrating the position of the rotor chip relative to the stator chip assembly. Specifically, if the rotor chip is positioned such that the venting channel is open, pressure supplied through channel 4403′ of the pressure plate can divert via branch 4411, enter the interface plate via hole 4313, and exit the cartridge via venting groove 4311 and channel 4507 in reagent plate 4501. This pressure can be detected, for example, audibly through the sound of escaping gas, or through use of a pressure sensor. In contrast, when the rotor chip is positioned so that the venting channel is closed, pressure supplied through channel 4403′ is blocked from exiting the cartridge.

FIGS. 35 and 36 are cross-sectional views showing operation of the valve, depicting the rotor chip 5101, flexible membrane 4201 and interface plate 4301, but omitting other plates for ease of interpretation. FIG. 35 shows the flowpath from inlet hole 4304 to reagent groove 4303 is blocked by flexible membrane 4201, which is pushed upwards into circular groove 4305. Thus, the flowpath is in a “closed” configuration. In FIG. 36, the rotor body has been rotated so that notch 5107 is aligned with inlet hole 4304. This allows flexible membrane 4201 to relax out of circular groove 4305, thus establishing a flowpath between inlet hole 4304 and outlet hole 4307, so that the flowpath is in an “open” configuration. The region of the flowpath actuated by the rotor chip corresponds to the “valve section” discussed in the summary of the invention section above. The embodiment depicted shows ridge 5105 blocking the exit of inlet hole 4304, but the skilled reader will appreciate that it is also possible for the ridge 5105 to be positioned away from inlet hole 4304, e.g. by pinching reagent groove 4303 closed.

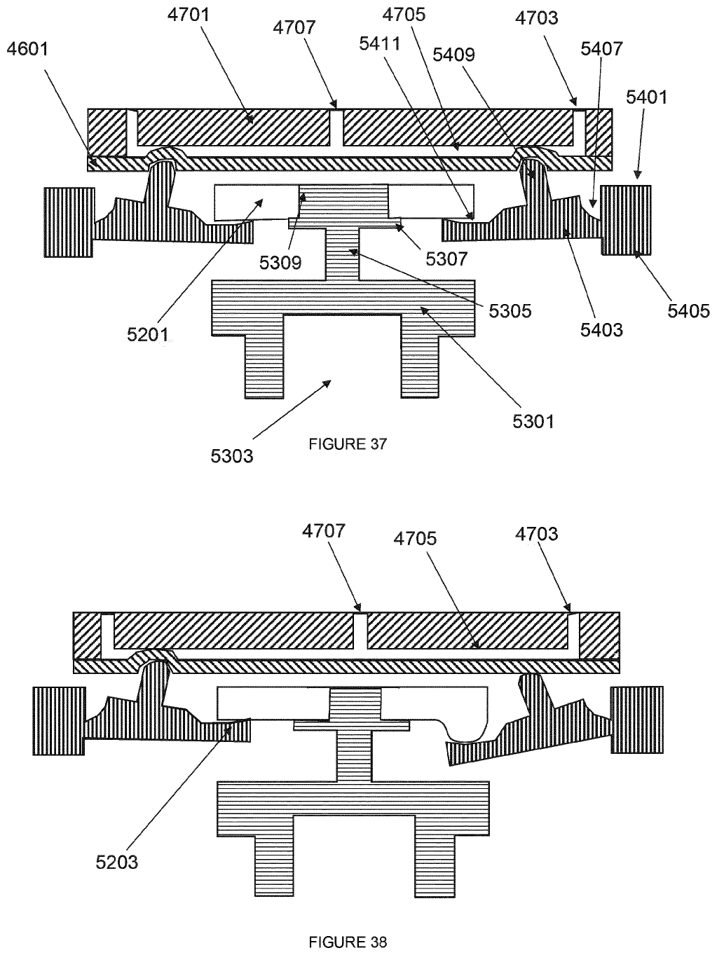

FIGS. 37 to 41 show an alternative valve mechanism based on a rotor chip which actuates a diaphragm valve, according to the “indirect chip contact” embodiment discussed above.

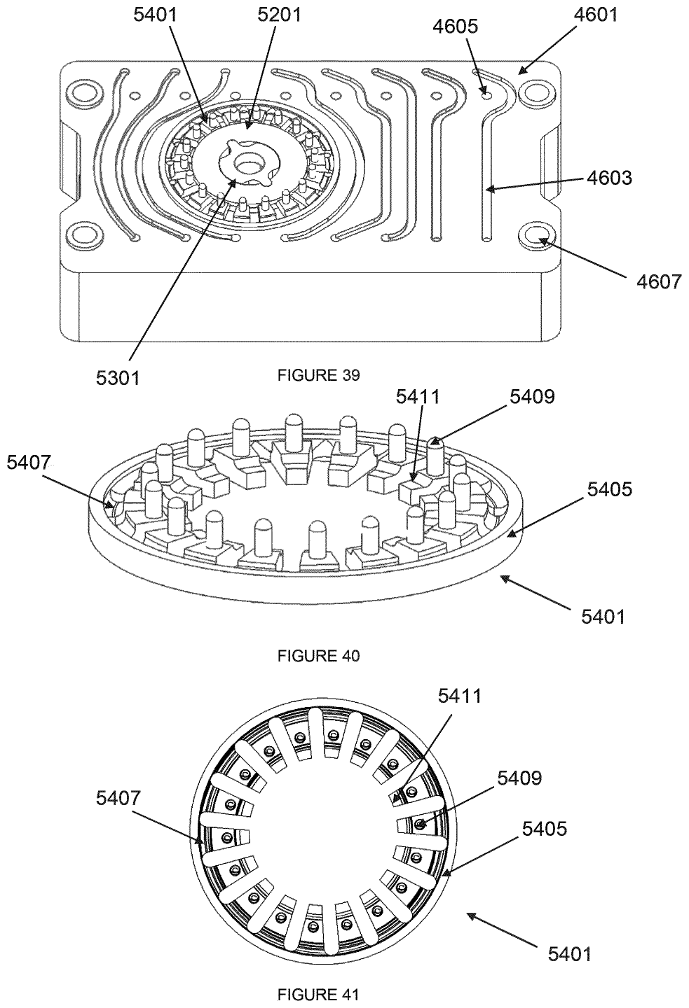

Operation of the valve mechanism is shown in FIGS. 37 and 38. In this mechanism, the rotor chip consists of a rotor 5301 having a motor mount 5303 at its base, and a shaft 5305 extending from its top face. A capping disc 5201 is inserted onto shaft 5305 so that it rests upon flange 5307, with locking projections 5309 of shaft 5305 slotting into corresponding locking grooves provided in capping disc 5201 to prevent relative rotational motion of capping disc 5201 around shaft 5305 (as shown in FIG. 39). In this instance, the connection between capping disc 5201 and shaft 5305 is a friction fit, but the skilled reader will appreciate that other forms of connection are possible.

The rotor chip interfaces with an actuator assembly 5401. The actuator assembly consists of eighteen pins 5403, each mounted to a shared ring 5405 via a joint 5407, with a lip 5411 positioned in the groove formed between the lower surface of the capping disc 5201 and rotor body 5301. The pins have a rounded head 5409 which, in the assembly's resting state, is urged into flexible membrane 4601 so as to occlude a reagent channel 4705 formed in reagent plate 4701. This prevents the flow of reagent from inlet hole 4703 to outlet hole 4707.

In FIG. 38, the rotor body 5301 and its associated capping disc 5201 have been rotated relative to the actuator assembly 5401, flexible membrane 4601 and reagent plate 4701. In so doing, a protrusion 5203 on the lower surface of capping disc 5201 has slid into contact with lip 5411 of actuator pin 5403, bending joint 5407 so that pin head 5409 is pushed downwards. This unblocks reagent channel 4705 allowing passage of reagents from inlet hole 4703 to outlet hole 4707, and then on to other components of the stator assembly (not shown, for simplicity).

The other components of the reagent cartridge may be as described above in relation to the other figures. FIG. 39 shows mounting of the capping disc 5201, rotor 5301 and actuator assembly 5401 within a pressure plate 4601 in the base module of the cartridge. The actuator assembly 5401 rests within a flanged recess within pressure plate 4601. The pressure plate incorporates pressure channels 4603 which connect with cartridge pressurisation ports via an internal gasket, and throughholes 4605 which link through to cartridge outlet ports via an internal gasket (both gaskets being analogous to those shown as feature 3013 in FIG. 13). In use, a sealing plate (not shown) is secured over the top surface of plate 4601 so as to seal pressure channels 4603, with slots for the pin heads 5409 and throughholes 4605. To facilitate positioning of the sealing plate, the pressure plate 4601 incorporates alignment holes 4607 having a raised rim which slots into corresponding gaps provided in the sealing plate, and providing a hole for inserting a guiding pin on other plates to ensure alignment. The sealing plate may be made from, for example, aluminium.

The actuator assembly 5401 is shown in more detail in FIGS. 40 and 41. The part is integrally formed in plastic, facilitating easy manufacture, installation and replacement of the part. The depicted embodiment includes eighteen pins, but the skilled reader will appreciate that any number and other arrangements of the pins are possible. In addition, the depicted embodiment includes the pins positioned on the inside of a circular support ring, but the skilled reader will appreciate that it is possible to implement alternative configurations.

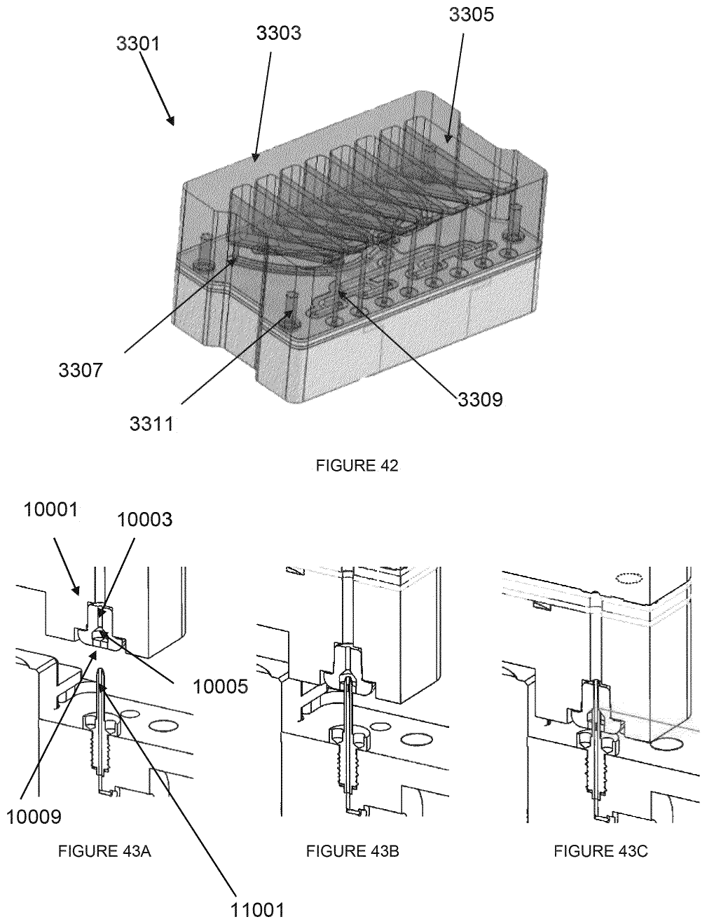

FIG. 42 shows an alternative reagent cartridge 3301 according to the invention. In this instance, the cartridge incorporates a reagent tray 3303 with eight reagent reservoirs 3305 having a sloped bottom to encourage draining of the reservoir towards outlet 3307. Each reagent reservoir 3305 is pressurised by a pressurisation channel 3309. The reagent tray is aligned with underlying plates through guide pin 3209, which fit into corresponding holes in lower plates (as in feature 4605 of FIG. 39). In this case, the reagent tray 3303 is bonded to lower plates through adhesive, although in other implementations the reagent tray may be removable and held in place by a releasable mechanism, such as a clip.

FIGS. 43A-C show a septum 10001 particularly well suited to use with the cartridge outlet port (and optionally cartridge pressurisation ports) of the cartridges of the invention. The septum 10001 has a central bore having a wider entry portion 10005 funnelling into a narrower portion 10003. The bore is sealed by elastomeric membrane 10009 having a central slit. In use, the cartridge is pushed down onto needle 11001 so that the needle inserts through the central slit of membrane 10009 as shown in FIG. 43B, causing the membrane to deform into entry portion 10005. The needle is then guided into narrower portion 10003 by the funnelled section, until it is gripped by the interior walls defining the narrower portion, as shown in FIG. 43C. The elastomeric membrane 10009 continues to grip the needle when inserted, meaning that the membrane is gribbed both at its top and towards its base. When the cartridge is lifted off of the needle, the membrane returns to seal the bore, so as to prevent egress of liquid.

The following numbered clauses provide examples of embodiments of the invention:

[1] A measurement device, comprising:
(i) an analysis chip mount, for receiving an analysis chip;
(ii) measurement apparatus, for analysing an analysis chip mounted on the analysis chip mount; and
(iii) a master microfluidic module, for supplying reagents to an analysis chip mounted on the analysis chip mount, the master microfluidic module comprising:
   a cartridge socket, having a plurality of cartridge socket inlet ports and cartridge socket outlet ports, for receiving a reagent cartridge;
   a pressure manifold, comprising a plurality of pressure feed lines connectable to an external pressure source, each pressure feed line having an associated multi-way valve assembly for selectively connecting the pressure feed line to either an external pressure output line or a cartridge socket pressure line; and
   a chip input manifold, comprising a plurality of chip input lines for providing reagent to said analysis chip in use; each chip input line having an associated multi-way valve assembly for selectively connecting the chip input line to either a cartridge socket reagent line or an external reagent input line;
wherein the plurality of external pressure output lines terminate in a shared pressure output connector and the plurality of external reagent input lines originate from a shared external reagent input connector.

[2] A measurement device according to [1], incorporating a secondary microfluidic module connected to the master microfluidic module via said shared pressure output connector and said shared external reagent input connector.

[3] A measurement device according to [2], wherein the secondary microfluidic module comprises:
a cartridge socket, having a plurality of cartridge socket inlet ports and cartridge socket outlet ports, for receiving a reagent cartridge;
a pressure manifold for supplying pressure to the cartridge socket, comprising a plurality of pressure feed lines originating from a shared pressure input connector, each pressure feed line fluidly connected to a cartridge socket inlet port; and
a reagent manifold, comprising a plurality of reagent output lines terminating in a shared reagent output connector, each reagent output line fluidly connected with a cartridge socket outlet port;
wherein the pressure input connector is fluidly connected to the external pressure output connector of the master microfluidic module, and the reagent output connector is fluidly connected to the external reagent input connector of the master microfluidic module.

[4] A measurement device according to [2], wherein the secondary microfluidic module comprises:
a cartridge socket, having a plurality of cartridge socket inlet ports and cartridge socket outlet ports, for receiving a reagent cartridge;
a pressure manifold, comprising a plurality of pressure feed lines each having an associated multi-way valve assembly for selectively connecting the pressure feed line to either an external pressure output line or a cartridge socket pressure line; and
a reagent manifold, comprising a plurality of reagent output lines having an associated multi-way valve assembly for selectively connecting upstream to either a cartridge socket reagent line or an external reagent input line;
wherein
the plurality of pressure feed lines originate from a shared external pressure input connector;
the plurality of external pressure output lines terminate in a shared external pressure output connector;
the plurality of external reagent input lines originate from a shared external reagent input connector;
the plurality of reagent output lines terminate in a shared reagent output connector;
the external pressure input connector is fluidly connected to the external pressure output connector of the master microfluidic module, and
the external reagent output connector is fluidly connected to the external reagent input connector of the master microfluidic module.

[5] A measurement device according to [4], wherein the reagent manifold comprises a fluidic chip socket, having a plurality of fluidic chip socket inlet ports and fluidic chip socket outlet ports, each fluidic chip socket inlet port being connected to said associated multi-way valve assembly, for selectively connecting the chip input line to either the cartridge socket reagent line or the external reagent input line, and each outlet port being fluidly connected to said reagent output line.

[6] A measurement device according to [5], further comprising a fluidic chip plugged into said fluidic chip socket.

[7] A measurement device according to any one of [4] to [6], comprising at least two of said secondary microfluidic modules attached to the master microfluidic module in a daisy chain configuration, such that the external pressure input connector of secondary microfluidic module l+1 is connected to the external pressure output connector of secondary microfluidic module l; and the external reagent output connector of secondary module l+1 is connected to the external reagent input connector of secondary microfluidic module l, where l is greater than or equal to 1.

[8] A measurement device according to any preceding claim, further comprising a reagent cartridge plugged into the cartridge socket of the master microfluidic module.

[9] A measurement device according to [8], wherein the reagent cartridge comprises a housing having a mating surface contacting the cartridge socket of the master microfluidic module, the housing containing:
a plurality of reagent reservoirs;
a plurality of cartridge pressurisation ports connected to the cartridge socket inlet ports, for pressurising the reagent reservoirs in use;
a plurality of cartridge outlet ports connected to the cartridge socket outlet ports, for dispensing reagent from the cartridge in use; and
a valve assembly, for regulating flow of reagents from the reagent reservoirs to the cartridge outlet ports in use, the valve assembly comprising:
   a stator chip assembly, comprising
   a plurality of primary reagent channels fluidly connected to the reagent reservoirs; and
      a plurality of secondary reagent channels fluidly connected to the cartridge outlet ports; and
   a rotor chip, sealingly engaging the stator chip assembly, the rotor chip having one or more linking channel(s) for fluidly connecting the primary reagent channels and secondary reagent channels; wherein the rotor chip is rotatable relative to the stator chip assembly between a first position and a second position, and wherein said rotation causes the linking channel(s) to establish a different fluid connection between the primary reagent channel(s) and the secondary reagent channel(s) in the first position compared to the second position;
wherein the cartridge pressurisation ports and cartridge outlet ports are provided on the mating surface of the housing.

A measurement device according to [8], wherein the reagent cartridge comprises a housing containing:
a plurality of reagent reservoirs;
a plurality of cartridge pressurisation ports connected to the cartridge socket inlet ports, for pressurising the reagent reservoirs in use;
a plurality of cartridge outlet ports connected to the cartridge socket outlet ports, for dispensing reagent from the cartridge in use; and
a valve assembly, for regulating pressurisation of the reagent reservoirs and flow of reagents from the reagent reservoirs to the cartridge outlet ports in use, the valve assembly comprising:
   a stator chip assembly, comprising
      a plurality of primary reagent channels fluidly connected to the reagent reservoirs; and
      a plurality of secondary reagent channels fluidly connected to the cartridge outlet ports;
      a plurality of primary pressure channels fluidly connected to the cartridge pressurisation ports;
      a plurality of secondary pressure channels fluidly connected to the reagent reservoirs; and
   a rotor chip, sealingly engaging the stator chip, the rotor chip having
      one or more reagent linking channel(s) for fluidly connecting the primary reagent channels and secondary reagent channels; and
      one or more pressure linking channel(s) for fluidly connecting the primary pressure channels to the secondary pressure channels;
   wherein the rotor chip is rotatable relative to the stator chip assembly between a first position and a second position, and wherein
      said rotation causes the reagent linking channel(s) to establish a different fluid connection between the primary reagent channel(s) and the secondary reagent channel(s) in the first position compared to the second position; and/or
      said rotation causes the pressure linking channel(s) to establish a different fluid connection between the primary pressure channel(s) and the secondary pressure channels in the first position compared to the second position.

[11] A measurement device according to [8], wherein the reagent cartridge comprises a housing containing:
a plurality of reagent reservoirs;
a plurality of cartridge pressurisation ports connected to the cartridge socket inlet ports, for pressurising the reagent reservoirs in use;
a plurality of cartridge outlet ports connected to the cartridge socket outlet ports, for dispensing reagent from the cartridge in use; and
a valve assembly, for regulating flow of reagents from the reagent reservoirs to the cartridge outlet ports in use, the valve assembly comprising:
   a stator chip assembly, comprising
      a plurality of primary reagent channels fluidly connected to the reagent reservoirs; and
      a plurality of secondary reagent channels fluidly connected to the cartridge outlet ports;
   a rotor chip, sealingly engaging the stator chip, the rotor chip having a plurality of reagent linking channel(s) for fluidly connecting the primary reagent channels and secondary reagent channels;
   wherein the rotor chip is rotatable relative to the stator chip assembly, and wherein said rotation causes the reagent linking channel(s) to establish a different fluid connection between the primary reagent channel(s) and the secondary reagent channel(s); and wherein the plurality of reagent linking channels is arranged such that any primary reagent channel can be connected to any secondary reagent channel.

[12] A measurement device according to [8], wherein the reagent cartridge comprises a housing containing:
a plurality of reagent reservoirs;
a plurality of cartridge pressurisation ports connected to the cartridge socket inlet ports, for pressurising the reagent reservoirs in use;
a plurality of cartridge outlet ports connected to the cartridge socket outlet ports, for dispensing reagent from the cartridge in use; and
a valve assembly, for regulating flow of reagents from the reagent reservoirs to the cartridge outlet ports in use, the valve assembly comprising:
   a stator chip assembly, comprising
      a plurality of primary reagent channels fluidly connected to the reagent reservoirs; and
      a plurality of secondary reagent channels fluidly connected to the cartridge outlet ports;
   a rotor chip, sealingly engaging the stator chip, the rotor chip having a branched reagent linking channel(s) for fluidly connecting the primary reagent channels and secondary reagent channels;
wherein the rotor chip is rotatable relative to the stator chip assembly, and wherein said rotation causes the reagent linking channel(s) to establish a different fluid connection between the primary reagent channel(s) and the secondary reagent channel(s); and wherein the branched reagent linking channel(s) is able to simultaneously direct flow from a primary reagent channel to multiple secondary reagent channels and/or is able to simultaneously direct flow from multiple primary reagent channels to a secondary reagent channel.

[13] A measurement device according to any one of [3] to [7], further comprising a reagent cartridge plugged into the cartridge socket of at least one secondary microfluidic module.

[14] A measurement device according to [13], wherein the reagent cartridge is as defined in any one of [9] to [12].

[15] A measurement device according to any one of [3] to [7], further comprising a routing cartridge plugged into the cartridge of socket of at least one secondary microfluidic module, wherein the routing cartridge allows the cartridge to be connected to a secondary microfluidic module.

[16] A measurement device according to [14], wherein the routing cartridge comprises
a plurality of cartridge pressurisation ports connected to exterior output tubes, the cartridge pressurisation ports connected to the cartridge socket inlet ports of the secondary microfluidic module;
a plurality of cartridge outlet ports connected to the cartridge socket outlet ports of the secondary microfluidic module, for dispensing reagent from the cartridge in use; and
a valve assembly comprising:
   a stator chip assembly, comprising
      a plurality of primary reagent channels each fluidly connected to an exterior input tube; and
      a plurality of secondary reagent channels each fluidly connected to the cartridge outlet ports; and
   a rotor chip, sealingly engaging the stator chip assembly, the rotor chip having one or more linking channel(s) for fluidly connecting the primary reagent channels and secondary reagent channels; wherein the rotor chip is rotatable relative to the stator chip assembly between a first position and a second position, and wherein said rotation causes the linking channel(s) to establish a different fluid connection between the primary reagent channel(s) and the secondary reagent channel(s) in the first position compared to the second position;
wherein
the plurality of exterior output tubes terminate in a shared exterior cartridge output connector; and
the plurality of exterior input tubes terminate in a shared exterior cartridge input connector.

[17] A measurement device according to [16], wherein the routing cartridge is attached to an additional secondary microfluidic module, wherein the exterior cartridge output connector of the routing cartridge is connected to the external pressure input connector of the additional secondary microfluidic module, and the exterior cartridge input connector is connected to the reagent output connector of the additional secondary microfluidic module.

[18] A measurement device according to any one [1] to [17], comprising an enclosure housing the analysis chip mount, the measurement apparatus, and the master microfluidic module.

[19] A measurement device according to [18], wherein the pressure output connector and external reagent input connector of the master microfluidic module are positioned on the outside of the enclosure.

[20] A measurement device according to or [19], wherein the enclosure incorporates a hatch for accessing the cartridge socket.

[21] A measurement device according to [20], wherein the shared pressure output connector and the external reagent input connector attach to a terminal block provided beneath the hatch.

[22] A measurement device according to any one of [1] to [21], wherein the measurement device is an optical measurement device, and the measurement apparatus incorporates optical measurement apparatus.

[23] A measurement device according to [22], wherein the measurement device is an optical microscope and the measurement apparatus incorporates a light source and a light detector.

[24] A secondary microfluidic module suitable for connection to the master microfluidic module of a measurement device as defined in [1], comprising:
a cartridge socket, having a plurality of cartridge socket inlet ports and cartridge socket outlet ports, for receiving a reagent cartridge;
a pressure manifold, comprising a plurality of pressure feed lines each having an associated multi-way valve assembly for selectively connecting the pressure feed line to either an external pressure output line or a cartridge socket pressure line; and
a reagent manifold, comprising a plurality of reagent output lines having an associated multi-way valve assembly for selectively connecting upstream to either a cartridge socket reagent line or an external reagent input line;
wherein
the plurality of pressure feed lines originate from a shared external pressure input connector;
the plurality of external pressure output lines terminate in a shared external pressure output connector;
the plurality of external reagent input lines originate from a shared external reagent input connector;
the plurality of reagent output lines terminate in a shared reagent output connector;
the external pressure input connector is fluidly connectable to the external pressure output connector of the master microfluidic module, and
the external reagent output connector is fluidly connectable to the external reagent input connector of the master microfluidic module.

[25] A kit comprising a measurement device according to [1] and a secondary microfluidic module according to [24].

[26] A reagent cartridge for delivering reagents to a microfluidic system, the reagent cartridge comprising a housing containing:
a plurality of reagent reservoirs;
a plurality of cartridge pressurisation ports, for pressurising the reagent reservoirs in use;
a plurality of cartridge outlet ports, for dispensing reagent from the cartridge in use; and
a valve assembly, for regulating pressurisation of the reagent reservoirs and flow of reagents from the reagent reservoirs to the cartridge outlet ports in use, the valve assembly comprising:
   a stator chip assembly, comprising
      a plurality of primary reagent channels fluidly connected to the reagent reservoirs; and
      a plurality of secondary reagent channels fluidly connected to the cartridge outlet ports;
      a plurality of primary pressure channels fluidly connected to the cartridge pressurisation ports;
   a plurality of secondary pressure channels fluidly connected to the reagent reservoirs; and
      a rotor chip, sealingly engaging the stator chip assembly, the rotor chip having one or more reagent linking channel(s) for fluidly connecting the primary reagent channels and secondary reagent channels; and
      one or more pressure linking channel(s) for fluidly connecting the primary pressure channels to the secondary pressure channels;
   wherein the rotor chip is rotatable relative to the stator chip assembly between a first position and a second position, and wherein
      said rotation causes the reagent linking channel(s) to establish a different fluid connection between the primary reagent channel(s) and the secondary reagent channel(s) in the first position compared to the second position; and/or
      said rotation causes the pressure linking channel(s) to establish a different fluid connection between the primary pressure channel(s) and the secondary pressure channels in the first position compared to the second position.

[27] A reagent cartridge according to [26], wherein the rotor chip comprises a plurality of reagent linking channels.

[28] A reagent cartridge according to [27], wherein the reagent linking channels are provided in the same plane of the rotor chip.

[29] A reagent cartridge according to or [27], wherein the plurality of linking channels are capable of linking any primary reagent channel to any secondary reagent channel.

[30] A reagent cartridge according to any one of to [29], wherein the rotor chip comprises a plurality of pressure linking channels in addition to said plurality of reagent linking channels.

[31] A reagent cartridge according to [30], wherein the reagent linking channels and pressure linking channels are provided in the same plane of the rotor chip.

[32] A reagent cartridge according to any one to [31], wherein the primary reagent channels and secondary reagent channels of the stator chip assembly open onto the same face of the stator chip assembly, and the rotor chip assembly engages said face of the stator chip assembly.

[33]. A reagent cartridge according to [32], wherein the rotor chip has a first face which engages the stator chip assembly, and a second face having a motor mounting adaptor.

[34] A reagent cartridge according to or [33], wherein the reagent linking channel(s) and pressure linking channel(s) consist of closed channels having openings on a face of the rotor chip.

[35] A reagent cartridge according [34], wherein the openings of the reagent linking channel(s) and pressure linking channel(s) are positioned according to a regular angular pattern.

[36] A reagent cartridge according to [10], wherein the angle between any two openings of the reagent linking channel(s) and/or pressure linking channel(s) on the rotor chip, as measured from the axis of rotation of the rotor chip, is a multiple of 360°/n where n is an integer of 3 or more.

[37] A reagent cartridge according to any one of to [36], wherein the openings of the pressure linking channel(s) on the rotor chip are positioned on a different track to the openings of the reagent linking channel(s), such that the openings of the pressure linking channel(s) are positioned at a different distance from the axis of rotation of the rotor chip compared to the openings of the reagent linking channel(s).

[38] A reagent cartridge according to [37], wherein the openings for the pressure linking channel(s) are on a track further outwards than the openings for the reagent linking channel(s).

[39] A reagent cartridge according to any one of to [38], wherein at least one of the reagent linking channels is a branched channel suitable for connecting a primary reagent channel to multiple secondary reagent channels, or a secondary reagent channel to multiple primary reagent channels.

[40] A reagent cartridge according to any one of to [39], wherein at least one reagent linking channel and/or pressure linking channel includes a slot-shaped opening extending around the rotational axis of the rotor chip.

[41] A reagent cartridge according to [27], wherein the plurality of reagent linking channels is arranged such that any primary reagent channel can be connected to any secondary reagent channel.

[42] A reagent cartridge according to any one of to [41], wherein the rotor chip and stator chip assembly include one or more indexing elements, to help achieve the correct indexing between rotor chip and stator chip assembly after the rotor chip moves between said first and second position.

[43] A reagent cartridge according to [42], wherein the one or more indexing elements is a spring plunger system provided at the interface between the rotor chip and stator chip.

[44] A reagent cartridge according to any one of to [43], wherein the stator chip assembly is a single plate having the reagent input channels, reagent output channels, and pressure input channels formed therein.

[45] A reagent cartridge according to any one of to [44], wherein the housing has a mating surface for connection to a cartridge socket, wherein the cartridge pressurisation ports and cartridge outlet ports are provided on the mating surface of the housing, to allow the cartridge to be plugged into corresponding ports on the cartridge socket.

[46] A reagent cartridge according to any one of to [45], wherein the plurality of cartridge pressurisation ports and plurality of cartridge outlet ports take the form of holes provided in the housing.

[47] A reagent cartridge comprises a housing having a mating surface for connection to a cartridge socket, the housing containing:
a plurality of reagent reservoirs;
a plurality of cartridge pressurisation ports in fluid communication with the reagent reservoirs, for pressurising the reagent reservoirs in use;
a plurality of cartridge outlet ports, for dispensing reagent from the cartridge in use; and
a valve assembly, for regulating flow of reagents from the reagent reservoirs to the cartridge outlet ports in use, the valve assembly comprising:
   a stator chip assembly, comprising
      a plurality of primary reagent channels fluidly connected to the reagent reservoirs; and
      a plurality of secondary reagent channels fluidly connected to the cartridge outlet ports; and
   a rotor chip, sealingly engaging the stator chip assembly, the rotor chip having one or more linking channel(s) for fluidly connecting the primary reagent channels and secondary reagent channels; wherein the rotor chip is rotatable relative to the stator chip assembly between a first position and a second position, and wherein said rotation causes the linking channel(s) to establish a different fluid connection between the primary reagent channel(s) and the secondary reagent channel(s) in the first position compared to the second position;
wherein the cartridge pressurisation ports and cartridge outlet ports are provided on the mating surface of the housing, to allow the cartridge to be plugged into corresponding ports on said cartridge socket in use.

[48] A reagent cartridge comprising a housing containing:
a plurality of reagent reservoirs;
a plurality of cartridge pressurisation ports, for pressurising the reagent reservoirs in use;
a plurality of cartridge outlet ports, for dispensing reagent from the cartridge in use; and
a valve assembly, for regulating flow of reagents from the reagent reservoirs to the cartridge outlet ports in use, the valve assembly comprising:
   a stator chip assembly, comprising
      a plurality of primary reagent channels fluidly connected to the reagent reservoirs; and
      a plurality of secondary reagent channels fluidly connected to the cartridge outlet ports;
   a rotor chip, sealingly engaging the stator chip, the rotor chip having a plurality of reagent linking channel(s) for fluidly connecting the primary reagent channels and secondary reagent channels;
   wherein the rotor chip is rotatable relative to the stator chip assembly, and wherein said rotation causes the reagent linking channel(s) to establish a different fluid connection between the primary reagent channel(s) and the secondary reagent channel(s); and wherein the plurality of reagent linking channels is arranged such that any primary reagent channel can be connected to any secondary reagent channel.

[49] A reagent cartridge comprising a housing containing:
a plurality of reagent reservoirs;
a plurality of cartridge pressurisation ports, for pressurising the reagent reservoirs in use;
a plurality of cartridge outlet ports, for dispensing reagent from the cartridge in use; and
a valve assembly, for regulating flow of reagents from the reagent reservoirs to the cartridge outlet ports in use, the valve assembly comprising:
   a stator chip assembly, comprising
      a plurality of primary reagent channels fluidly connected to the reagent reservoirs; and
      a plurality of secondary reagent channels fluidly connected to the cartridge outlet ports;
   a rotor chip, sealingly engaging the stator chip, the rotor chip having a branched reagent linking channel(s) for fluidly connecting the primary reagent channels and secondary reagent channels;
wherein the rotor chip is rotatable relative to the stator chip assembly, and wherein said rotation causes the reagent linking channel(s) to establish a different fluid connection between the primary reagent channel(s) and the secondary reagent channel(s); and wherein the branched reagent linking channel(s) is able to simultaneously direct flow from a primary reagent channel to multiple secondary reagent channels and/or is able to simultaneously direct flow from multiple primary reagent channels to a secondary reagent channel.

[50] A microfluidic device, comprising a reagent cartridge as defined in any one of to [49].

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps. It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. A measurement device, comprising:
(i) an analysis chip mount, for receiving an analysis chip;
(ii) measurement apparatus, for analysing an analysis chip mounted on the analysis chip mount; and
(iii) a master microfluidic module, for supplying reagents to an analysis chip mounted on the analysis chip mount, the master microfluidic module comprising:
a cartridge socket, having a plurality of cartridge socket inlet ports and cartridge socket outlet ports, for receiving a reagent cartridge;
a pressure manifold, comprising a plurality of pressure feed lines connectable to an external pressure source, each pressure feed line having an associated multi-way valve assembly for selectively connecting the pressure feed line to either an external pressure output line or a cartridge socket pressure line; and
a chip input manifold, comprising a plurality of chip input lines for providing reagent to said analysis chip in use; each chip input line having an associated multi-way valve assembly for selectively connecting the chip input line to either a cartridge socket reagent line or an external reagent input line;
wherein the plurality of external pressure output lines terminate in a shared pressure output connector and the plurality of external reagent input lines originate from a shared external reagent input connector.

2. A measurement device according to claim 1, incorporating a secondary microfluidic module connected to the master microfluidic module via said shared pressure output connector and said shared external reagent input connector.

3. A measurement device according to claim 2, wherein the secondary microfluidic module comprises:
a cartridge socket, having a plurality of cartridge socket inlet ports and cartridge socket outlet ports, for receiving a reagent cartridge;
a pressure manifold for supplying pressure to the cartridge socket, comprising a plurality of pressure feed lines originating from a shared pressure input connector, each pressure feed line fluidly connected to a cartridge socket inlet port; and
a reagent manifold, comprising a plurality of reagent output lines terminating in a shared reagent output connector, each reagent output line fluidly connected with a cartridge socket outlet port;
wherein the pressure input connector is fluidly connected to the external pressure output connector of the master microfluidic module, and the reagent output connector is fluidly connected to the external reagent input connector of the master microfluidic module.

4. A measurement device according to claim 2, wherein the secondary microfluidic module comprises:
a cartridge socket, having a plurality of cartridge socket inlet ports and cartridge socket outlet ports, for receiving a reagent cartridge;
a pressure manifold, comprising a plurality of pressure feed lines each having an associated multi-way valve assembly for selectively connecting the pressure feed line to either an external pressure output line or a cartridge socket pressure line; and
a reagent manifold, comprising a plurality of reagent output lines having an associated multi-way valve assembly for selectively connecting upstream to either a cartridge socket reagent line or an external reagent input line;
wherein
the plurality of pressure feed lines originate from a shared external pressure input connector;
the plurality of external pressure output lines terminate in a shared external pressure output connector;
the plurality of external reagent input lines originate from a shared external reagent input connector;
the plurality of reagent output lines terminate in a shared reagent output connector;
the external pressure input connector is fluidly connected to the external pressure output connector of the master microfluidic module, and
the external reagent output connector is fluidly connected to the external reagent input connector of the master microfluidic module.

5. A measurement device according to claim 4, wherein the reagent manifold comprises a fluidic chip socket, having a plurality of fluidic chip socket inlet ports and fluidic chip socket outlet ports, each fluidic chip socket inlet port being connected to said associated multi-way valve assembly, for selectively connecting the chip input line to either the cartridge socket reagent line or the external reagent input line, and each outlet port being fluidly connected to said reagent output line.

6. A measurement device according to claim 5, further comprising a fluidic chip plugged into said fluidic chip socket.

7. A measurement device according to claim 4, comprising at least two of said secondary microfluidic modules attached to the master microfluidic module in a daisy chain configuration, such that the external pressure input connector of secondary microfluidic module l+1 is connected to the external pressure output connector of secondary microfluidic module l; and the external reagent output connector of secondary module l+1 is connected to the external reagent input connector of secondary microfluidic module l, where l is greater than or equal to 1.

8. A measurement device according to claim 2, wherein said connectors of the master microfluidic module are connected to said connectors of the at least one secondary microfluidic module through a linker.

9. A measurement device according to claim 1, wherein the multi-way valve assembly associated with each chip input line comprises two 2-way valves: with the chip input line split so as to be connected to the outlets of (i) a first 2-way valve with an inlet connected to the external reagent input line and (ii) a second 2-way valve with an inlet connected to the cartridge socket reagent line.

10. A measurement device according to claim 1, wherein the multi-way valve assembly associated with each pressure feed line of the measurement device comprises two 2-way valves: with the pressure feed line split so as to be connected to the inlets of (i) a first 2-way valve with an outlet connected to the external pressure output line, and (ii) a second 2-way valve with an outlet connected to the cartridge socket pressure line.

11. A measurement device according to claim 1, wherein the cartridge socket of the master microfluidic module and/or an attached secondary microfluidic module incorporates a cartridge securing element, for fixing the cartridge in position and ensuring a sealing connection between the cartridges and the cartridge socket.

12. A measurement device according to claim 11, wherein the cartridge securing element is a quick release mechanism, such as a snap fit mechanism.

13. A measurement device according to claim 11, wherein the cartridge socket incorporates one or more socket guides to correctly position a cartridge relative to the cartridge socket inlet ports and cartridge socket outlet ports.

14. A measurement device according to claim 1, wherein the cartridge socket of the master microfluidic module and/or an attached secondary microfluidic module includes an electrical contact for providing power to the cartridge and allowing exchange of electrical signals with a cartridge inserted into the cartridge socket.

15. A measurement device according to claim 1, wherein the cartridge socket of the master microfluidic module and/or an attached secondary microfluidic module includes a motor, for moving components of the cartridge.

16. A measurement device according to claim 1, comprising an enclosure housing the analysis chip mount, the measurement apparatus, and the master microfluidic module.

17. A measurement device according to claim 16, wherein the pressure output connector and external reagent input connector of the master microfluidic module are positioned on the outside of the enclosure.

18. A measurement device according to claim 16, wherein the enclosure incorporates a hatch for accessing the cartridge socket.

19. A measurement device according to claim 18, wherein the shared pressure output connector and the external reagent input connector attach to a terminal block provided beneath the hatch.

20. A measurement device according to claim 1, wherein the measurement device is an optical measurement device, and the measurement apparatus incorporates optical measurement apparatus.

21. A measurement device according to claim 20, wherein the measurement device is an optical microscope and the measurement apparatus incorporates a light source and a light detector.

22. A measurement device according to claim 1, further comprising a reagent cartridge plugged into the cartridge socket of the master microfluidic module.

23. A measurement device according to claim 22, wherein the reagent cartridge comprises a housing having a mating surface contacting the cartridge socket of the master microfluidic module, the housing containing:
a plurality of reagent reservoirs (optionally provided as part of a detachable reagent tray/module as described above);
a plurality of cartridge pressurisation ports (connected to the cartridge socket inlet ports when installed on a microfluidic module) in fluid communication with the reagent reservoirs, for pressurising the reagent reservoirs in use;
a plurality of cartridge outlet ports (connected to the cartridge socket outlet ports when installed on a microfluidic module), for dispensing reagent from the cartridge in use; and
a valve assembly, for regulating flow of reagents from the reagent reservoirs to the cartridge outlet ports in use, the valve assembly comprising:
a stator chip assembly, having a plurality of reagent channels each providing a flowpath from the reagent reservoirs to the cartridge outlet ports, each reagent channel having an associated valve section in which the reagent channel is capped with a flexible membrane;
a valve actuator, comprising a plurality of pins which are movable to actuate the valve sections between an open position in which the reagent channel is open and a closed position in which the flexible membrane is deformed so as to occlude the reagent channel; and
a rotor chip, rotatable relative to the valve actuator between a first position and a second position, wherein the rotor chip includes an actuator surface which pushes the pins to actuate the valve sections, and wherein said rotation causes the actuator surface to actuate (open/close) a different subset of the valve sections in the first position compared to the second position.

24. A measurement device according to claim 23, wherein the valve actuator comprises a plurality of cantilever-mounted pins attached to a support body.

25. A measurement device according to claim 24, wherein each cantilever-mounted pin is bendable from a resting state in which the pin deforms the flexible membrane to close its associated valve section to an engaged state in which the pin is bent away from the flexible membrane so as to open the valve section.

26. A measurement device according to claim 22, wherein the reagent cartridge comprises a housing containing:
a plurality of reagent reservoirs (optionally provided as part of a detachable reagent tray/module as described above);
a plurality of cartridge pressurisation ports (connected to the cartridge socket inlet ports when installed on a microfluidic module) in fluid communication with the reagent reservoirs, for pressurising the reagent reservoirs in use;
a plurality of cartridge outlet ports (connected to the cartridge socket outlet ports when installed on a microfluidic module), for dispensing reagent from the cartridge in use; and
a valve assembly, for regulating flow of reagents from the reagent reservoirs to the cartridge outlet ports in use, the valve assembly comprising:
a stator chip assembly, having a plurality of reagent channels each providing a flowpath from the reagent reservoirs to the cartridge outlet ports, the plurality of reagent channels intersecting a circular groove, each reagent channel having an associated valve section provided at the circular groove in which the reagent channel is capped with a flexible membrane, the valve section being switchable between an open position in which the reagent channel is open and a closed position in which the flexible membrane is deformed so as to occlude the reagent channel;
a rotor chip, rotatable relative to the stator chip assembly between a first position and a second position, the rotor chip having a protrusion (e.g. in the form of bump or ridge, such as a notched ridge, as described above) which contacts and deforms the flexible membrane so as to close at least one of the valve sections, the protrusion being sited within the circular groove of the stator chip assembly wherein said rotation causes the protrusion to close a different subset of the reagent channels in the first position compared to the second position.

27. A measurement device according to claim 23, wherein the reagent reservoirs are provided as part of a detachable reagent tray.

28. A measurement device according to claim 23, wherein the rotor chip is a disc, and the actuator surface corresponds to a protrusion on said disc.

29. A measurement device according to claim 23, wherein the cartridge pressurisation ports and cartridge outlet ports are provided on a mating surface of the housing.

30. A measurement device according to claim 2, further comprising a reagent cartridge plugged into the cartridge socket of at least one secondary microfluidic module.

31. A measurement device according to claim 30, wherein the reagent cartridge comprises a housing having a mating surface contacting the cartridge socket of the master microfluidic module, the housing containing:
a plurality of reagent reservoirs (optionally provided as part of a detachable reagent tray/module as described above);
a plurality of cartridge pressurisation ports (connected to the cartridge socket inlet ports when installed on a microfluidic module) in fluid communication with the reagent reservoirs, for pressurising the reagent reservoirs in use;
a plurality of cartridge outlet ports (connected to the cartridge socket outlet ports when installed on a microfluidic module), for dispensing reagent from the cartridge in use; and
a valve assembly, for regulating flow of reagents from the reagent reservoirs to the cartridge outlet ports in use, the valve assembly comprising:
a stator chip assembly, having a plurality of reagent channels each providing a flowpath from the reagent reservoirs to the cartridge outlet ports, each reagent channel having an associated valve section in which the reagent channel is capped with a flexible membrane;
a valve actuator, comprising a plurality of pins which are movable to actuate the valve sections between an open position in which the reagent channel is open and a closed position in which the flexible membrane is deformed so as to occlude the reagent channel; and
a rotor chip, rotatable relative to the valve actuator between a first position and a second position, wherein the rotor chip includes an actuator surface which pushes the pins to actuate the valve sections, and wherein said rotation causes the actuator surface to actuate (open/close) a different subset of the valve sections in the first position compared to the second position.

32. A secondary microfluidic module suitable for connection to the master microfluidic module of a measurement device as defined in claim 1, comprising:
a cartridge socket, having a plurality of cartridge socket inlet ports and cartridge socket outlet ports, for receiving a reagent cartridge;
a pressure manifold, comprising a plurality of pressure feed lines each having an associated multi-way valve assembly for selectively connecting the pressure feed line to either an external pressure output line or a cartridge socket pressure line; and
a reagent manifold, comprising a plurality of reagent output lines having an associated multi-way valve assembly for selectively connecting upstream to either a cartridge socket reagent line or an external reagent input line;
wherein
the plurality of pressure feed lines originate from a shared external pressure input connector;
the plurality of external pressure output lines terminate in a shared external pressure output connector;
the plurality of external reagent input lines originate from a shared external reagent input connector;
the plurality of reagent output lines terminate in a shared reagent output connector;
the external pressure input connector is fluidly connectable to the external pressure output connector of the master microfluidic module, and
the external reagent output connector is fluidly connectable to the external reagent input connector of the master microfluidic module.

33. A kit comprising a measurement device according to claim 1 and a secondary microfluidic module suitable for connection to the master microfluidic module of the measurement device, comprising:
a cartridge socket, having a plurality of cartridge socket inlet ports and cartridge socket outlet ports, for receiving a reagent cartridge;
a pressure manifold, comprising a plurality of pressure feed lines each having an associated multi-way valve assembly for selectively connecting the pressure feed line to either an external pressure output line or a cartridge socket pressure line; and
a reagent manifold, comprising a plurality of reagent output lines having an associated multi-way valve assembly for selectively connecting upstream to either a cartridge socket reagent line or an external reagent input line;
wherein
the plurality of pressure feed lines originate from a shared external pressure input connector;
the plurality of external pressure output lines terminate in a shared external pressure output connector;
the plurality of external reagent input lines originate from a shared external reagent input connector;
the plurality of reagent output lines terminate in a shared reagent output connector;
the external pressure input connector is fluidly connectable to the external pressure output connector of the master microfluidic module, and
the external reagent output connector is fluidly connectable to the external reagent input connector of the master microfluidic module.
